(19) United States
(12) Patent Application Publication
(10) Pub. No.: US 2025/0284373 A1
(43) Pub. Date: Sep. 11, 2025

(54) METHODS OF DETERMINING AN INPUT REGION ON A PHYSICAL SURFACE IN A THREE-DIMENSIONAL ENVIRONMENT

(71) Applicant: Apple Inc., Cupertino, CA (US)

(72) Inventors: Vinay CHAWDA, San Jose, CA (US); Leah M. GUM, Sunol, CA (US)

(21) Appl. No.: 19/059,003

(22) Filed: Feb. 20, 2025

Related U.S. Application Data
(60) Provisional application No. 63/563,895, filed on Mar. 11, 2024.

(51) Int. Cl. G06F 3/04815; G06F 3/01; G06F 3/0484; G06F 3/0488

(52) U.S. Cl. CPC G06F 3/04815; G06F 3/011; G06F 3/017; G06F 3/0484; G06F 3/0488

(57) ABSTRACT

In some embodiments, a computer system designates input region on a depiction of a physical surfaced in a displayed three-dimensional environment in response to detecting one or more inputs provided to the computer system. In some embodiments, a computer system determines a pose of an input region on a physical surface in a three-dimensional environment based on one or more properties of the three-dimensional environment.

### CROSS REFERENCE TO RELATED APPLICATIONS

This application claims the benefit of U.S. Provisional Application No. 63/563,895, filed Mar. 11, 2024, the content of which is herein incorporated by reference in its entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system designates an input region on a depiction of a physical surface in a three-dimensional environment based on one or more inputs detected by the computer system. In some embodiments, a computer system determines a pose of an input region on a physical surface in a three-dimensional environment based on one or more properties of the three-dimensional environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figs.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7U illustrate examples of a computer system designating one or more input regions on a physical surface in a three-dimensional environment based on or more inputs in accordance with some embodiments.

FIG. 8 is a flowchart illustrating an exemplary method of designating one or more input regions on a physical surface in a three-dimensional environment based on or more inputs in accordance with some embodiments.

FIGS. 9A-9K illustrate examples of a computer system determining a pose of an input region on a physical surface in a three-dimensional environment based on one or more properties of the three-dimensional environment in accordance with some embodiments.

FIG. 10 is a flowchart illustrating a method of determining a pose of an input region on a physical surface in a three-dimensional environment based on one or more properties of the three-dimensional environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system designates an input region on a depiction of a physical surface in a three-dimensional environment based on one or more inputs detected by the computer system.

In some embodiments, a computer system determines a pose of an input region on a physical surface in a three-dimensional environment based on one or more properties of the three-dimensional environment.

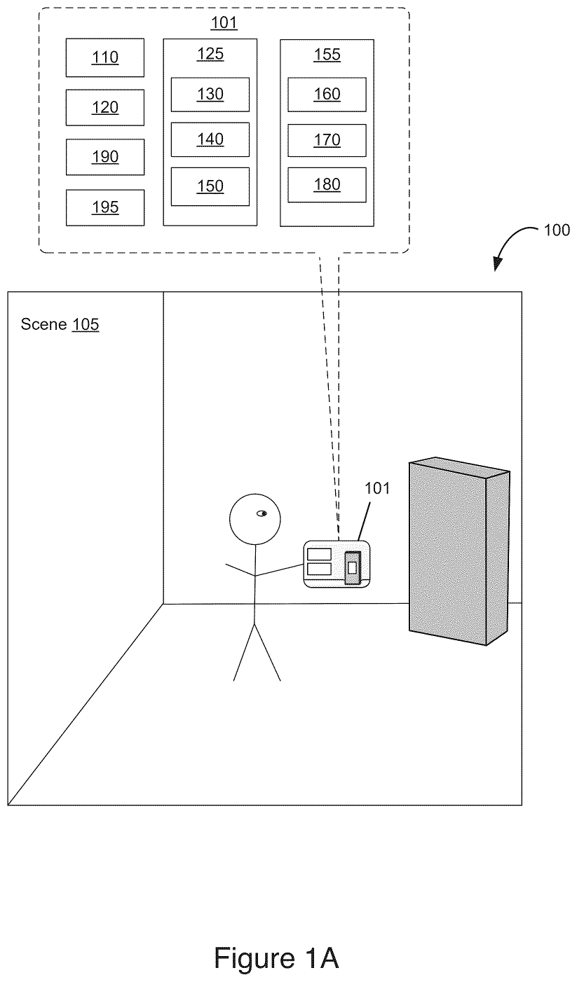

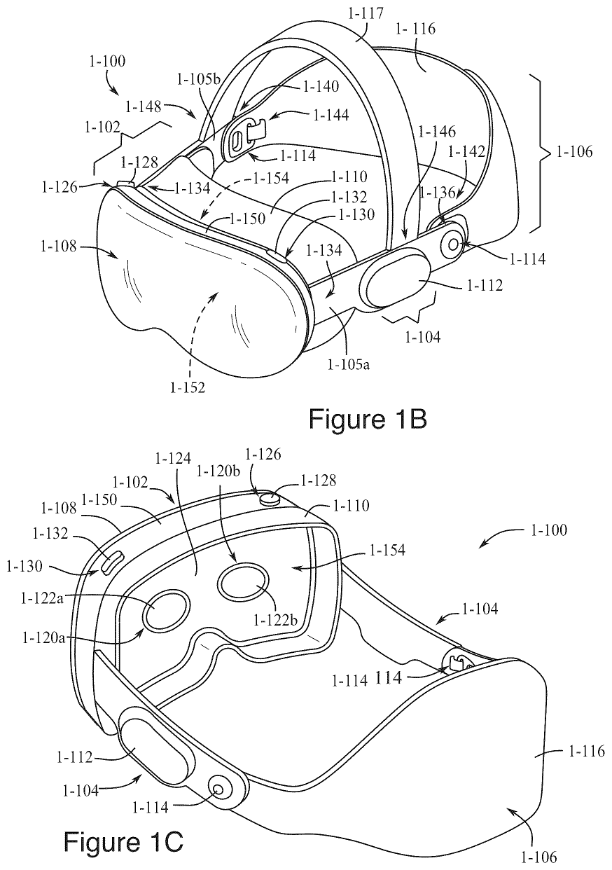

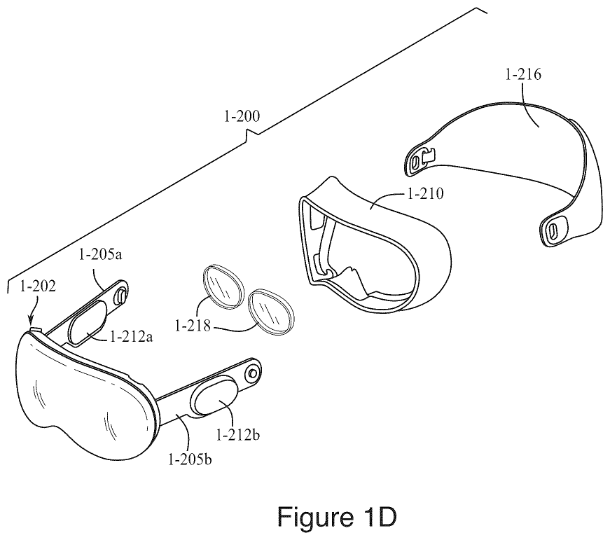

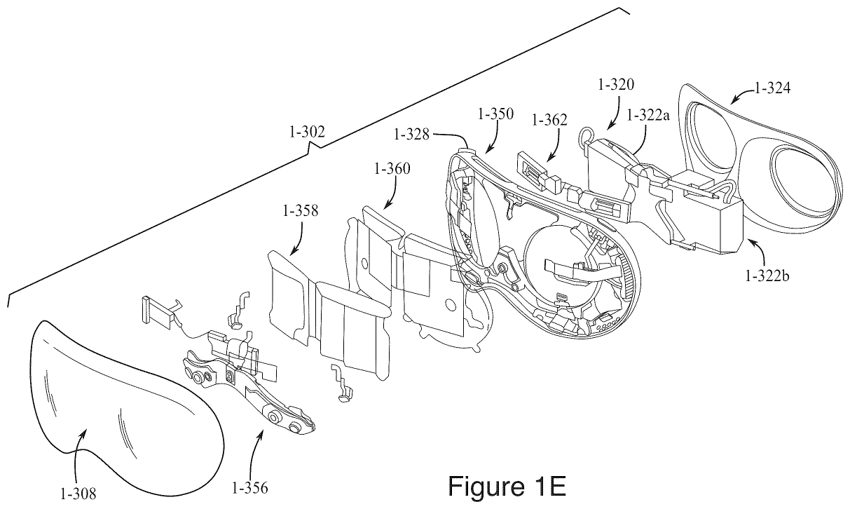

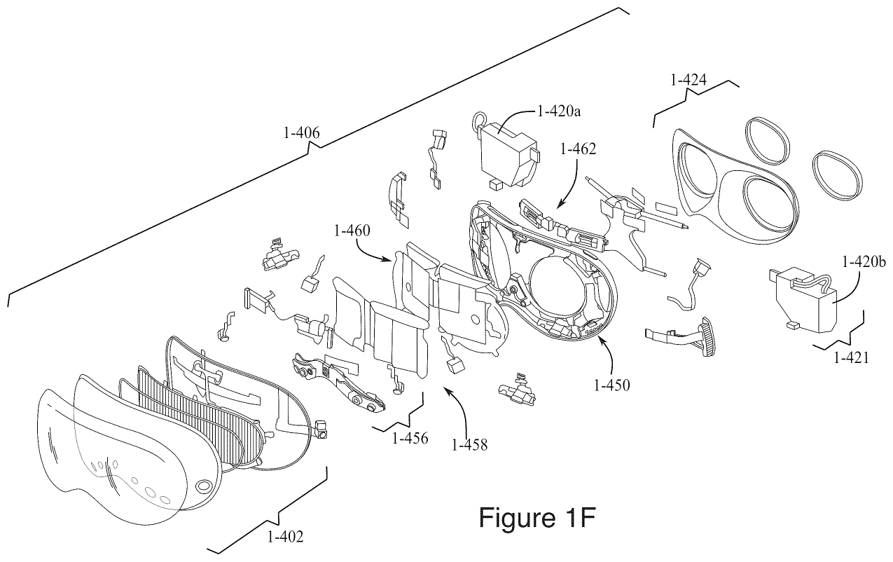

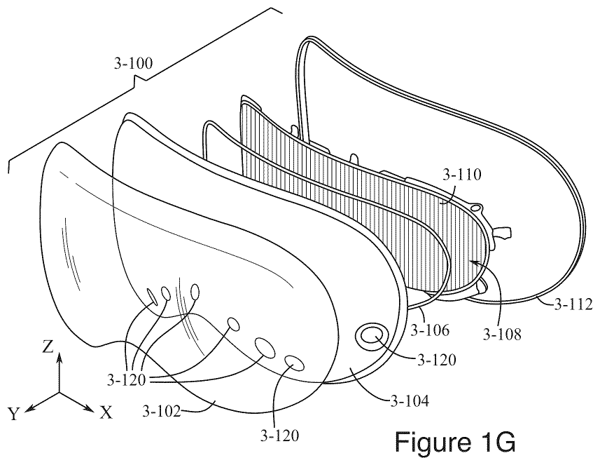

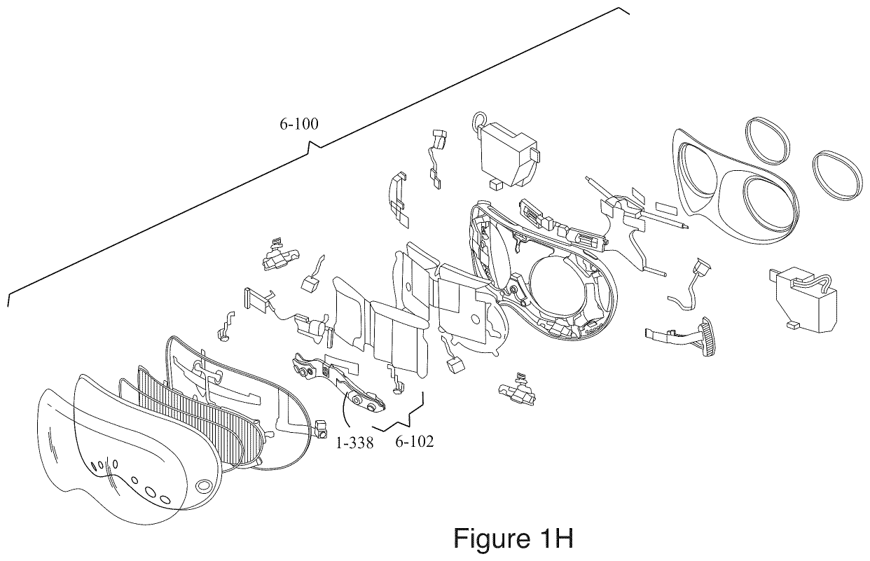

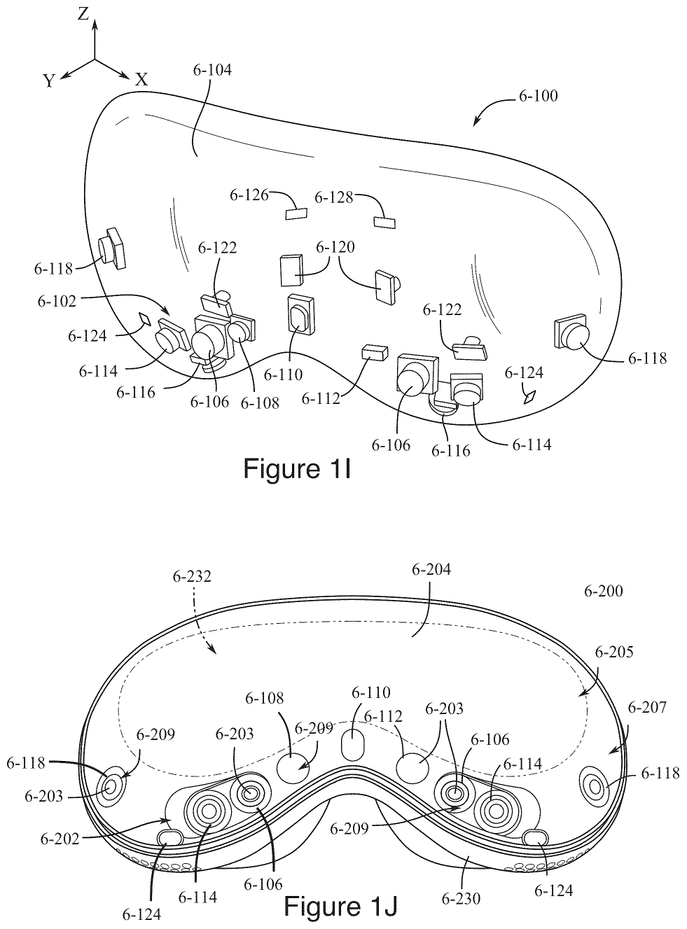

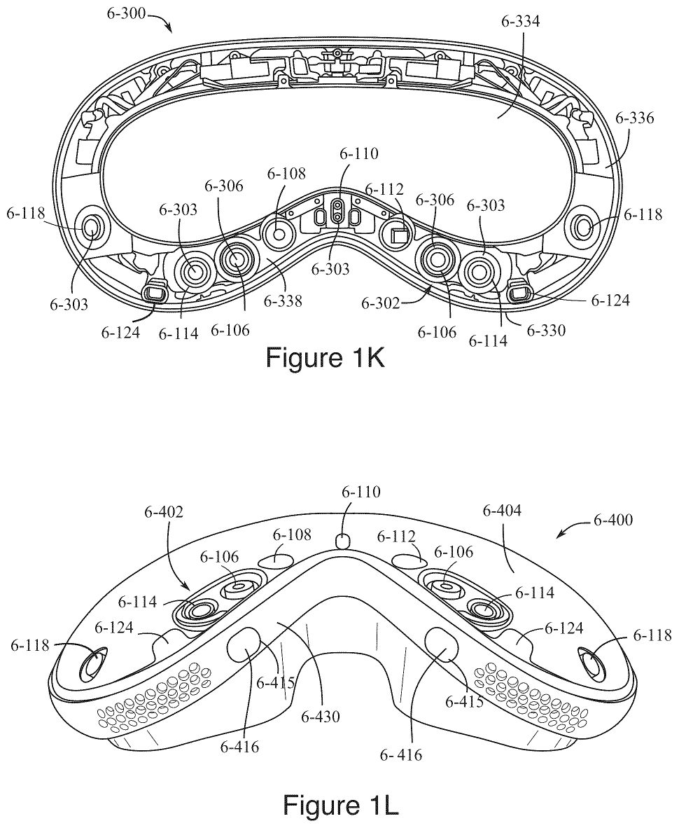

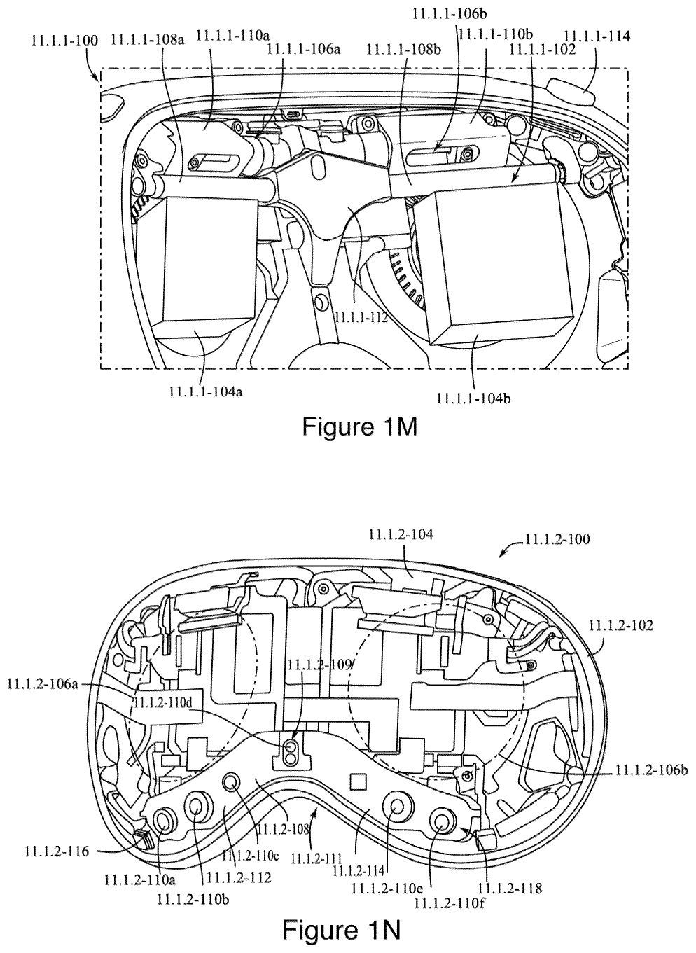

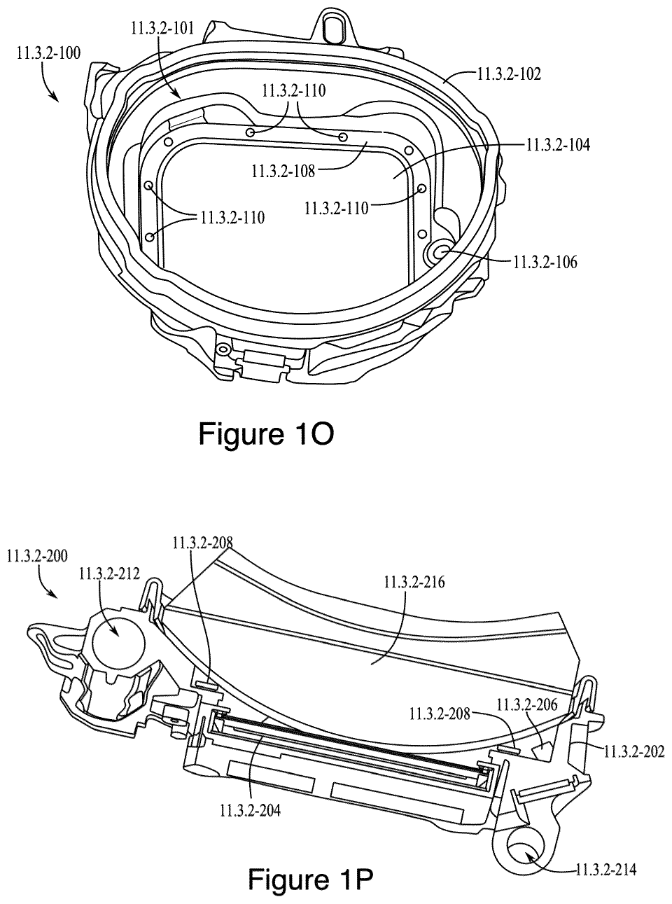

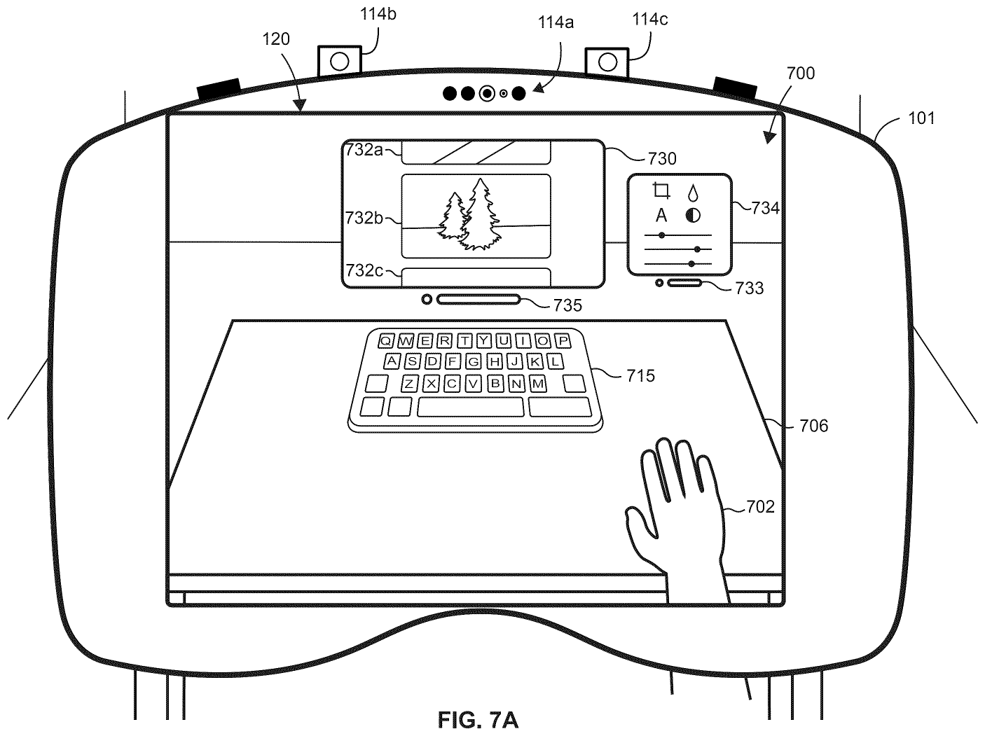

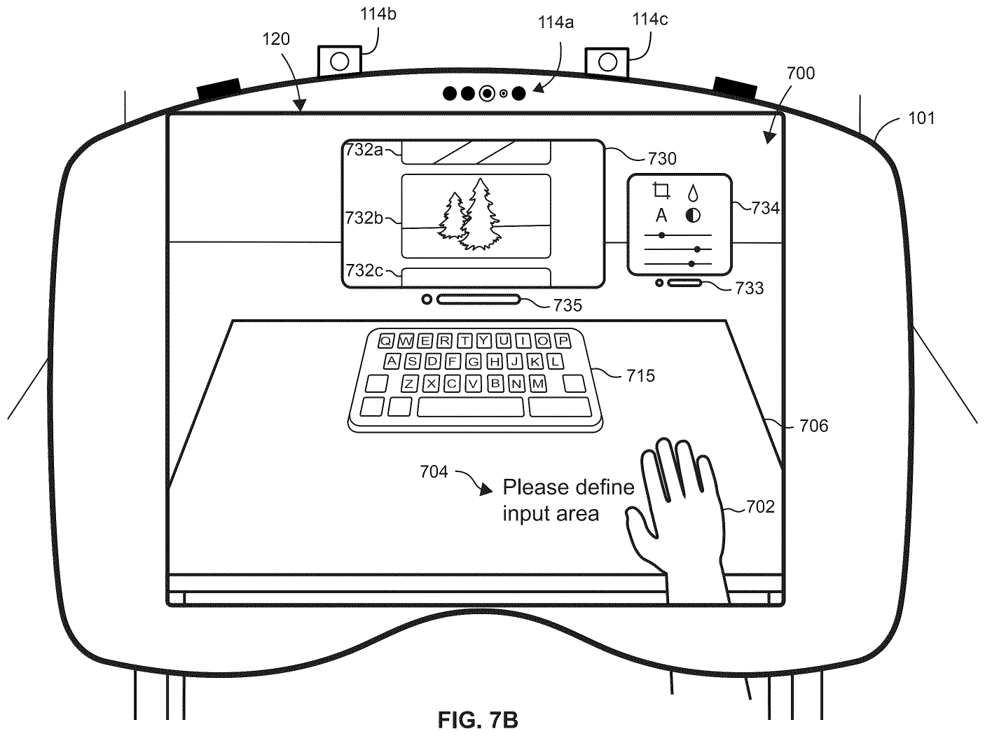

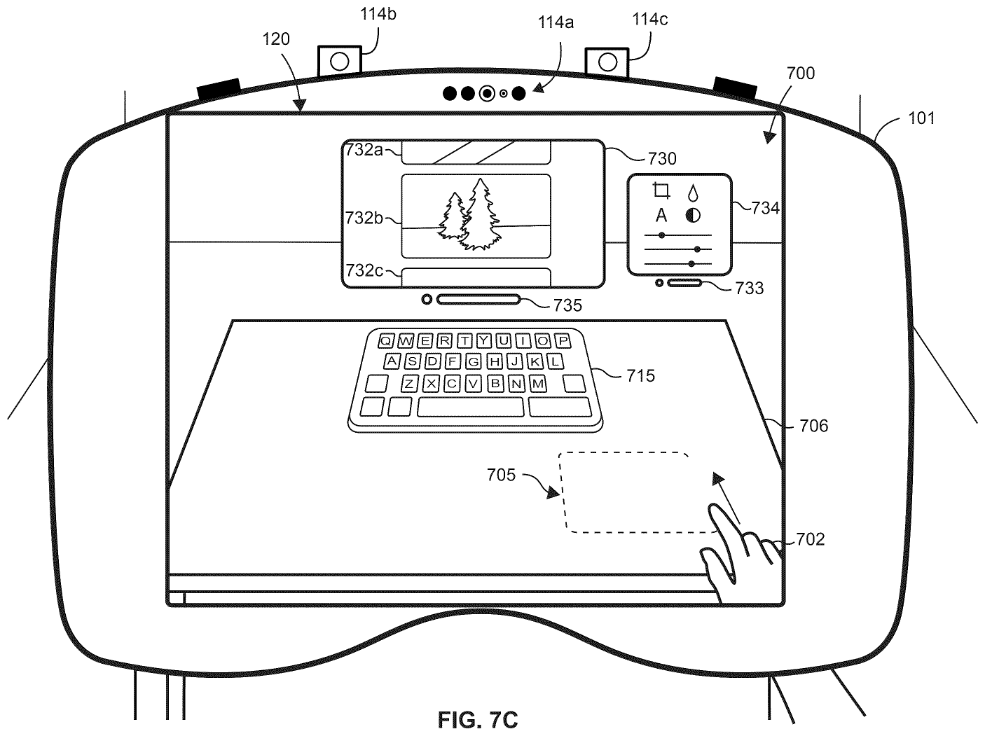

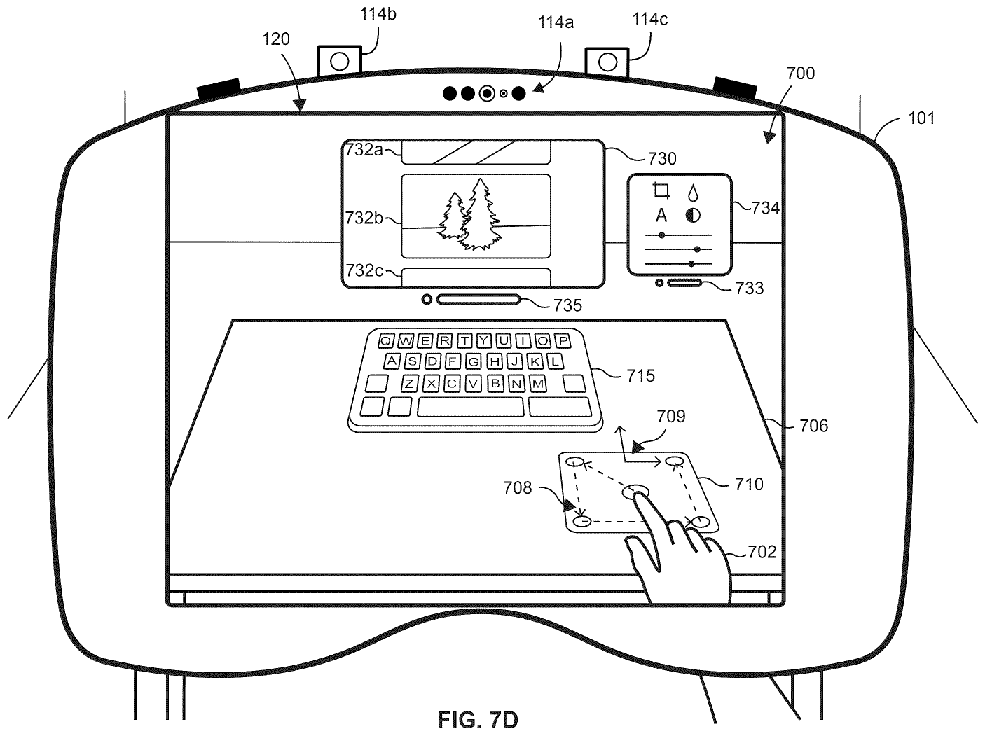

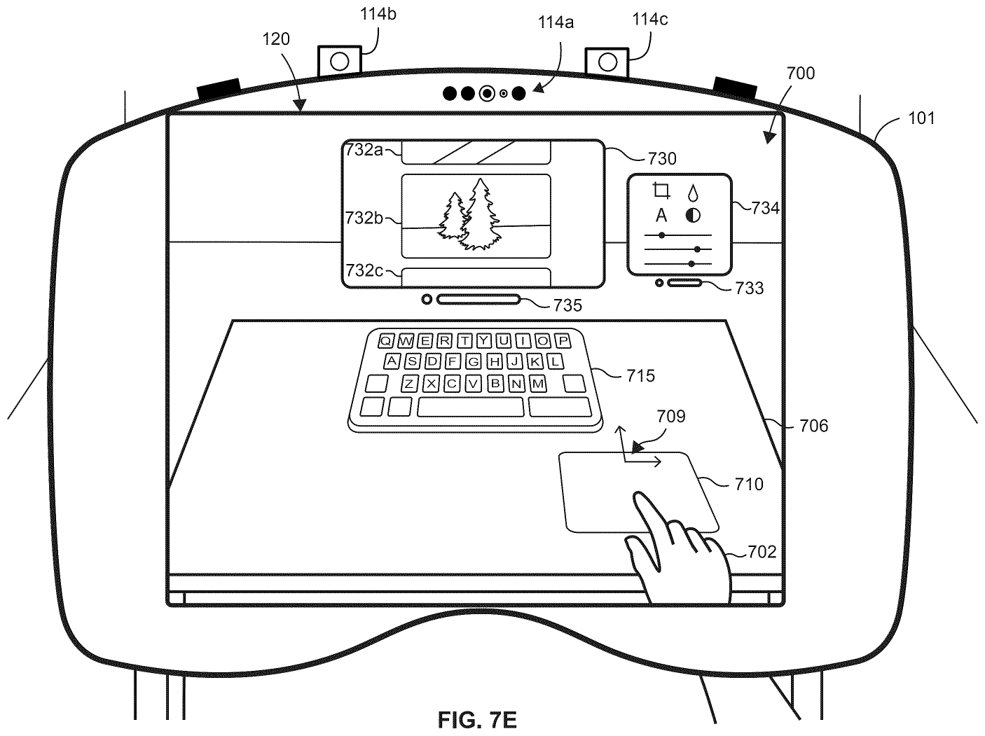

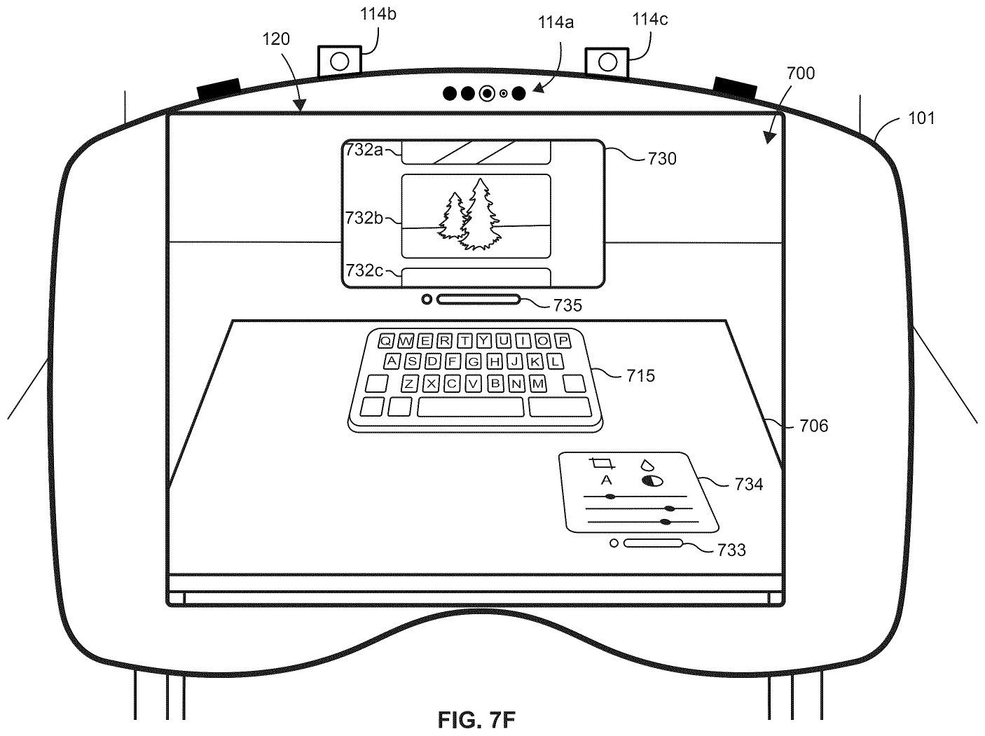

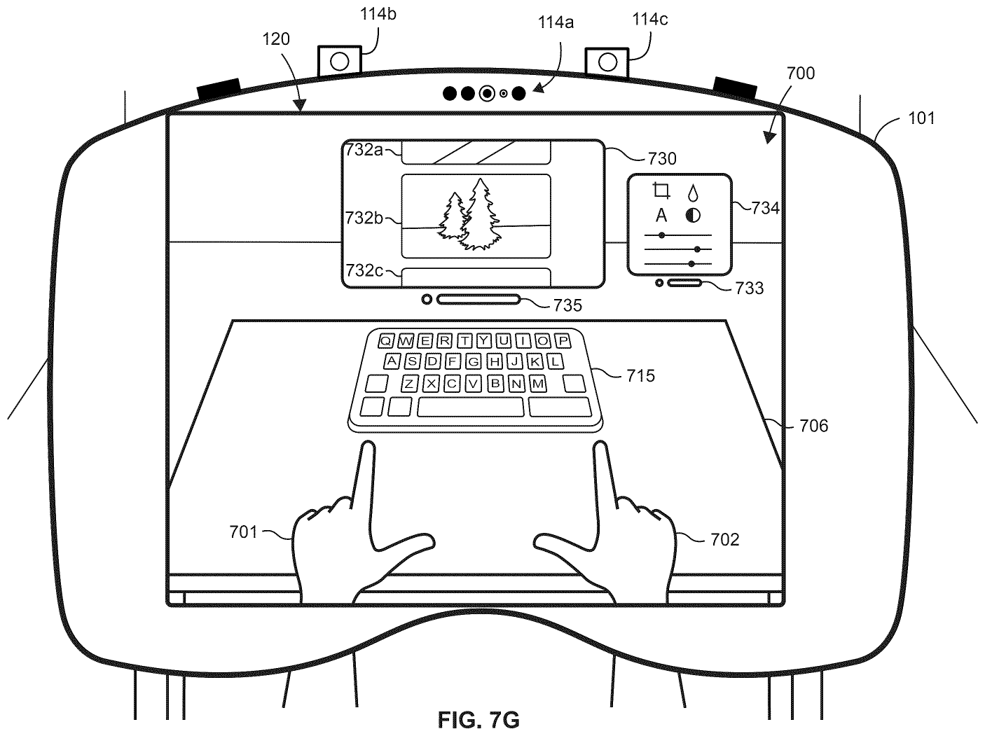

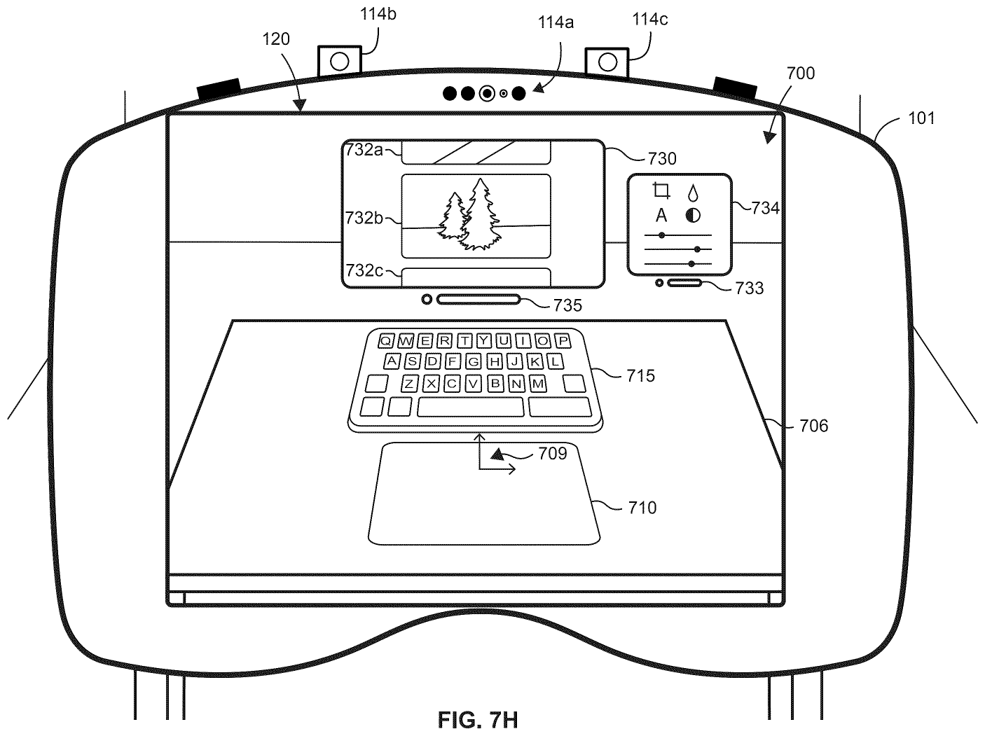

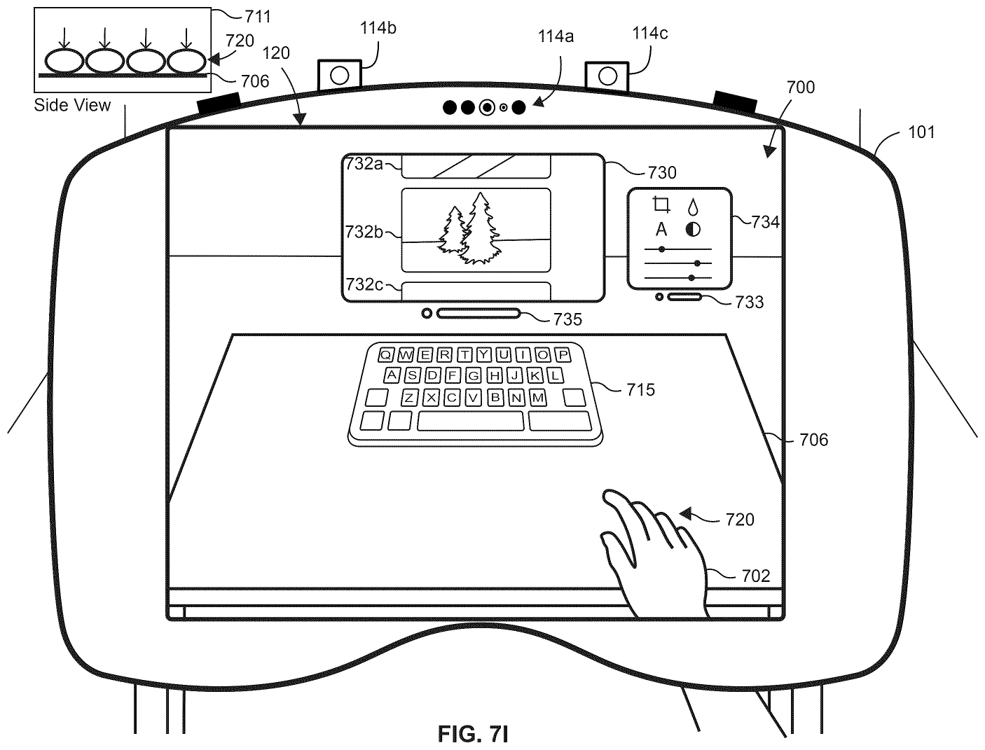

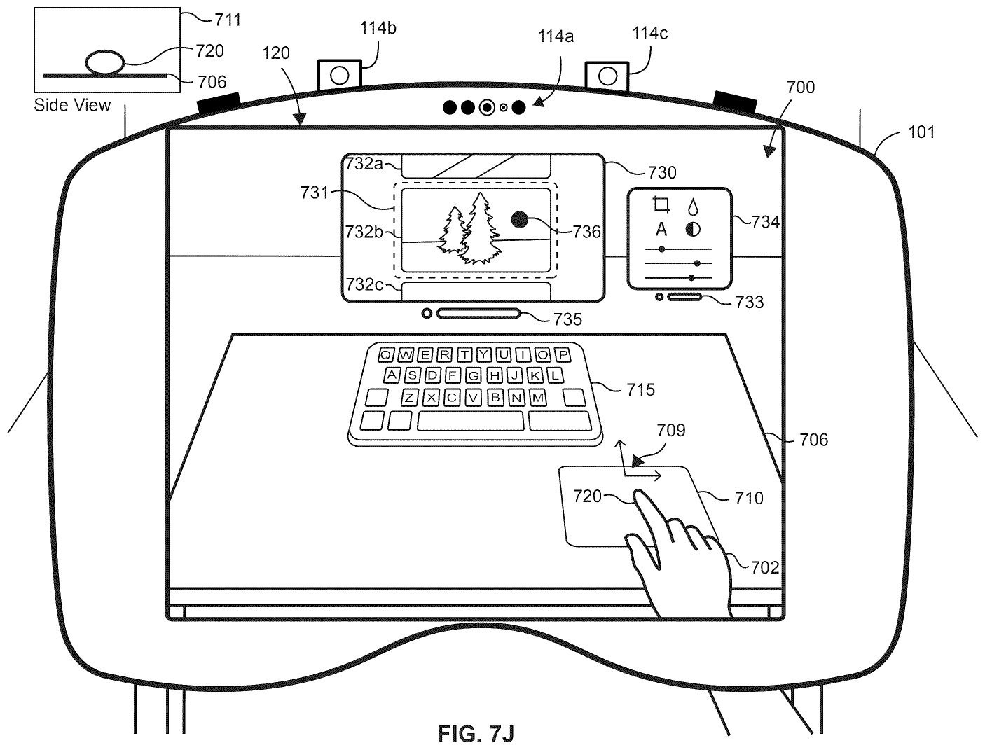

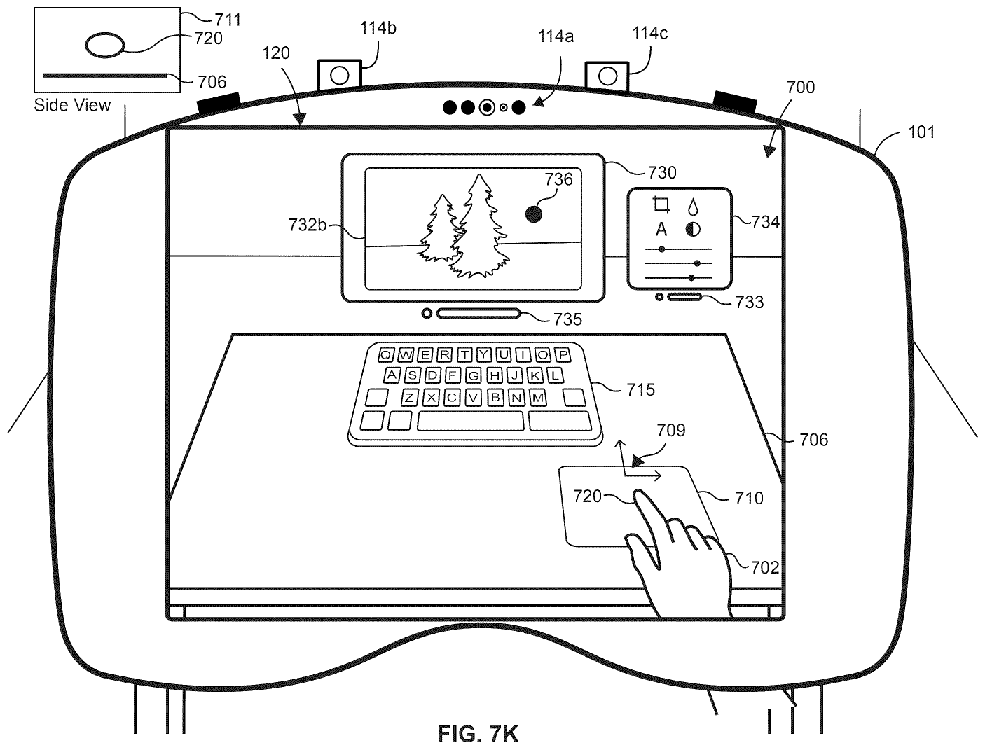

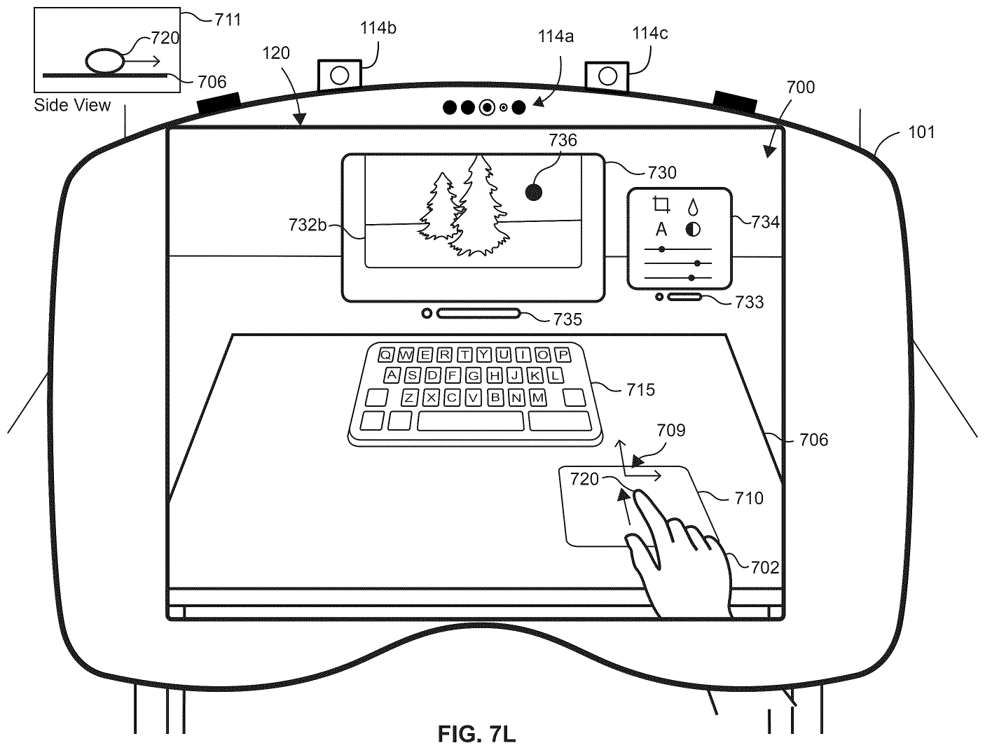

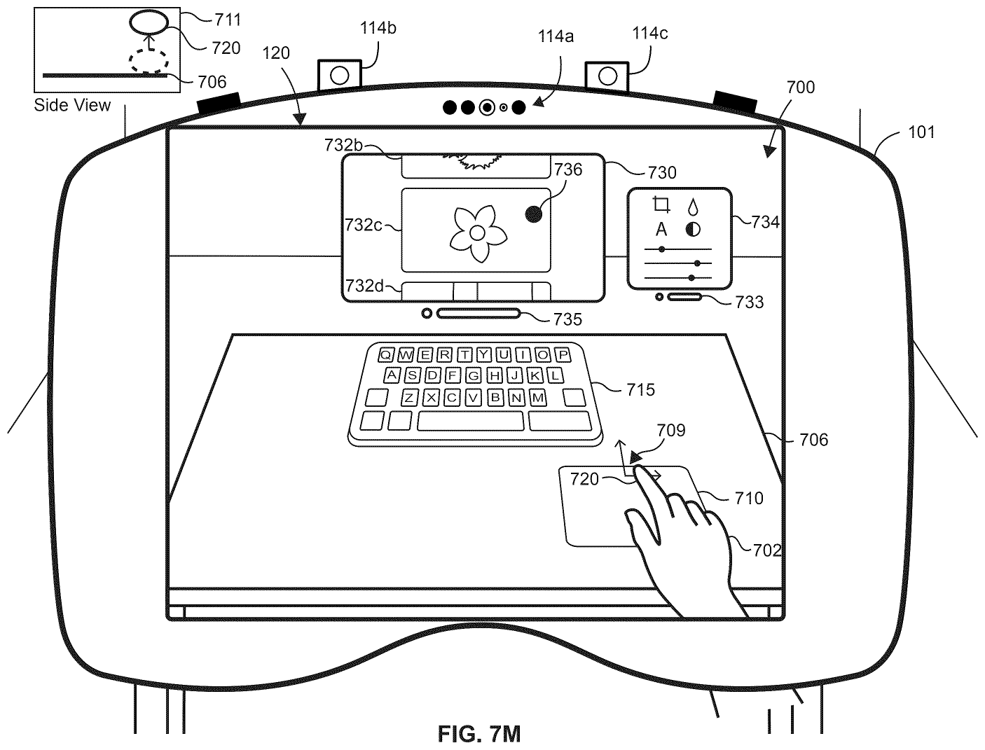

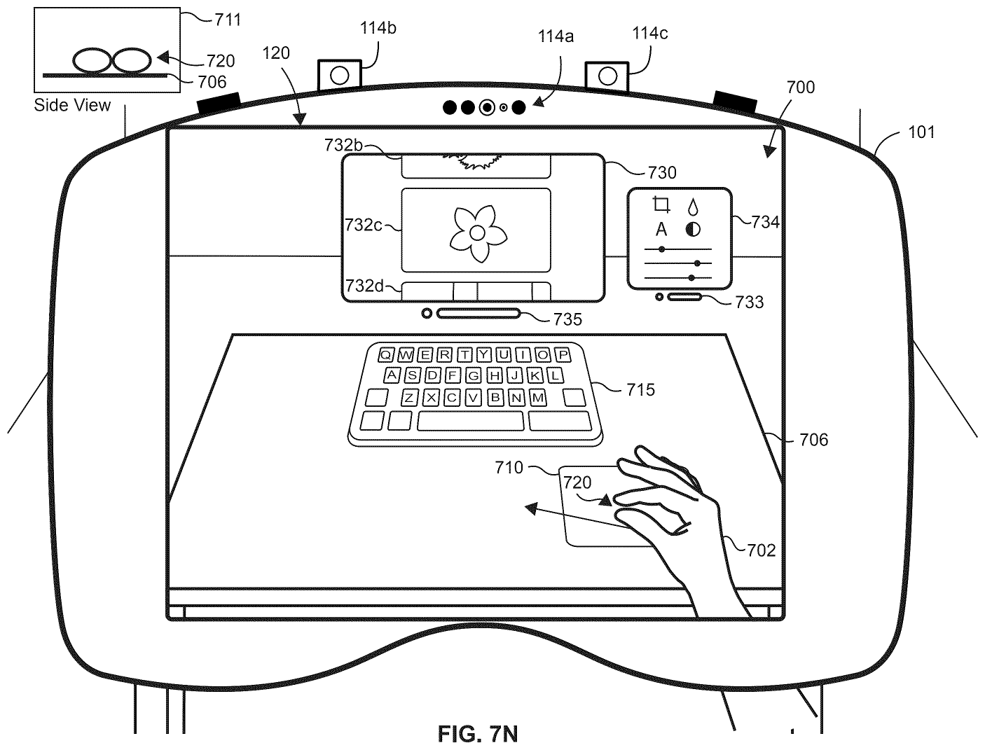

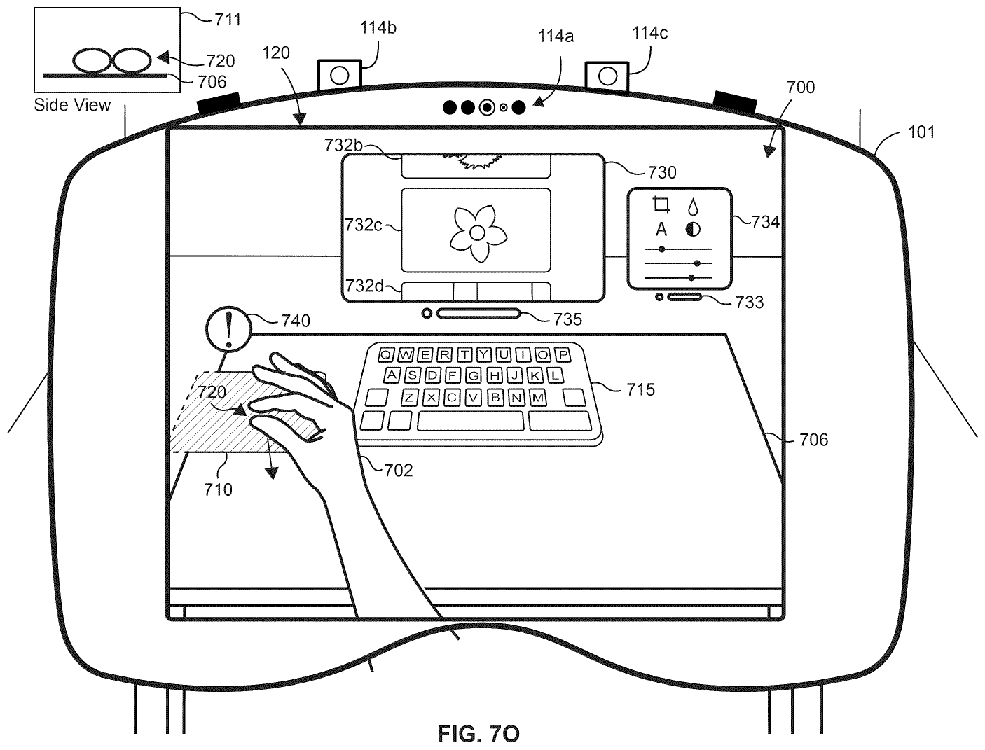

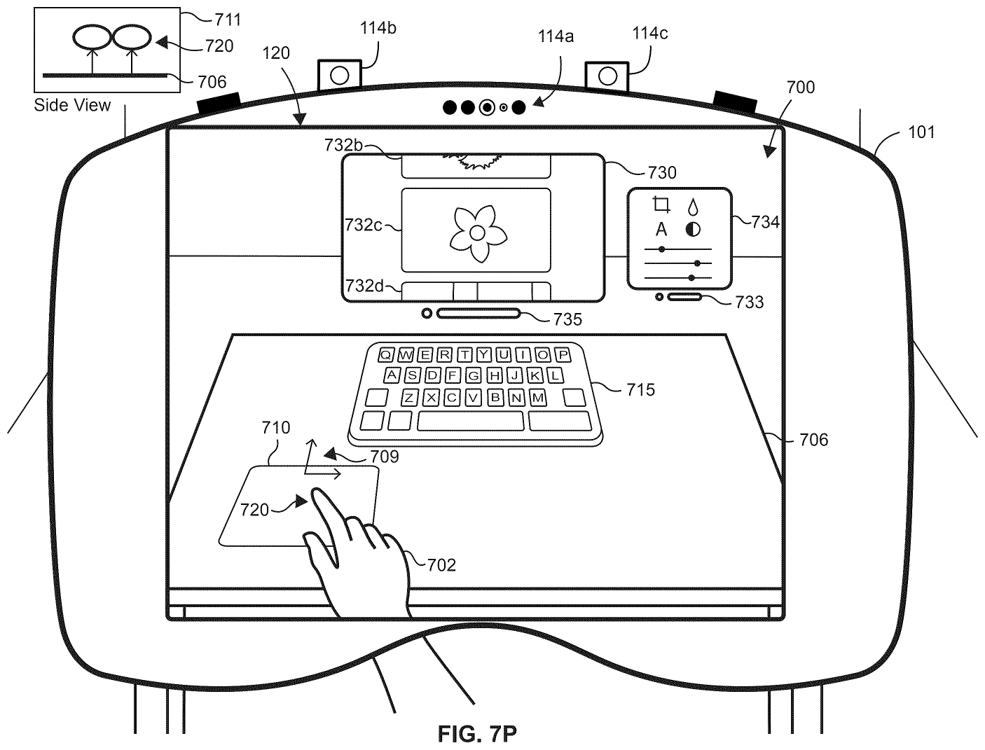

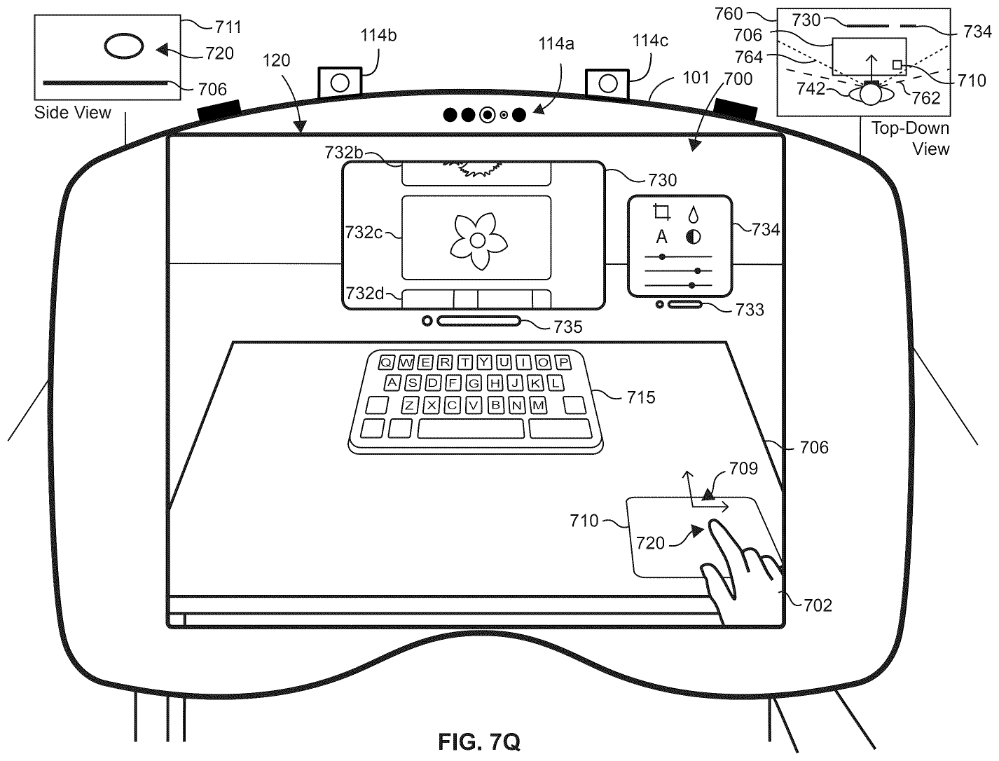

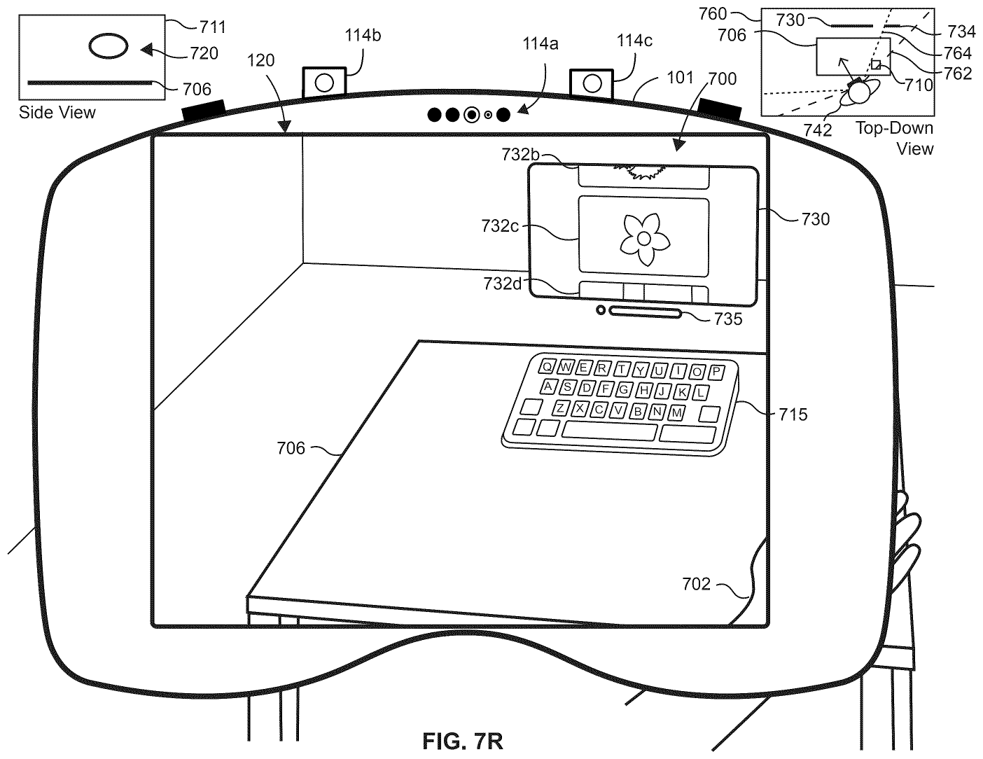

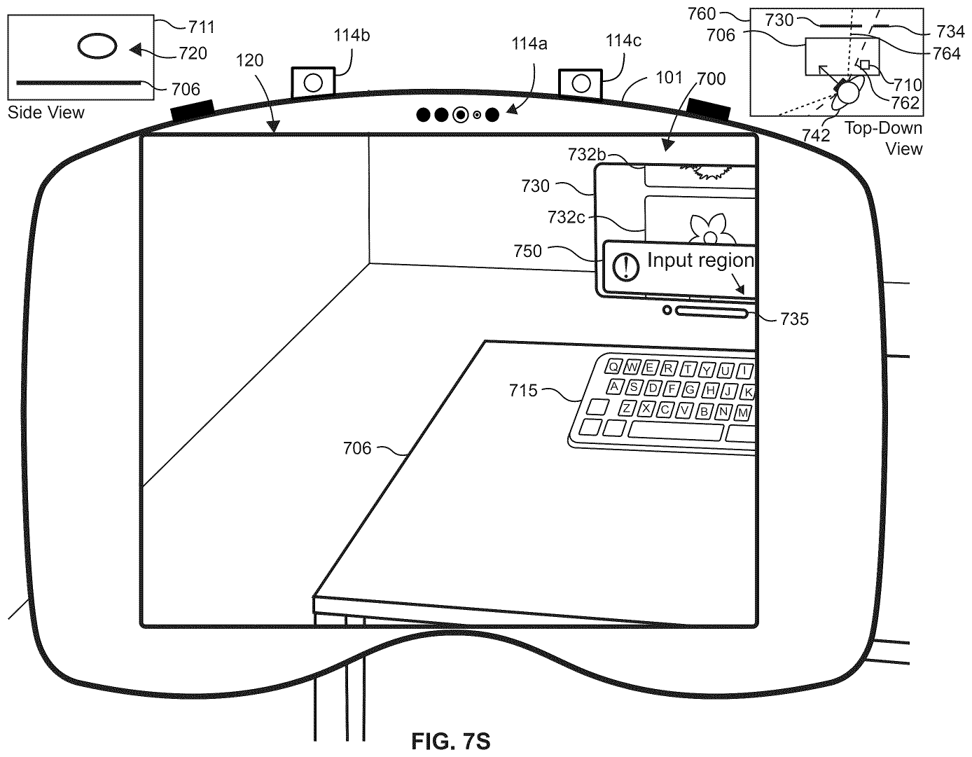

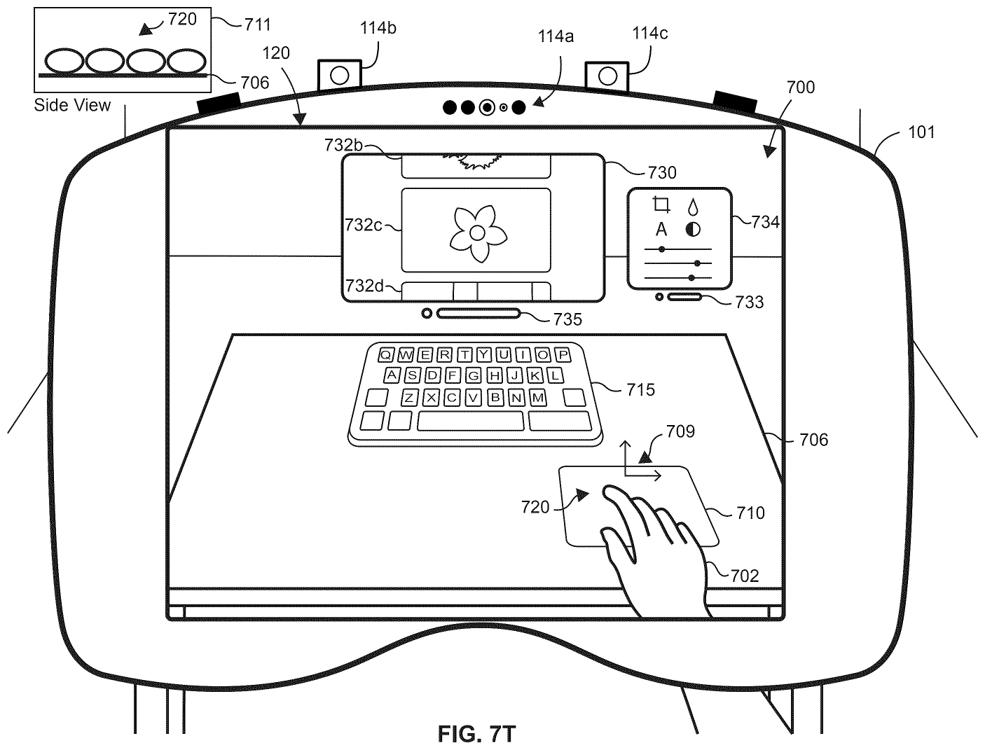

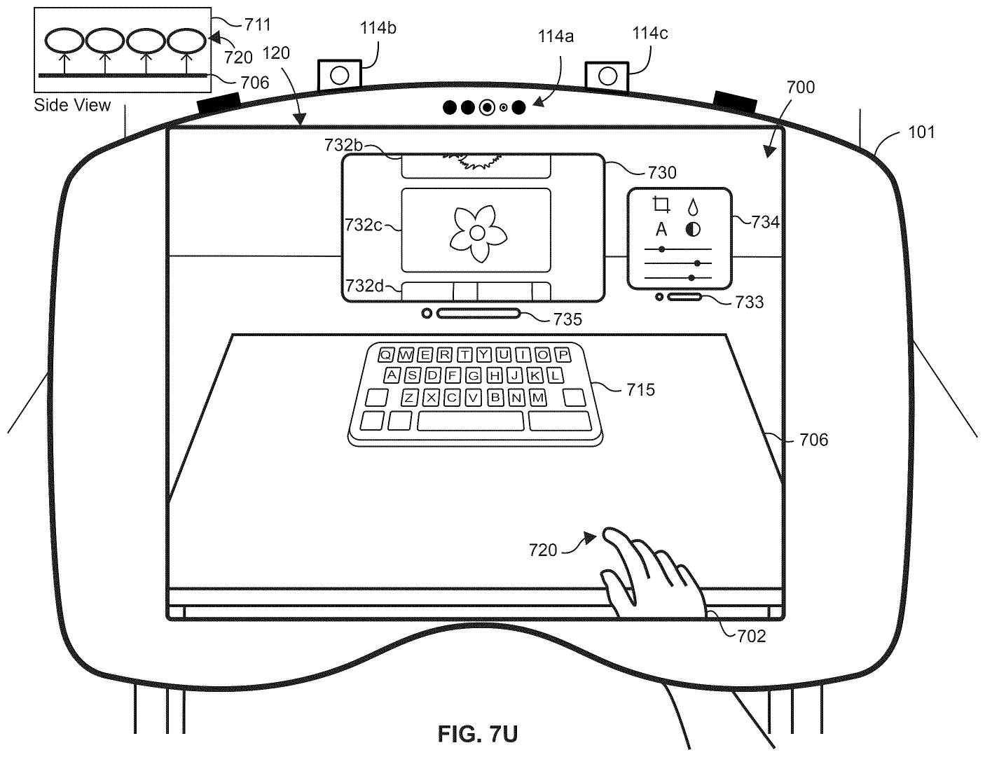

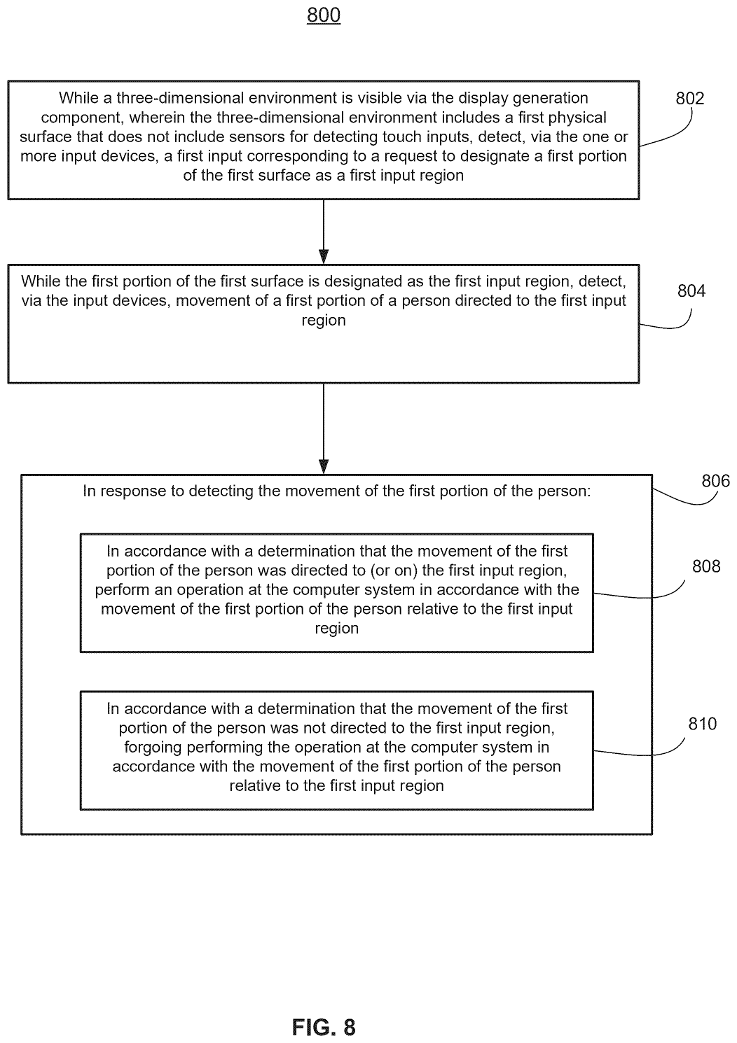

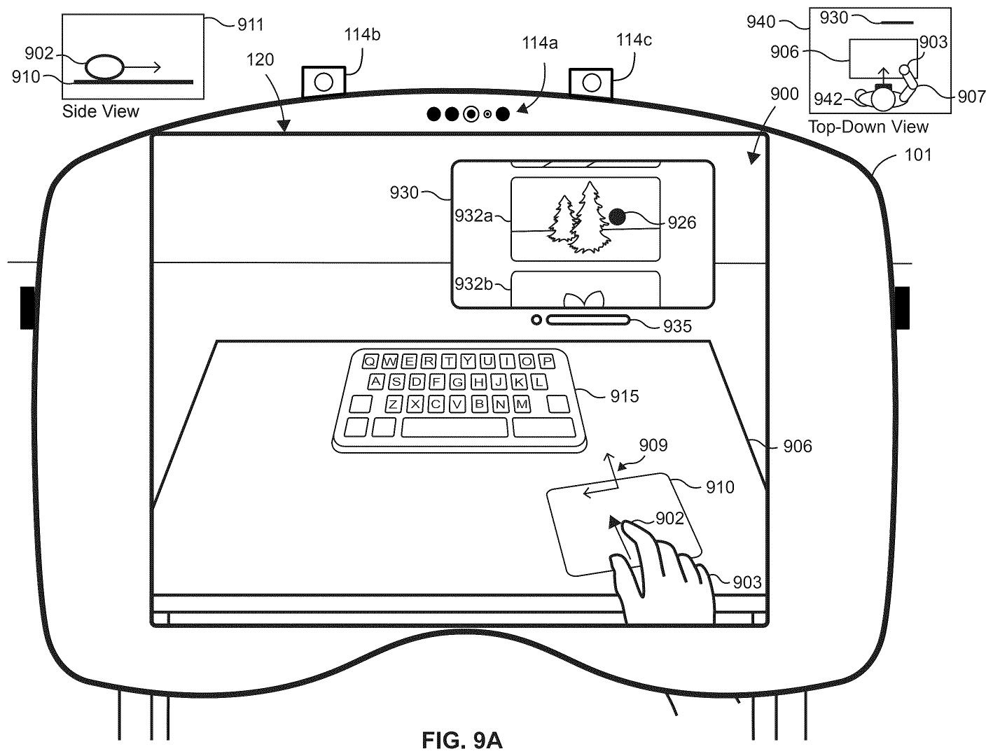

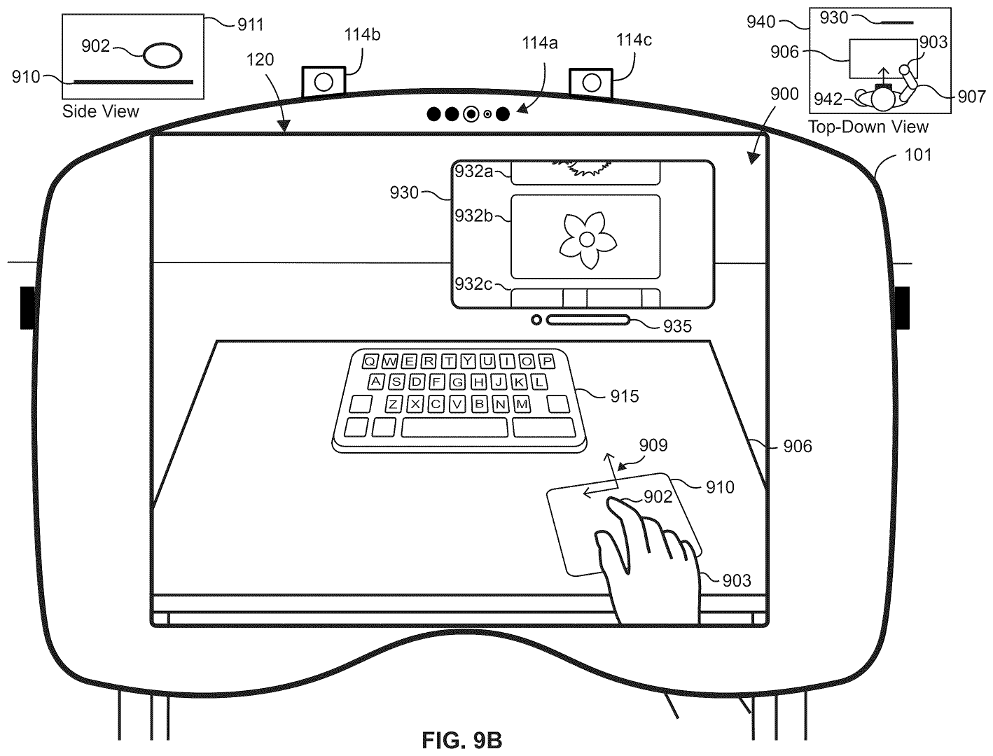

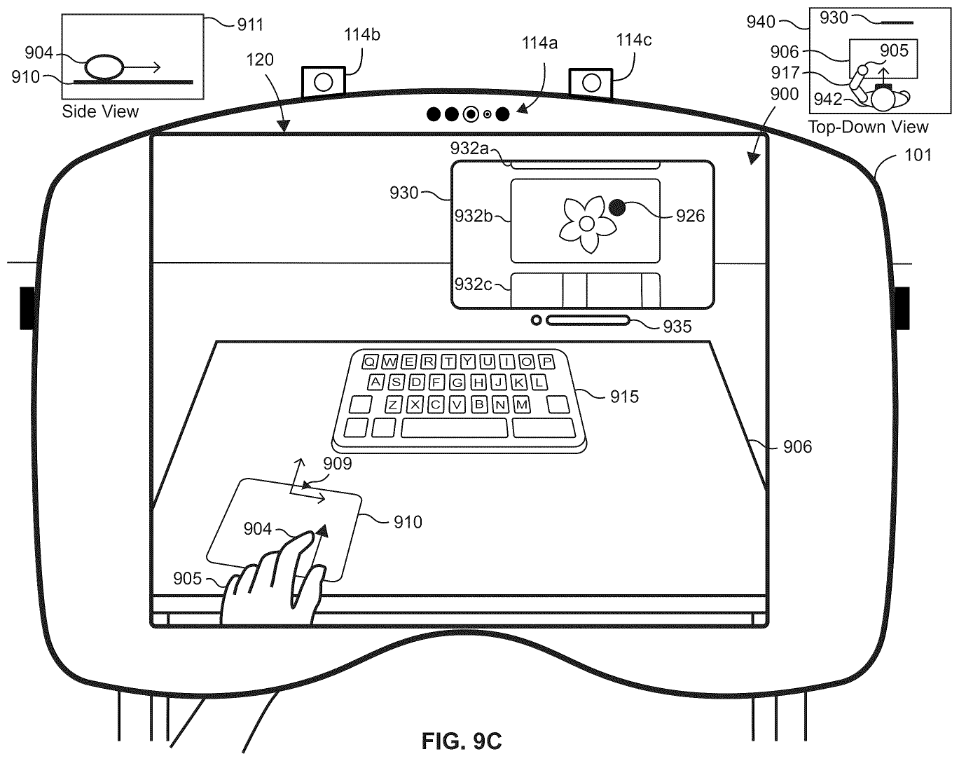

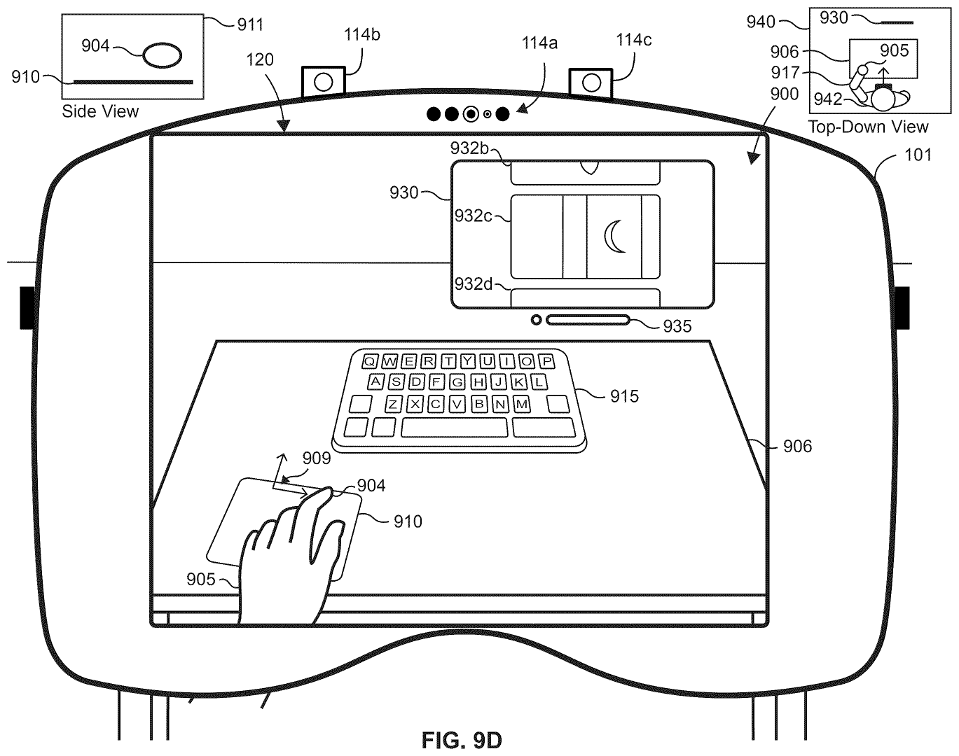

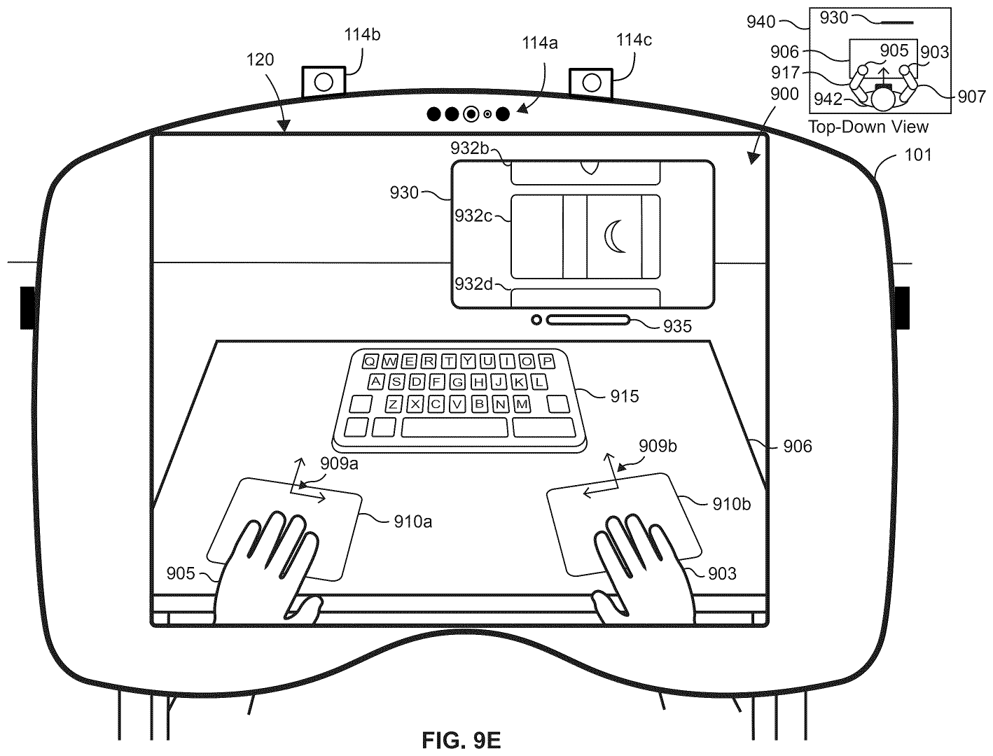

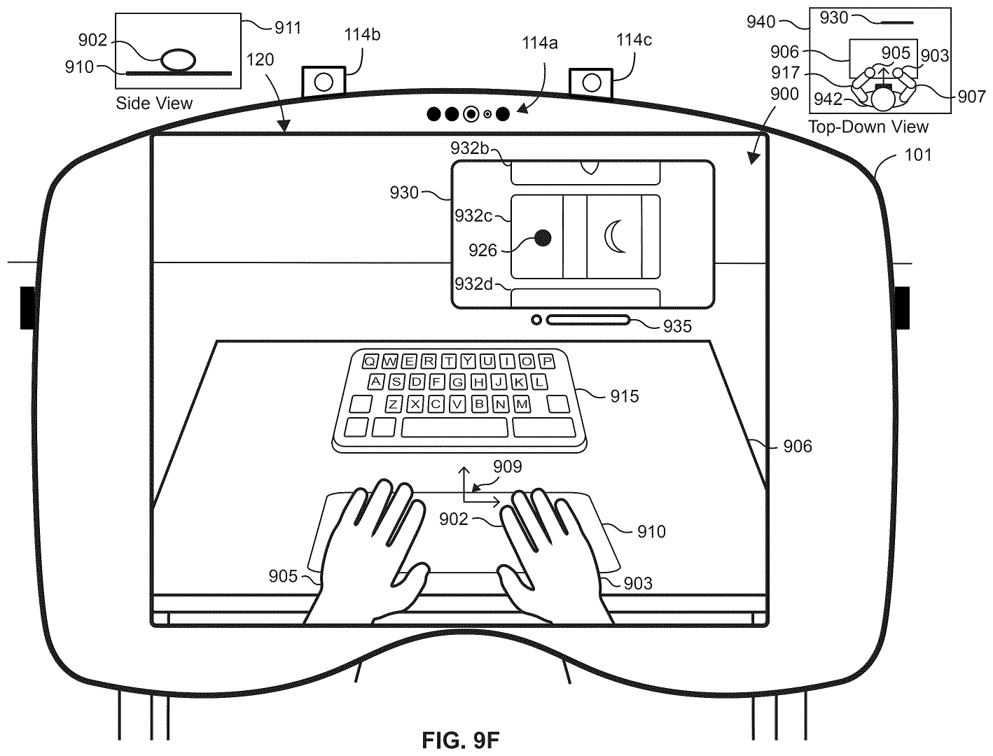

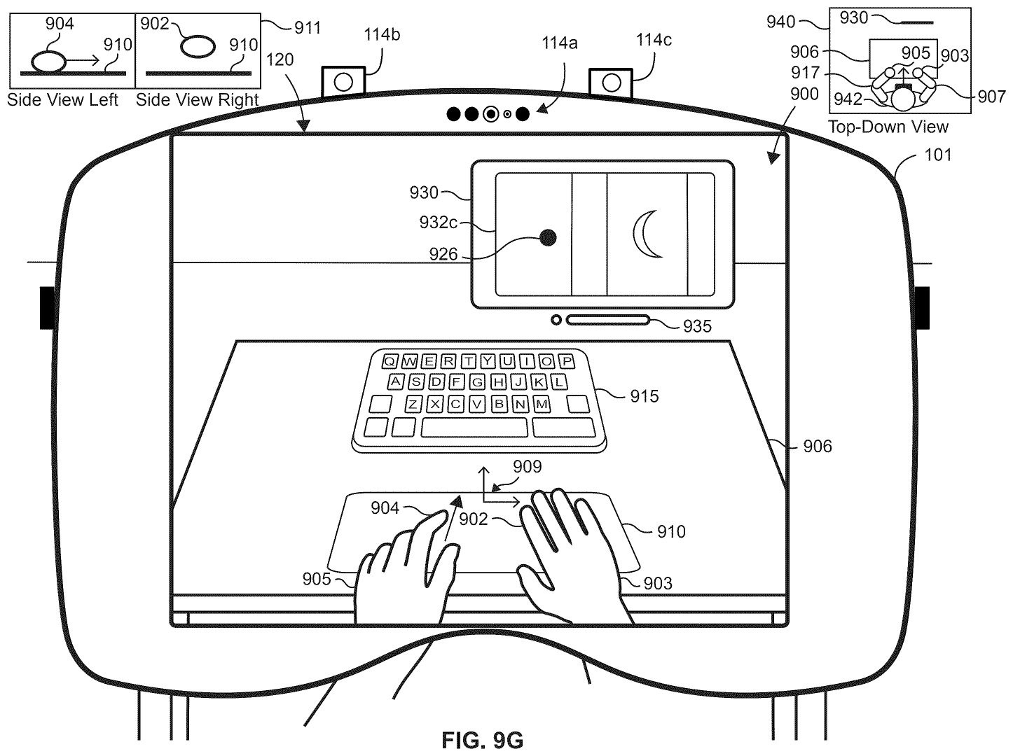

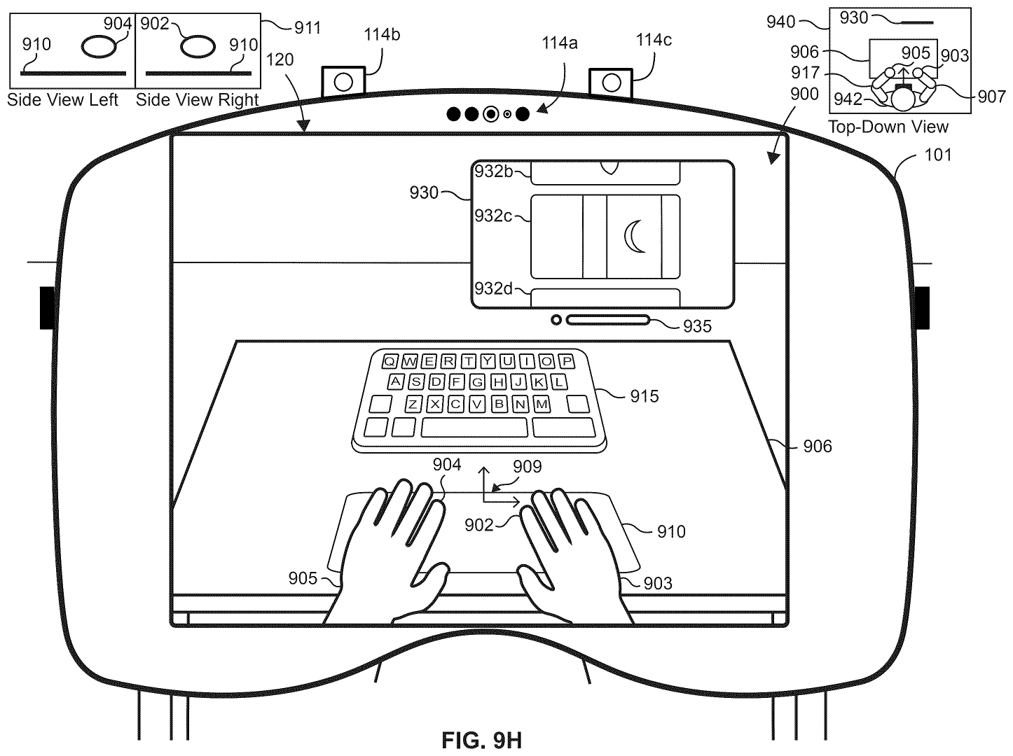

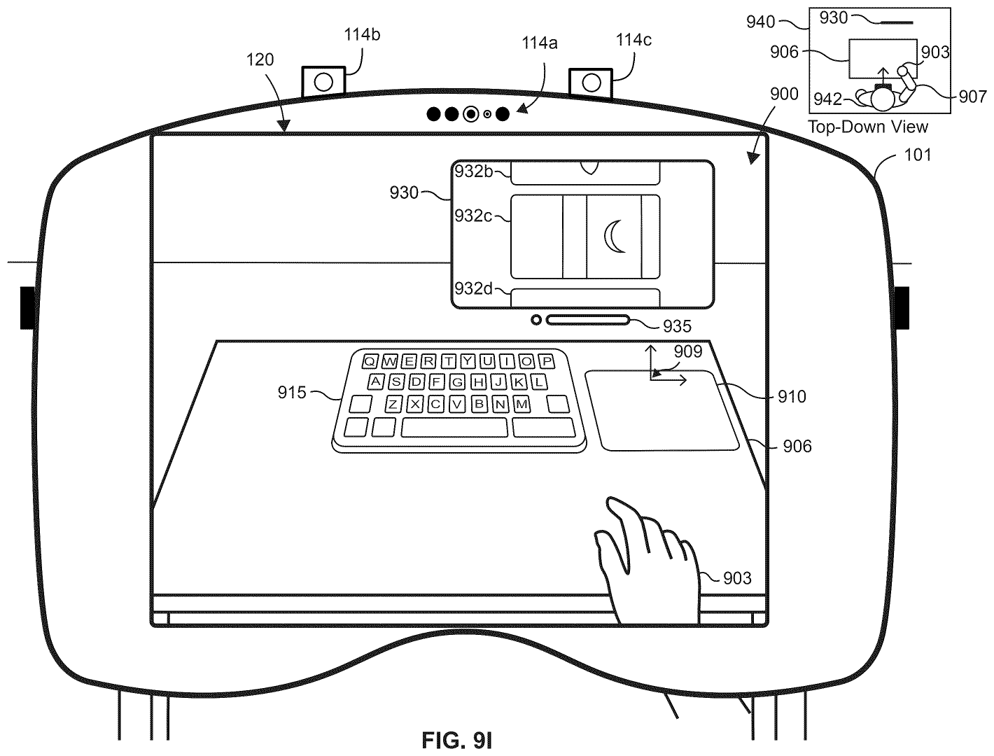

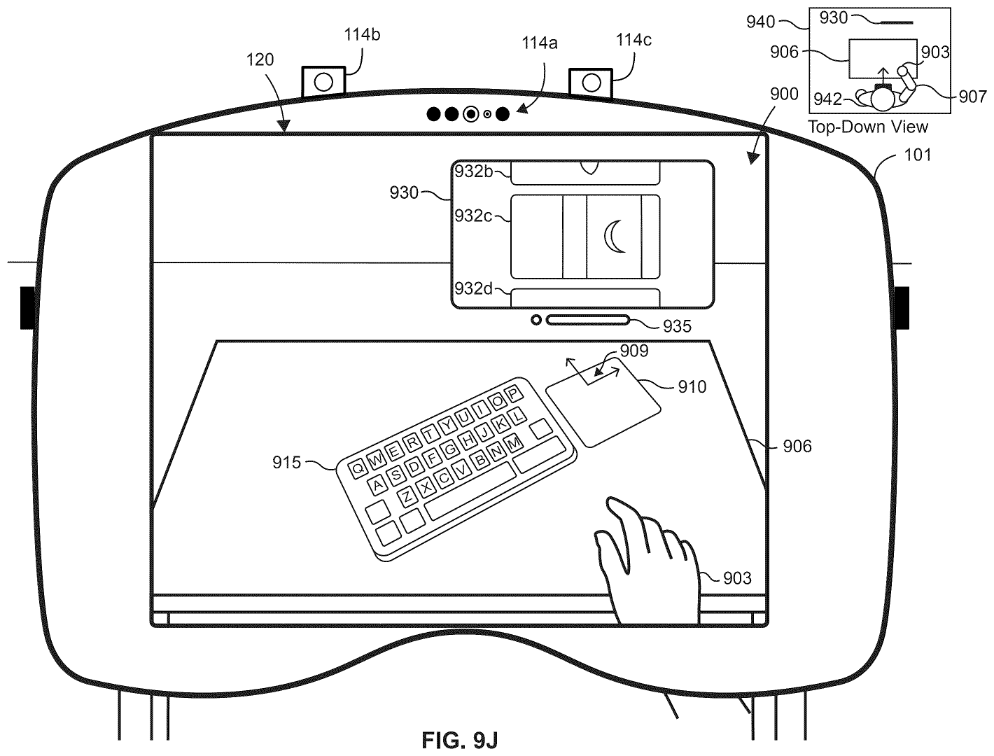

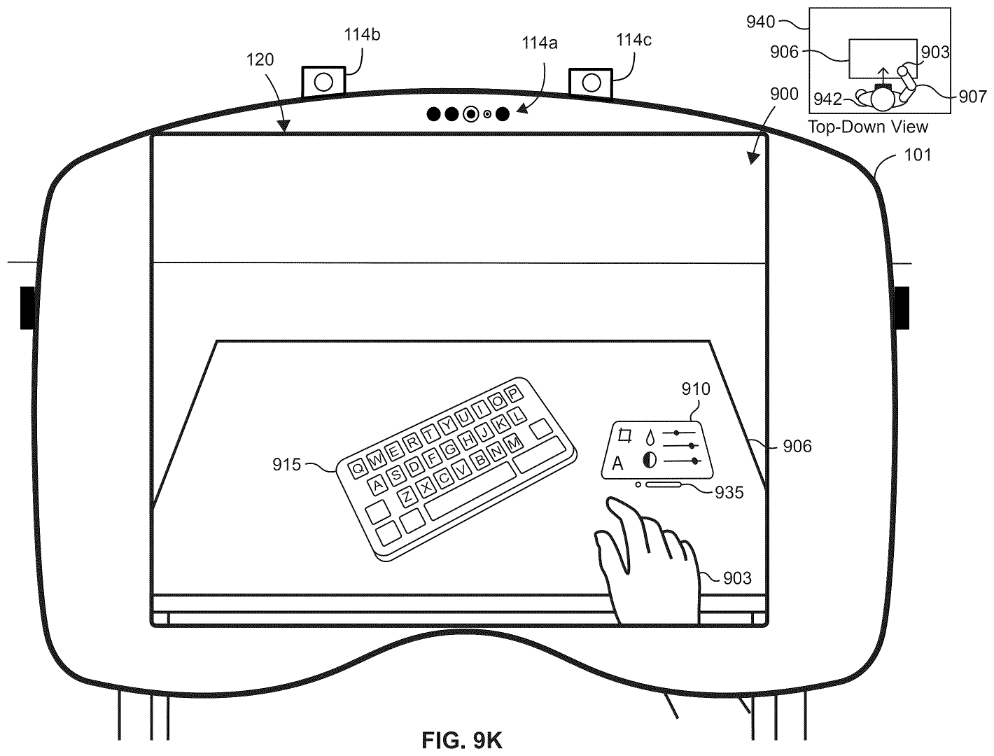

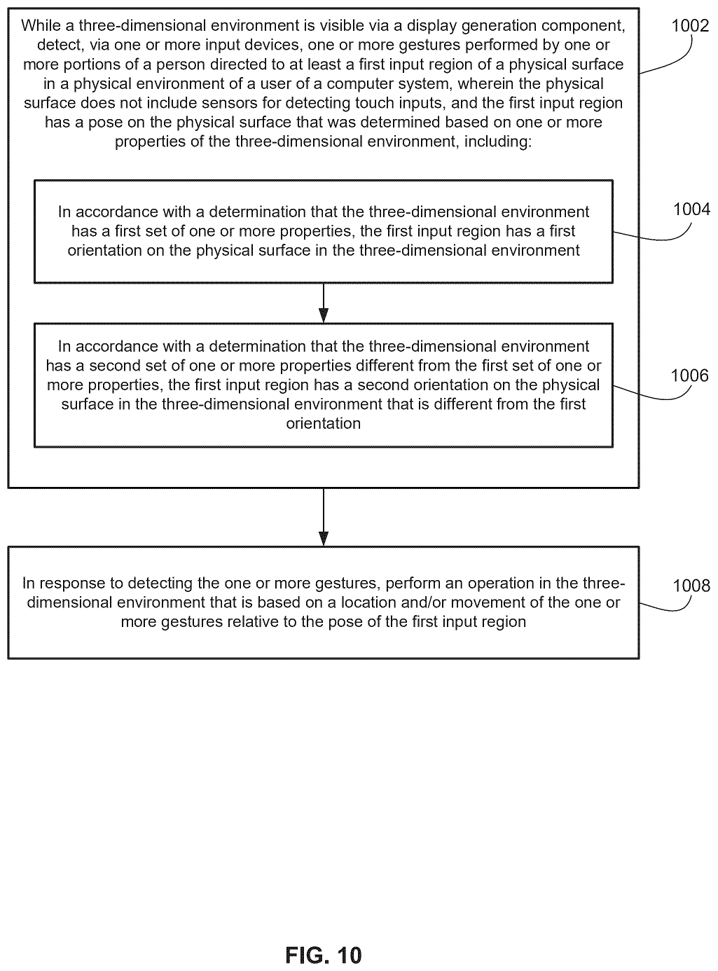

FIGS. 1A-6 provide a description of example computer systems for providing XR experiences to users (such as described below with respect to methods 800 and/or 1000). FIGS. 7A-7U illustrate example techniques designating input regions on displayed surfaces in a three-dimensional environment in accordance with some embodiments. FIG. 8 is a flow diagram of methods of designating input regions on displayed surface in a three-dimensional environment in accordance with some embodiments. The user interfaces in FIGS. 7A-7U are used to illustrate the processes in FIG. 8. FIGS. 9A-9K illustrate example techniques for determining a pose of an input region on a physical surface in a three-dimensional environment based on one or more properties of the three-dimensional environment in accordance with some embodiments. FIG. 10 is a flow diagram of methods of determining a pose of an input region on a physical surface in a three-dimensional environment based on one or more properties of the three-dimensional environment in accordance with some embodiments. The user interfaces in FIGS. 9A-9K are used to illustrate the processes in FIG. 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

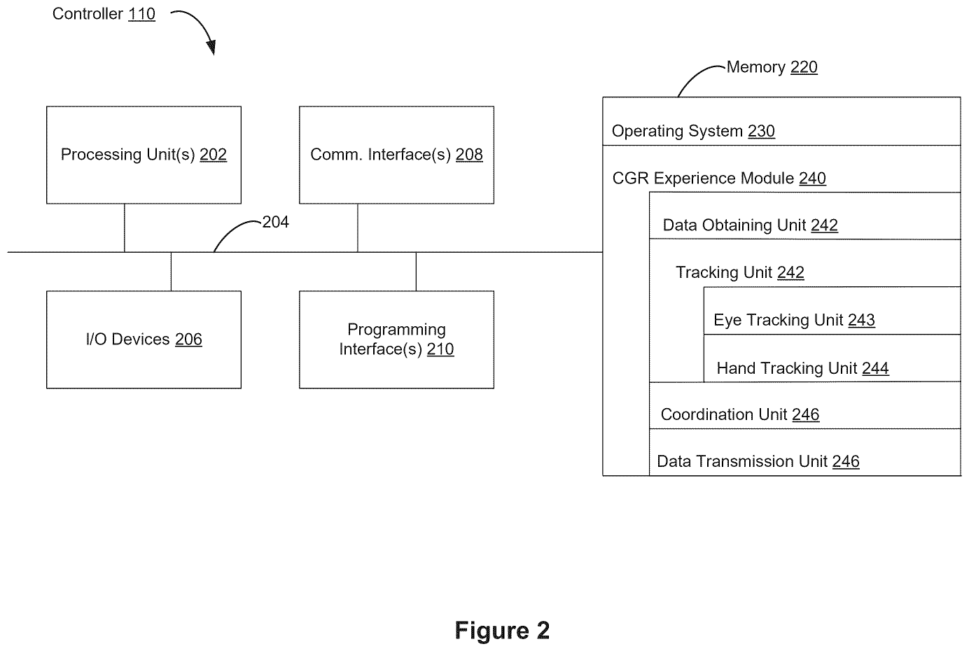

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

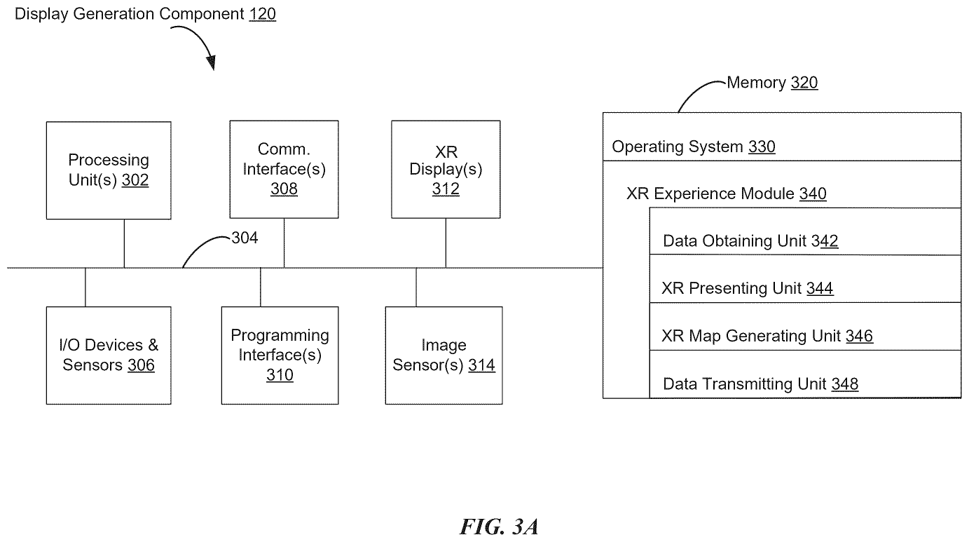

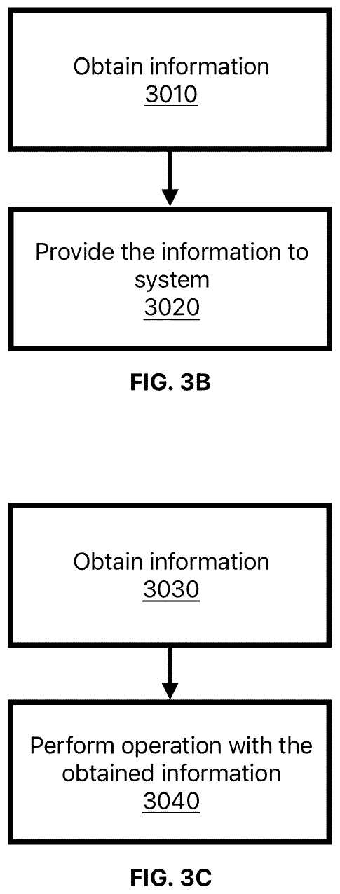

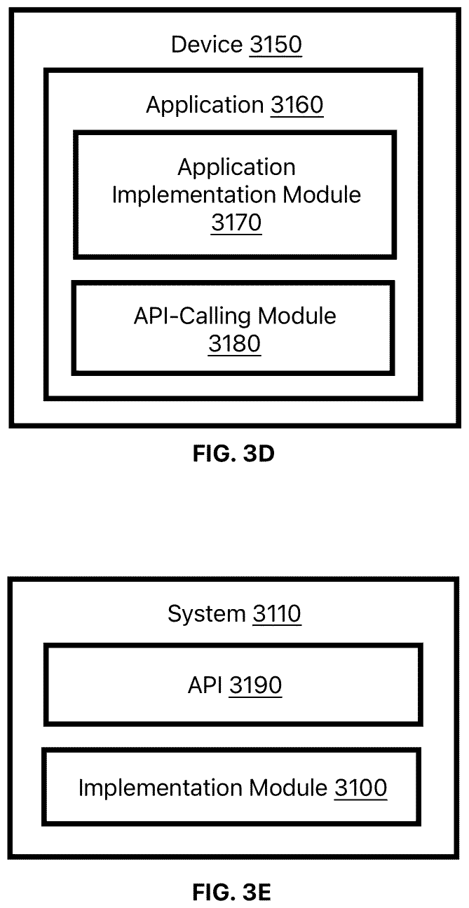

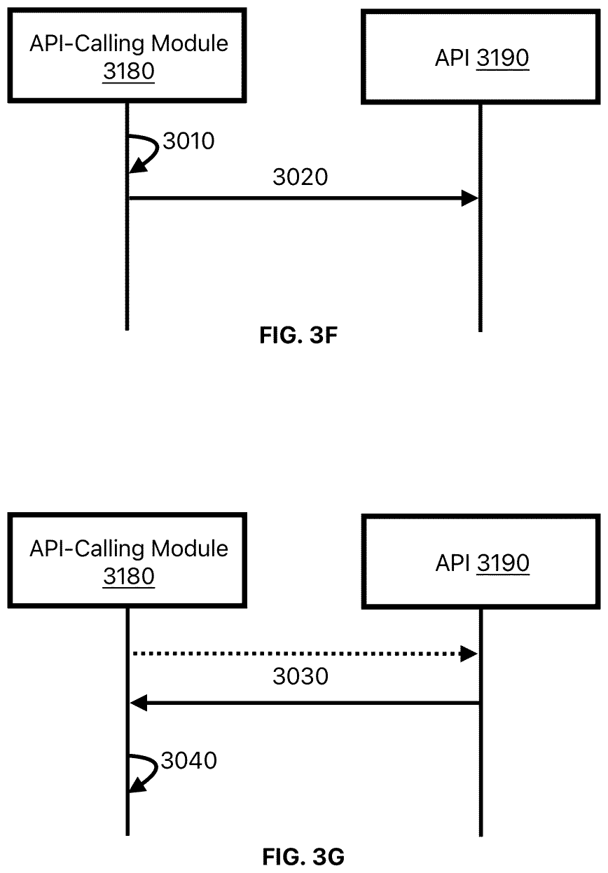

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100.

The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 11-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

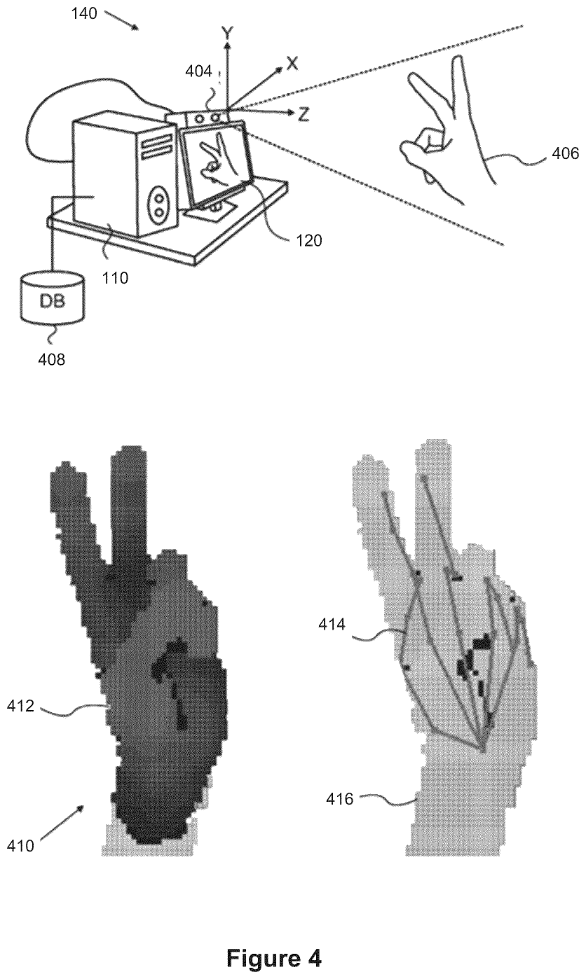

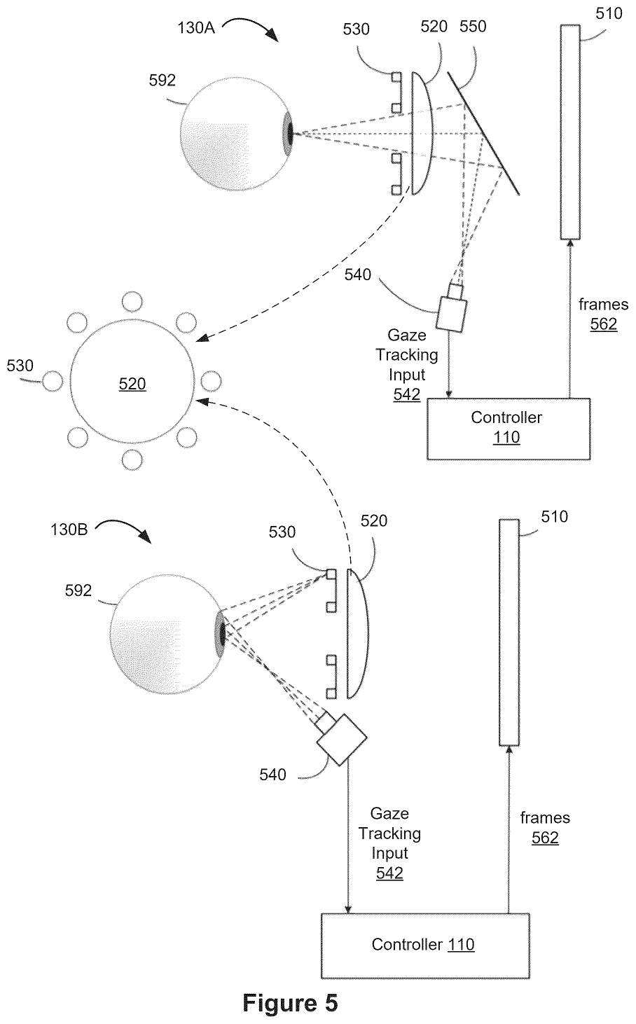

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 800 and/or 1000 (FIGS. 8 and/or 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

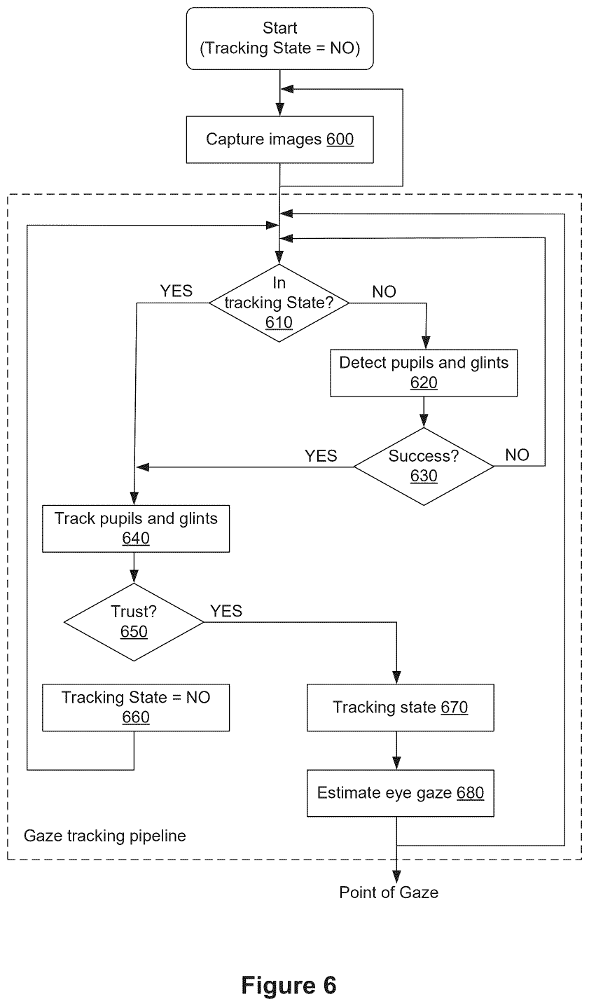

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7U illustrate examples of a computer system designating an input region on a physical surface that is visible in a three-dimensional environment based on inputs provided by a portion of person visible in the three-dimensional environment in accordance with some embodiments.

FIG. 7A illustrates a computer system 101 (e.g., an electronic device) displaying, via a display generation component (e.g., display generation component 120 of FIGS. 1 and 3), a three-dimensional environment 700 from a viewpoint of a user. In some embodiments, computer system 101 includes a display generation component 120. In FIG. 7A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 700 and/or the physical environment of the computer system 101 is visible via display generation component 120 (e.g., via passive passthrough). For example, as shown in FIG. 7A, the three-dimensional environment 700 includes a representation of a table 706, which is optionally a representation of a physical table in the physical environment, and a representation of a keyboard 715, which is optionally a representation of a physical keyboard in the physical environment of the computer system 101. In some embodiments, the keyboard 715 is in communication with the computer system 101 (e.g., as an input device). In some embodiments, the keyboard 715 is not in communication with the computer system 101 (e.g., and is optionally in communication with a different electronic device or computer system in the physical environment).

As discussed in more detail below, in FIG. 7A, display generation component 120 is illustrated as displaying content in the three-dimensional environment 700. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 7A-7U.

Display generation component 120 has a field of view (e.g., a field of view captured by external image sensors 114b and 114c and/or visible to the user via display generation component 120) that corresponds to the content shown in FIG. 7A. Because display generation component 120 is optionally a head-mounted device, the field of view of display generation component 120 is optionally the same as or similar to the field of view of the user. In some embodiments, as discussed in more detail with reference to method 800, the field of view of external image sensors 114b and 114c are larger than the field of view of the user such that objects and/or portions of the three-dimensional environment are visible to external image sensors 114b and 114c even though they are not visible to the user.

As discussed herein, the user performs one or more gestures and/or movements (e.g., with hand 702) to provide one or more inputs to computer system 101 to provide one or more corresponding inputs directed to content displayed by computer system 101. Such depiction is intended to be exemplary rather than limiting; the user optionally provides user inputs using different air gestures and/or using other forms of input as described with reference to the FIG. 9 series.

In the example of FIG. 7A, because the user's hand 702 is within the field of view of display generation component 120, it is visible within the three-dimensional environment 700. That is, the user can optionally see, in the three-dimensional environment 700, any portion of their own body that is within the field of view of display generation component 120.

As mentioned above, the computer system 101 is configured to display content in the three-dimensional environment 700 using the display generation component 120. In FIG. 7A, the three-dimensional environment 700 also includes virtual objects. In some embodiments, the virtual object 730 is optionally a user interface of an application containing content (e.g., a plurality of selectable options, images, text, and/or video), three-dimensional objects (e.g., virtual clocks, virtual balls, virtual cars, etc.) or any other element displayed by computer system 101 that is not included in the physical environment of display generation component 120. For example, in FIG. 7A, the virtual object 730 is a user interface of a web-browsing application containing website content, such as text, images, video, hyperlinks, and/or audio content. As an example, in FIG. 7A, the virtual object 730 includes a first photo 732a, a second photo 732b, and a third photo 732c (as illustrated only portions of images 732a and 732c are visible within virtual object 730). In some embodiments, the user interface of virtual object 730 is configured to be scrollable (e.g., upward and/or downward) in the three-dimensional environment 700, such that additional and/or previous images are able to be displayed in the user interface of the virtual object 730. It should be understood that the content discussed above is exemplary and that, in some embodiments, additional and/or alternative content and/or user interfaces are provided in the three-dimensional environment 700, such as the content described below with reference to methods 800 and/or 1000. Additionally, in some embodiments, as shown in FIG. 7A, the virtual object 730 is displayed with an exit option and grabber bar (indicated by reference 735 in FIG. 7A). In some embodiments, the exit option is selectable to initiate a process to cease displaying the virtual object 730 in the three-dimensional environment 700. In some embodiments, as discussed below, the grabber bar 735 is selectable to initiate a process to move the virtual object 730 within the three-dimensional environment 700.

In some embodiments, a control window 734 is displayed concurrently with virtual object 730 as illustrated in FIG. 7A. In some embodiments, control window 734 includes one or more interactive controls for interacting with virtual object 730. For instance, in the example where virtual object 730 is a photo application displaying one or more photos 732a-c, control window 734 includes one or more interactive controls for interacting with the photo applications such as photo editing controls pertaining to cropping an image, applying one or more effects to the photos, and/or modifying one or more parameters of the photos. Additionally, in some embodiments, as shown in FIG. 7A, control window 734 is displayed with its own exit option and grabber bar 733. In some embodiments, the exit option is selectable to initiate a process to cease displaying control window 734 in the three-dimensional environment 700. In some embodiments, as discussed below, the grabber bar 733 is selectable to initiate a process to move the control window 734 within the three-dimensional environment 700.

In some embodiments, the user's hand 702 (or the hand of another person that is not the user, but that is visible within three-dimensional environment 700) is laid flat against the surface of table 706 such that the fingers of the user are extended and resting against the surface of table 706 as illustrated in FIG. 7A. In some embodiments, computer system 101 using sensors 114b and 114c recognizes the pose of the user's hand as a predefined pose that is in accordance with the user's desire to designate a portion of the physical surface of table 706 as an input region, and initiates a process to designate an input region on the physical surface of table 706 as illustrated in FIG. 7B.

As illustrated in FIG. 7B, in response to determining that the pose of hand 702 matches a predefined pose that is in accordance with an intent to designate an input region on a physical surface of table 706, computer system 101 displays a prompt 704 for prompting the user to define a boundary of the input region on the physical surface of table 706. In some embodiments, using hand 702, the user (or the person whose hand 702 is visible in three-dimensional environment 700) defines a boundary of an input region as illustrated in FIG. 7C.

As illustrated in the example of FIG. 7C, hand 702 applies an input using hand 702 to define a boundary 705 for an input region to be designated by computer system 101 on the physical surface of table 706 such that once designated, the user can apply inputs to the computer system 101 using the input region. For instance, as illustrated in FIG. 7C, the user traces boundary 705 using a finger of hand 702 in a rectangular shape such that an input region 710 is designated with a boundary 705 as illustrated in FIG. 7D. In some embodiments, the boundary 705 is visually displayed in the three-dimensional environment 700. Optionally, the boundary 705 is not displayed when traced by finger of hand 702. The shape and/or size of boundary 705 are meant as exemplary, and in some embodiments, the user optionally defines any type of boundary including a circular boundary, a square boundary, a triangular boundary, and/or an abstract boundary. In some embodiments, the user optionally defines the size of boundary 705 using the input described with respect to FIG. 7C and optionally the size is only constrained by the dimensions of the physical surface that the input region is being designated on (e.g., the size of boundary 705 cannot exceed the dimensions of table 706).

As illustrated in FIG. 7D, once the user has established boundary 705, computer system 101 designates input region 710 on the physical surface of table 706. In some embodiments, an input region such as input region 710, refers to a region of a physical surface visible in the three-dimensional environment with respect to which computer system 101, upon detecting an input being applied by the user to the input region, performs an operation that is in accordance with the input detected at the input region. In some embodiments, an orientation 709 of the input region (e.g., the direction in which the input region is facing) is based on the location and/or orientation of virtual object 730 and/or control window 734 that the input region 710 is designated to interact with as described with respect to method 1000. Additionally or alternatively, if computer system 101 is displaying multiple virtual objects that input region 710 can be used to interact with, the orientation 709 of the designated input region is optionally based on the orientation of the physical surface (e.g., table 706) that the input region is on. In some embodiments, the orientation 709 of input region 710 is based on the user's input that was provided to designate input region 710 as discussed above with respect to FIG. 7C. In some embodiments, computer system 101 displays, via display generation component 120, a visual indicator and/or indication of input region 710 within three-dimensional environment 700 such that the user is provided with a visual indication as to where in the three-dimensional environment 700 the input region 710 is located. In some embodiments, the visual indication includes display input region 710 with one or more visual characteristics such as color, brightness, highlighting, and/or other visual characteristics that are designed to allow the user to visually discern where in the three-dimensional environment input region 710 is located.

In some embodiments, and as illustrated in FIG. 7D, once input region 710 has been designated by computer system 101, the computer system prompts the user to apply inputs to input region 710 for the purpose of calibrating the input region. In some embodiments, computer system 101 prompts the user/person to calibrate the input region 710 by displaying one or more visual indicators 708 that guide the user through the process of calibrating the input region. For instance, and as illustrated in FIG. 7D, the visual indicator 708 includes a path for the user to trace with their finger and one or more tap points where the user is to apply a tap input (described in further detail below with respect to method 800). In some embodiments, the calibration process ensures that the input region can be used by the computer system 101 to accurately record inputs that are applied to it. In some embodiments, once computer system 101 determines that the calibration procedure indicated by visual indicator 708 has been completed, input region 710 is fully designated by computer system 101 to accept inputs as illustrated in FIG. 7E

In the example of FIG. 7E, input region 710 is designated by computer system 101 for accepting inputs to the computer system, optionally meaning that the computer system 101 through image sensors 114b-c determines when a portion of the user (e.g., hand 702) provides a movement or other interaction with input region 710 in accordance with providing an input to the input region 710 and performs an operation on the computer system 101 in accordance with the provided input. For instance, and as described in further detail below, inputs provided by hand 702 to input region 710 are be used by computer system 101 to perform operations at virtual object 730 and/or control window 734. In the example of control window 734, the user applies inputs to input region 710 using hand 702, which results in computer system 101 performing operations on the control window 734 and those operations are used to control the content of virtual object 730, thus providing the user with an “indirect” method for controlling virtual object 730. In some embodiments, control window 734 is designated in response to the input that designates input region 710, and/or in response to the completion of the calibration procedure described above.

In some embodiments, input region 710 is configured by computer system 101 to allow the user to apply direct controls to virtual object 730 by projecting control window 734 directly onto input region 710 as illustrated in FIG. 7F. In the example of FIG. 7F, computer system 101 ceases display of control window 734 next to virtual object 730 and instead projects an image of control window 734 directly onto input region 710. Thus, optionally, the user interacts directly with control window 734 when applying inputs to input region 710 since the user optionally interacts with control window 734 directly via input region 710. In some embodiments, the selectable options and various controls on control window 734 are projected onto input region 710 and are optionally selected or interacted with when the user touches or applies input to the portion of the input region 710 that coincides with a particular control and/or selectable option. For instance, control window 734 includes one or more visual characteristics controls such as brightness and/or color that when interacted change the brightness and/or color of virtual object 730.

Referring back to the example of FIG. 7A, in addition to or alternatively to detecting that hand 702 is laying flat with fingers extended on a physical surface that is visible in the three-dimensional environment 700 to initiate designation of an input region, the process to designate an input region is optionally initiated in response to a number of predefined poses and/or gestures of hand 702 as illustrated in FIGS. 7G-7J. For instance, in the example of FIG. 7G, in response to detecting that hands 701 and 702 are making a framing gesture (e.g., hand 701 and 702 form an L-shape with the thumb and index fingers of each hand forming a frame, described in further detail below with respect to method 800), computer system 101 designates an input region 710 as illustrated in FIG. 7H. As illustrated in FIG. 7H, the size and/or extent region 710 is based on the distance between hands 701 and 702 and/or the fingers of hands 701 and 702 when forming the framing gesture.

In some embodiments, computer system 101 detects the user performing a multi-finger tap on the physical surface of table 706 and in response designates an input region 710 as illustrated in FIGS. 71-7J. As illustrated in FIG. 7I, computer system 101 detects the hand 702 of the user/person performing a multi-finger tap gesture 720 (described in further detail below with respect to method 800). As illustrated in side view 711, a multi-finger tap gesture 720 includes four fingers making concurrent contact with the physical surface of table 706. In some embodiments, the computer system 101 recognizes fewer or more fingers making contact with the surface of table 706 as a multi-finger tap gesture. In some embodiments, and in response to detecting multi-finger tap gesture 720, computer system designates input region 710 on the surface of table 706 as illustrated in FIG. 7J. In some embodiments, the location on the surface of table 706 is based on the location on the surface of table 706 that the multi-finger tap gesture 720 is performed at as illustrated in in FIG. 7J

In some embodiments, once input region 710 has been designated by computer system 101, input region 710 is available to be used an additional input device or mechanism for interacting with computer system 101, virtual object 730 and/or other portions of the three-dimensional environment as illustrated in FIGS. 7J-7M. For instance, as illustrated in FIG. 7J, computer system 101 detects hand 702 performing a tap gesture 720 at input region 710, while also detecting that the user's gaze 736 is directed to virtual object 730. In some embodiments, computer system 101 determines where the user's gaze 736 is directed when an input is received at input region 710, in order to determine what operation to perform in response to receiving the input at input region 710. In some examples, a tap gesture 720 includes detecting a finger of the user making contact with the surface of table 706 within input region 710 as illustrated by side view 711. In some embodiments, in response to detecting the user's gaze 736 directed to virtual object 730 at the time that tap gesture 720 is received at input region 710, computer system 101 performs an operation on the virtual object 730 in accordance with the tap input 720 received at input region 710 as illustrated in FIG. 7K.

As illustrated in FIG. 7K, in response to detecting that the user's gaze 736 is directed to virtual object 730, and specifically to photo 732b at the time that tap gesture 720 is received at input region 710, computer system 101 selects photo 732b such that the photo is displayed at full size on the window of virtual object 730. In this way, rather than requiring the user to direct their gaze at photo 732b and perform an air gesture, computer system 101 provides an alternative input method (e.g., input region 710) that allows the user to perform operations on virtual object 730. In some embodiments, computer system 101 via designated input region 710 allows for the user to provide additional types of inputs to input region 710 that when detected by computer system 101, will cause the computer system 101 to perform additional operations that are different than an operation performed in response to a tap input 720, as illustrated in FIG. 7L.

In the example of FIG. 7L, computer system 101 detects that the user/person is performing a drag input 750 at input region 710. In some embodiments, and as illustrated in side view 711, a drag input 750 includes detecting that the user is contacting input region 710 (e.g., the surface of table 706 where the input region is designated) with their finger while “dragging” their finger (e.g., moving the finger across the surface while making contact with the surface). In some embodiments, and as illustrated in FIG. 7L, in response to detecting the user's gaze 736 directed to virtual object 730 and specifically to photo 732b when drag input 750 is detected, computer system 101 initiates a scroll operation on photo 732b. In some embodiments, the amount of scrolling performed by computer system 101 is based on the detected distance of the drag input 750 as illustrated in FIG. 7M. For instance, as shown in FIG. 7L, photo 732b begins to scroll up in response to drag input 750, and as illustrated in FIG. 7M, in response to detecting that the hand 702 while performing drag input 750 has moved further up input region 710, computer system 101 further scrolls photo 732b such that it only is partially visible in virtual object 730, while photo 732c is now fully visible. In some embodiments, and as illustrated in side view 711 of FIG. 7M, computer system 101 determines that the drag input has been terminated when the computer system detects that the user's finger has been lifted off input region 710 after having been dragged as previously described.

In some embodiments, once an input region 710 has been designated by computer system 101, the computer system 101 optionally moves the input region to a different portion of the surface on which the input region was designated in response to user input as illustrated in FIGS. 7N-7P. In the example of FIG. 7N, computer system 101 detects that the user/person applies a pinch input 752 to input region 710 and while holding the pinch input 752, moves hand 702 in a direction. In some embodiments, and as illustrated at side view 711, a pinch input 752 includes placing two fingers in close proximity to and/or touching one another, wherein one of the fingers is the user's thumb. In response to detecting the predefined pinch input 752 followed by motion of the hand, computer system 101 initiates a process to move input region 710 to another portion of table 706 based on the movement of the user's hand 702 (e.g., in a direction and/or with a magnitude corresponding to the direction and/or magnitude of the movement of the hand 702) while engaged in a pinch input 752 as illustrated in FIG. 7O.

As illustrated in FIG. 7O, upon determining that the user is performing a pinch gesture 752 while dragging their pinched fingers across table 706, computer system 101 moves input region 710 in accordance with the distance that hand 702 has moved while performing the pinch gesture 752. In some embodiments, computer system 101 moves input region 710 such that the input region follows hand 702 as it is performing the pinch gesture 752 while dragging input region 710. In some embodiments, computer system 101 displays a visual warning to the user when the user attempts to move the input region 710 to a location within the three-dimensional environment 700 and/or on the surface of table 706 where the input region will not be able to be placed due to size/shape of input region 710. For instance, as illustrated in FIG. 7O, when computer system 101 detects that hand 702 has moved to a position at which if input region 710 were placed it would be partially off of the surface of table 706, computer system 101 provides one or more visual indicators 740 warning the user that they are placing the input region at a location that is not possible or appropriate for the input region. In some embodiments, in addition to and/or alternatively to displaying a separate visual indicator 740 providing the warning to the user, computer system 101 also provides a visual indicator on the input region 710 itself in the form of changing the color of the input region 710 or some other visual feature of the input region thereby warning the user that they are attempting to move the input region 710 beyond the limits of table 706. In some embodiments, in addition and/or alternatively to displaying a visual indicator 740, computer system 101 applies a rubber-band effect to the movement of input region 710 (described in further detail below with respect to method 800).

In some embodiments, in response to detecting that the user has terminated the pinch gesture 752 (as shown in side view 711 wherein the fingers have lifted off of the surface of table 706), computer system 101, re-designates input region 710 at the location at which hand 702 was located when the input is terminated as illustrated in FIG. 7P. As illustrated in FIG. 7P, computer system 101 places input region 710 at the location of hand 702 when pinch gesture 752 is terminated, thus moving the input region 710 from the right side of table 706 to the left side.

In some embodiments, in addition to providing a warning to the user that they are attempting to place the input region in a region that is beyond the bounds of table 706, computer system 101 detects when the input region 710 is moving outside of the field of view of image sensors 114b-c and provides the user with a warning as illustrated in FIGS. 7Q-7S. In the example of 7Q, and as illustrated by top-down view 760, the image sensors 114b-c, optionally when part of a head mounted display being worn by user 742, have a field of view (e.g., field of sensing) 762. Field of view 762 represents the area of the three-dimensional environment 700 in which image sensors 114b-c optionally detect movement and poses of the user's hand 702. In some embodiments, the field of view 762 of computer system 101 is broader than the user's field of view 764, which is visible via display generation component 120 in FIG. 7Q. In some embodiments, in order to be able to detect inputs to input region 710, the input region 710 must be in the field of view 762 of the head mounted display, such that computer system 101 can sense hand 702 applying inputs to input region 710. In some embodiments, if the location input region 710 is beyond the field of view 762 of computer system 101, then computer system 101 will no longer be able to detect inputs being applied to input region 710 as illustrated in FIGS. 7R-7S.

In the example of FIG. 7R, user 742 has rotated their view point (e.g., by turning their body and/or head) such that input region 710 is no longer within the field of view 764 of the user, but is still within the field of view 762 of image sensors 114b-c. When the user's viewpoint is rotated as illustrated in FIG. 7R such that the input region 710 is outside the field of view 764 of the user but still within the field of view 762 of the sensors, if the user applied an input to input region 710, computer system 101 will still be able to detect input region 710, even though the user may not be able to see it, and thus will still be able to determine if hand 702 of user 742 has applied an input to input region 710, and can also further determine the nature of any input applied to input region 710. For instance, if user 742 applies a tap input 720 to input region 710 (which is still within the field of view 762 of computer system 101, but is outside of the user's field of view 764), computer system 101 will optionally detect and/or see the input being applied to input region 710. In some embodiments, computer system 101 in response to detecting that the input region 710 is no longer within the field of view 762 of the computer system (for instance due to the user further rotating their point of view), displays one or more visual indicators warning user 742 that the input region 710 is outside of the field of view as illustrated in FIG. 7S.

As illustrated in FIG. 7S, in response to detecting that input region 710 is outside of the field of view 762, computer system 101 displays a visual indicator 756 that alerts the user that the input region is outside of the field of view and thus any input applied to input region 710 may not be detected. In some embodiments, visual indicator 756 shares one or more characteristics of the visual indicator 740 described with respect to FIG. 7O and/or the one or more visual indicators described with respect to method 800. In some embodiments, once the computer system 101 detects that input region 710 has returned within the field of view 762, computer system 101 ceases display of visual indicator 756 as illustrated in FIG. 7T.

In the example of FIG. 7T, the user has rotated their viewpoint so that input region 710 is within both the field of view 762 of computer system 101 as well as the field of view 764 of the user (e.g., the viewable area of three-dimensional environment 700 displayed on display generation component 120). Thus, and as illustrated in FIG. 7T, computer system 101 no longer displays the visual indicator 756 previously illustrated in FIG. 7S. In some embodiments, computer system 101 also is able to cease designation of an input region (e.g., de-designate an input region) in response to detecting a pre-defined user input being applied to input region 710. For instance, and as illustrated in FIG. 7T, computer system 101 detects hand 702 applying a multi-finger tap gesture 720 to input region 710 (as also shown in side view 711). In some embodiments, multi-finger tap gesture 720 is the same multi-finger tap gesture that was used to create input region 710 such that the multi-finger tap gesture when first applied creates the input region, and when applied again while the input region 710 is active causes the input region 710 to be de-designated. In some embodiments, in response to detecting the multi-finger tap gesture 720, computer system 101 ceases designation of input region 710 as illustrated in FIG. 7U.

As illustrated in FIG. 7U, computer system 101, in response to determining that hand 702 has performed the multi-finger input/gesture at input region 710 (in FIG. 7T) ceases display and/or designation of the input region such that any inputs applied to the surface of table 706 that used to be part of input region 710, when detected, no longer cause computer system 101 to perform an operation (for instance on either of virtual object 730 and/or control window 734).

FIG. 8 is a flowchart illustrating a method of designating an input region on a physical surface in a three-dimensional environment. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, the method 800 is performed at a computer system in communication with a display generation component, and one or more input devices. For example, a mobile device (e.g., a tablet, a smartphone, a media player, or a wearable device), or a computer or other electronic device. In some embodiments, the display generation component is a display integrated with the electronic device (optionally a touch screen display), external display, such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, and/or detecting a user input.) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device and/or a motion sensor (e.g., a hand tracking device, a hand motion sensor), etc. In some embodiments, the computer system is in communication with a hand tracking device (e.g., one or more cameras, depth sensors, proximity sensors, touch sensors (e.g., a touch screen, trackpad)). In some embodiments, the hand tracking device is a wearable device, such as a smart glove. In some embodiments, the hand tracking device is a handheld input device, such as a remote control or stylus.

In some embodiments, while a three-dimensional dimensional environment is visible via the display generation component, wherein the three-dimensional environment includes a first physical surface that does not include sensors for detecting touch inputs, the computer system detects (802), via the one or more input devices (e.g., one or more remote body tracking devices, such as cameras, motion sensors, proximity sensors and/or depth sensors), a first input corresponding to a request to designate a first portion of the first surface as a first input region, such as hand 702 performing a gesture (e.g., laying flat against table 706) in FIG. 7A. In some embodiments, the three-dimensional environment at least partially incorporates a representation of the real-world physical environment of the user while using the computer system (e.g., via active or passive passthrough). Optionally, the first surface includes a real word physical surface (such as a table top, floor, desk, and/or any physical object) that is part of the real-world physical environment of the user. Additionally or alternatively, the first surface is a virtual surface of a virtual object that is displayed as part of the three-dimensional environment. In some embodiments, the three-dimensional environment includes one or more virtual objects that are displayed by the computer system when the first input is detected. Examples of virtual objects include, but are not limited to, content windows, graphical user interfaces, and/or objects that are not part of a physical real-world environment that is visible via the display generation component. In some embodiments, the computer system is not configured to accept gestures or other inputs performed on the physical surface as inputs to the computer system prior to the surface being designated as a first input region. In some embodiments, detecting the first input includes detecting, using one or more cameras that are part of or communicatively coupled to the computer system, the user arranging and/or moving one or more portions of their body in a manner that has optionally been defined for designating surfaces in the three-dimensional environment as an input region. In some embodiments, the first surface is partially or fully visible within the field of view of the user when the first input is received. In some embodiments, the first input is performed on the first surface itself, or alternatively it is performed at any location that is visible to the one or more remote body tracking devices of the computer system. In some embodiments, different portions of the same physical surface are designated as input regions based on different user inputs applied at or on the portions of the physical surface (discussed in detail further below). Examples of the first input include, but are not limited to air gestures and touch inputs on a touchpad or other input device. In some embodiment, once the computer system recognizes that the first input corresponds to the input for designation of a surface and/or portion of a surface as a input region, the computer system treats the designated surface and/or portion of the first surface as another input device of the computer system, for instance as if the surface was a trackpad and/or touch sensor that was communicatively coupled to the computer system.

In some embodiments, while the first portion of the first surface is designated as the first input region, the computer system detects (804), via the input devices, movement of a first portion of a person (e.g., a user of the computer system) directed to the first input region, such as hand 702 performing tap gesture 720 in FIG. 7J. In some embodiments, the first portion of the user includes but is not limited to one or more of the hands (including fingers and finger tips) and/or the arms of the user. In some embodiments, the first gesture includes but is not limited to air gestures performed by the user's hands and/or gestures that are performed on the first surface. Optionally, the first gesture includes inputs provided on an input device, such as a trackpad and/or electronic stylus. In some embodiments, the first gesture is directed to the first input region when the one or more portions of the user perform the first gesture on or in proximity (e.g., within 0.05, 0.1, 1, 10, 100 or 1000 mm) to the first input region.

In some embodiments, in response to detecting the movement of the first portion of the person (806): in accordance with a determination that the movement of the first portion of the person was directed to (or on) the first input region, the computer system performs (808) an operation at the computer system in accordance with the movement of the first portion of the person relative to the first input region, such as in response to detecting that the user's gaze 736 is directed to virtual object 730, and specifically to photo 732b at the time that tap gesture 720 is received at input region 710, computer system 101 selects photo 732b such that the photo is displayed at full size on the window of virtual object 730 in FIG. 7K.

In some embodiments, in response to detecting the movement of the first portion of the person, in accordance with a determination that the movement of the first portion of the person was not directed to the first input region, the computer system forgoes (810) performing the operation at the computer system in accordance with the movement of the first portion of the person relative to the first input region, such as if the tap gesture 720 in FIG. 7J-K was performed outside of input region 710, and computer system 101 did not select photo 732b in response to tap gesture 720. In some embodiments, the three-dimensional environment is an extended reality (XR) environment, such as a virtual reality (VR) environment, a mixed reality (MR) environment, or an augmented reality (AR) environment. In some embodiments, in order to detect gestures being applied to a designated input region, the computer system utilizes one or more remote body tracking devices (e.g., cameras and/or depth sensors) that are part of and/or communicatively coupled to the computer system to detect gestures being applied to the input region by the user. In some embodiments, and in the example of the remote body tracking device being a camera, the one or more cameras include both inward facing cameras and/or outward facing cameras that are part of a head mounted display (described in detail above). In some embodiments, in response to receiving an indication of movement of the first portion of the person at the input region, and while the user is engaged with a software application that is running on the computer system, the computer system performs an operation on the software application corresponds to the input that is provided by the user on the input region. For instance, if the computer system detects that the user has performed a “tap” gesture on the designated input region using their fingers (e.g., the user places one or more of their finger tips on the input region and then removes them in a single motion), the computer system interprets the detected input as if the tap had occurred on a track pad and/or touch sensor and performs an operation at the software application that corresponds to the tap (for instance selecting a selectable option on a graphical user interface of the software application that is being displayed as part of the three-dimensional environment). In some embodiments, a gesture includes any input provided by a portion of the user's body, an electronic stylus, and/or other input device at the input region. In some embodiments, at the input region refers to being in contact with or not in contact with but in proximity to the input region (e.g., 0.05, 0.1, 1, 10, or 100 mm). In some embodiments, the computer system recognizes and/or responds to gestures that are provided within the input region created on the surface as inputs, while ignoring gestures provided to the surface that are outside of the designated bounds of the input region. Configuring surfaces visible in a three-dimensional environment as input regions for accepting inputs from a user reduces the power needed by the computer system to power and/or respond to inputs provided via different input devices (e.g., an electronic trackpad) and increases the total number of ways in which a user can provide inputs to the computer system, thus minimizing the likelihood of the user providing erroneous input to the computer system by allowing the user to have the flexibility to provide inputs to the computer system according to their preferences, thereby conserving computing resources of the computing system associated with correcting erroneous input.

In some embodiments, detecting, via the one or more input devices, the first input corresponding to the request to designate the first portion of the first surface as the first input region comprises detecting a second portion (e.g., the same as or different from the first portion) of the person performing a first gesture directed to the first portion of the first surface that satisfies one or more criteria, such as framing gesture performed by hands 701 and 702 in FIG. 7G. In some embodiments, the device designates an input region in response to detecting that the user has performed a specific hand gesture directed to the portion of the surface that they wish to designate as an input region. In some embodiments, the hand gesture is a gesture that is distinguishable from other air gestures and/or hand gestures that would otherwise be used by the user to provide input to the computer system, thereby avoiding erroneous designations of input regions when the user intended to provide input to applications running on the computer system. In some embodiments, the hand gestures utilize the full hand of the user and/or multiple fingers of the user (e.g., beyond two, which is optionally the maximum number fingers involved in gestures that are meant to provide input to applications running on the computer system). In some embodiments, the first gesture is “directed to the first portion” when the gesture is performed at/on a location that corresponds to the location of the first portion of the physical surface in the three-dimensional environment. In some embodiments, the one or more criteria are satisfied when the computer system determines that the first gesture is in accordance with one or more specific gestures associated with an indication to designate an input region, such as described in more detail below. In some embodiments, if the first gesture does not satisfy the one or more criteria (for instance because the gesture is not one of the gestures associated with designating an input region) then the device does not designate the first portion of the first physical surface as an input region. Using hand gestures to designate input regions minimizes the number of inputs required to designate an input region and minimizes the likelihood of a surface being erroneously designated as an input region, thereby conserving computing resources of the computing system associated with extra inputs that would otherwise be needed to designate an input region and extra input required to correct erroneous designations of input regions.

In some embodiments, the one or more criteria include a criterion that is satisfied when the first gesture is a first pose performed within a threshold distance of the first portion of the first surface, such as the framing gesture performed by hands 701 and 702 in FIG. 7G being performed within a threshold distance of the surface of table 706. In some embodiments, the computer system designates an input region upon the satisfaction of two criteria: (1) a determination that the second portion of the user is engaged in a respective pose, and (2) that the respective pose is being performed within a threshold distance of the input region. In some embodiments, the input region is designated if at least one of the two criteria above are satisfied. In some embodiments, the respective pose is a pose of the user's hand that is distinguishable from other inputs that are generally associated with providing input to one or more applications associated with the computer system (e.g., different from the movement of the first portion of the person detected while the first portion of the first surface is designated as the first input region). In some embodiments, the threshold distance is such that if the user is touching the surface and/or nearly touching the surface (e.g., within. 1 mm, 1 mm, 10 mm, and/or 1 cm) and is performing the respective pose, the computer system will determine that the user intends to designate the surface as an input region. Using specific poses to designate input regions, while the pose is being performed within a threshold distance of a surface, minimizes the number of inputs required to designate an input region and minimizes the likelihood of a surface being erroneously designated as an input region, thereby conserving computing resources of the computing system associated with extra inputs that would otherwise be needed to designate an input region and extra input required to correct erroneous designations of input regions.

In some embodiments, the second portion of the person comprises a palm of the person's hand, and wherein the one or more criteria include a criterion that is satisfied when the computer system detects that the palm of the person is located within the threshold distance from the first portion of the surface, such as the palm of hand 702 being with a threshold distance of the surface of table 706 in FIG. 7A, and in response computer system 101 designating input region 710 as shown in FIG. 7D. In some embodiments, the computer system determines the user's intention to designate a surface as an input region if the computer system determines that the user's palm is placed on the surface and/or hovering within a threshold distance from the surface. In some embodiments, the computer system determines the user's intention to designate the surface, if it detects that the palm of the user is on or hovering over the surface for longer than a time threshold (e.g., 0.1 s, 1 s, or 5 s) thereby avoiding inadvertent designation of an input region in cases where the user inadvertently or unintentionally places the palm of their hand on a surface that is visible in the three-dimensional environment for a shorter duration. In some embodiments, the location on the surface that the palm is on determines the location of the input region (e.g., the palm detected at different locations on the surface results in different corresponding portions of the surface being designated as the first input region). In some embodiments, the palm optionally faces towards the input region in order to satisfy the one or more criteria. In some embodiments, if the computer system detects that the palm is not facing towards the input region, then the one or more criteria are not satisfied. Using a palm on the surface to be designated as a gesture and designating the input region when the palm is within a threshold distance of a surface, minimizes the number of inputs required to designate an input region and minimizes the likelihood of a surface being erroneously designated as an input region, thereby conserving computing resources of the computing system associated with extra inputs that would otherwise be needed to designate an input region and extra input required to correct erroneous designations of input regions.

In some embodiments, the second portion of the person comprises one or more fingers of a hand of the person, and wherein the one or more criteria include a criterion that is satisfied when the computer system detects that the one or more fingers of the person's hand are extended and are located within the threshold distance from the first portion of the first physical surface, such as the fingers of hand 702 in FIG. 7A being extended from the palm of hand 702 and being on or near the surface of table 706. In some embodiments, and in addition to or alternatively to detecting the palm of the user on the surface to designate an input region, the computer system determines the user's intention to designate a surface as an input region if the computer system determines that one or more fingers of the user are placed on the surface and/or hovering within a threshold distance from the surface. In some embodiments, the computer system determines the user's intention to designate the surface, if it detects that the fingers of the user are on or hovering over the surface for longer than a time threshold (e.g., 0.1 s, 1 s, or 5 s) thereby avoiding inadvertent designation of an input region in cases where the user inadvertently or unintentionally places the palm of their hand on a surface that is visible in the three-dimensional environment for a short duration. In some embodiments, the number of fingers required is more than two (e.g., three, four, or five) so as to avoid erroneous designation of an input region when the user is performing a gesture associated with an application running on the computer system, and/or the user inadvertently place one or more of their fingers on a surface that is visible within the three-dimensional environment. In some embodiments, the computer system requires that the user's finger are extended (e.g., the user has stretched out their fingers to their maximum length) so as to further avoid erroneously designation of input regions if the user is inadvertently placing one or more of their fingers on a surface that is visible in the three-dimensional environment. In some embodiments, the location on the surface that the fingers are extended on determines the location of the input region (e.g., the fingers detected being extended at different locations on the surface results in different corresponding portions of the surface being designated as the first input region). Using fingers extended on the surface to be designated as a gesture for designating an input region and designating the input region when the extended fingers are within a threshold distance of a surface, minimizes the number of inputs required to designate an input region and minimizes the likelihood of a surface being erroneously designated as an input region, thereby conserving computing resources of the computing system associated with extra inputs that would otherwise be needed to designate an input region and extra input required to correct erroneous designations of input regions.

In some embodiments, the one or more criteria include a criterion that is satisfied when the computer system detects the second portion of the person performing a framing gesture directed to the first portion of the first physical surface, such as the framing gesture performed by hands 701 and 702 on the surface of table 706 in FIG. 7G. In some embodiments, a framing gesture refers to a gesture in which both hands of the user form an L-shape with the thumb and pointer finger, and the two hands together form the outline of a frame (while the fingers of each hand are in the L-shape) thus framing a location on the surface to be designated as an input region. In some embodiments, the framing gesture is performed at or on the surface to be designated as in input region. Additionally or alternatively, the framing gesture is performed away from but over the surface to be designated. In some embodiments, the size of the framing gesture (e.g., the distance between the two hands when in an L-shape) determines the size of the input region. Additionally or alternatively, the computer system in response to detecting the framing gesture, designates an input region according to a specific size (e.g., 1 cm2 10 cm2, or 1 m2). In some embodiments, the location on the surface that the framing gesture is directed to (e.g., on or above) determines the location of the input region (e.g., placing the framing gesture at different locations on the first surface causes different portions of the first surface to be designated as an input region). Using a framing gesture on the surface to be designated as a gesture for initiating designation of an input region, minimizes the number of inputs required to designate an input region and minimizes the likelihood of a surface being erroneously designated as an input region, thereby conserving computing resources of the computing system associated with extra inputs that would otherwise be needed to designate an input region and extra input required to correct erroneous designations of input regions.

In some embodiments, the second portion of the person comprises a plurality of fingers of the user's hand, and wherein the one or more criteria include a criterion that is satisfied when the computer system detects that the plurality of fingers are concurrently performing a gesture directed to the first portion of the first surface, for instance the multi-finger tap gesture 720 performed by hand 702 in FIG. 7I. In some embodiments, the gesture performed by the plurality of fingers is a tap gesture in which the plurality of fingers simultaneously or near simultaneously tap the portion of the surface to be designated as an input region. Optionally, the gesture includes a single tap of the plurality of fingers and/or multiple taps of the plurality of fingers on the surface to be designated as an input region. In some embodiments, the gesture performed by the plurality of fingers is a swipe gesture in which the plurality of fingers simultaneously move across a portion of the surface to be designated as an input region. In some embodiments, the location on the surface where the gesture including the plurality of fingers occurs determines the location on the surface where the input region is to be designated (e.g., performing the gesture at different locations on a physical surface results in different regions of the physical surface being designated as an input region). Using a multi-finger gesture on the surface to be designated as a gesture for initiating designation of an input region, minimizes the number of inputs required to designate an input region and minimizes the likelihood of a surface being erroneously designated as an input region, thereby conserving computing resources of the computing system associated with extra inputs that would otherwise be needed to designate an input region and extra input required to correct erroneous designations of input regions.

In some embodiments, before detecting, via the one or more input devices, the first input corresponding to the request to designate a first portion of the first physical surface as the first input region, the computer system displays a designation user interface that prompts the person to provide the first input corresponding to the request to designate the first portion of the first surface as the first input region, such as prompt 704 displayed in FIG. 7B. In some embodiments, the computer system detects surfaces that are visible in the three-dimensional environment that are viable (and/or available) to be designated as an input region, and places a visual indicator in the form of the designation user interface that prompts the user to perform a gesture on the detected surface to designate the surface and/or portion of the surface as an input region. In some embodiments, the designation user interface is a textual prompt prompting the user to “Please define input area.” Additionally or alternatively, the designation user interface is a visually highlighted region of the detected surface (e.g., using color) showing a viable surface or portion of a surface where an input region can be designated. In some embodiments, the computer system displays a single designation user interface on a surface, and/or displays multiple designation user interfaces on a single surface in locations on the surface that are viable for being designated as an input region. In some embodiments, a portion of a surface is viable when there is large enough area on the surface (e.g., 1 cm2 10 cm2, or 1 m2) that is uninterrupted by other objects that are visible in the three-dimensional environment. Prompting the user to designate the location of the input region, ensures that the user designates portions of a surface as input regions only when the portion is viable for acting as an input region, thereby minimizing the likelihood of the user attempting to designate a portion of a surface as an input region that is not viable (e.g., large enough) to be designated as an input region, thereby conserving computing resources associated with the user attempting to designate portions of a surface as an input region that are not viable.

In some embodiments, in response to detecting the first input corresponding to the request to designate the first portion of the first physical surface as the first input region, the computer system displays a calibration user interface that prompts the person to provide one or more second inputs for calibrating the first input region, such as visual indicator 708 illustrated in FIG. 7D. In some embodiments, as part of the process of designating a surface and/or portion of a surface as an input region, the user is prompted (using a calibration user interface) to provide input on the surface to be designated as an input region so that the surface can be calibrated for use as an input region. In some embodiments, the calibration user interface includes a plurality of visual indicators that show locations within the input region that the user should tap and/or trace on so that the device can ascertain the height of the input region as well as the metes and bounds of the input region and/or the positioning of the user's fingers and/or hands relative to the input region. In some embodiments, if the computer system determines that one or more inputs applied to the first input region correspond to the prompted one or more second inputs, then the computer system calibrates the input region based on the provided one or more second inputs. Optionally, if the device determines that the one or more inputs do not correspond to the prompted one or more second inputs, then the computer system forgoes using the one or more inputs to calibrate the input region. By using a calibration user interface to guide the user through the calibration process, the computer device minimizes the likelihood of false positive inputs being performed on the designated input region (e.g., the computer device detecting an input on the input region when no input was intended), thereby conserving computing resources associated with correcting unintended inputs on the designated input region.

In some embodiments, the one or more second inputs for calibrating the first input region comprise a plurality of taps at a plurality of locations on the first input region, such as hand 702 tapping the circular marks of visual indicator 708 in order to calibrate input region 710 in FIG. 7D. In some embodiments, the calibration user interface (described above) includes one or more visual indicators for where on the designated input region the user should tap in order to calibrate the input region. In some embodiments, the taps performed by the user as part of the calibration process, aid the computer system in determining the height of the input region, such that the user can distinguish air gestures performed above or in proximity to the input region and gestures performed on the input region itself. In some embodiments, a tap refers to the user contacting and then lifting off one or more fingers at a specific location on the input region. In some embodiments, the computer system determines the relative position of the hands/finger relative to the input region when calibrating the input region. By requiring the user to tap in multiple specific locations on the input region during the calibration process, the computer system is able to determine the height of the input region, thereby minimizing the likelihood of erroneously interpreting an air gesture as an input on the input region, thereby conserving computing resources associated with correcting erroneous input associated with misidentification of inputs provided on the designated input region.

In some embodiments, while the first portion of the first physical surface is designated as the first input region, the computer system detects one or more second inputs at the first input region, such as hand 702 providing inputs to input region 710 while visual indicator 708 is displayed to guide the user through the calibration process in FIG. 7D.

In some embodiments, while the first portion of the first physical surface is designated as the first input region, and in response to detecting the one or more second inputs at the first input region, the computer system calibrates the first input region according to a first set of calibration parameters corresponding to the one or more second inputs (and optionally performing an operation at the computer system in accordance with the one or more second inputs), such as computer system 101 calibrating input region 710 in response to the inputs provided by hand 702 in FIG. 7E. In some embodiments, the input region is calibrated using inputs that were provided to the input region for performing an operation on the computer system using the input region. Thus, in some embodiments, an input to perform an operation is simultaneously used to calibrate the input region. In some embodiments, the second inputs include one or more taps and/or swiping gestures (e.g., the user dragging one or more fingers) performed on or within a threshold distance (e.g., 0.1, 1, or 10 mm) from the designated input region. In some embodiments, in response to receiving the second inputs, and based on the second inputs, the device determines one or more calibration parameters (e.g., height, width, and/or slope) of the input region. In response to receiving the second inputs, the device is able to determine a location of the designated input region which it then uses to determine when the user is applying and/or directing an input to the designated input region versus performing an air gesture or simply moving their hands and fingers in a manner that does not correspond to providing an input to the computer system.

In some embodiments, the computer system detects one or more third inputs, different from the one or more second inputs, at the first input region, such as if hand 702 were applying a different input to input region 710 in FIG. 7D. In some embodiments, in response to detecting the one or more third inputs, different from the one or more second inputs, at the first input region, the computer system calibrates the first input region according to a second set of calibration parameters corresponding to the one or more third inputs (and optionally performing an operation at the computer system in accordance with the one or more third inputs), such as if the user provided different inputs to the designated input region 710 using hand 702 in FIG. 7E. In some embodiments, similar to the example described above, the input region is calibrated using the third inputs and additionally the computer system performs an operation in response to the third inputs. In some embodiments, the one or more third inputs include an alternate form of input on the designated input region different from the second input. For instance, if the second input is a tap, then the third input includes movement across at least a portion of the designated input region. In some embodiments, the second and third inputs collectively include, but are not limited to: a tap, a movement input, a pinch, a multi-tap gesture, a multi-finger tap, and/or any of the gestures and inputs described above. By calibrating the designated input region based on a different types of inputs provided by the user during a calibration process, the computer system is able to calibrate the input region to the environment of the user, thereby minimizing the likelihood of erroneously interpreting an air gesture as an input on the input region, thereby conserving computing resources associated with correcting erroneous input associated with misidentification of inputs provided on the designated input region.

In some embodiments, while the first portion of the first physical surface is designated as the first input region, the computer system displays, on the first surface, a visual indicator that indicates an extent of the first input region, such as the boundary of input region 710 illustrated in FIG. 7E. In some embodiments, the visual indicator includes but is not limited to, a visual border (e.g., solid line or dashed line) that illustrates the boundary of the designated input region. In some embodiments, the visual indicator includes applying color, highlighting, texture, and/or shading to the entirety of or to a portion of the designated input region. In some embodiments, the visual indicator is configured to render the designated input region visually unique from (e.g., having a different visual appearance than) the rest of the physical surface that the input region is on (e.g., the portions of the physical surface that are not designated as input region(s)). In some embodiments, visually distinguishing the input region from the rest of the physical surface includes applying a different color, opacity, brightness, color saturation, highlighting, and/or texture to the input region versus the physical surface. Additionally or alternatively, the visual indicator is configured to visually distinguish the designated input region from the three-dimensional environment that is visible on the display generation component. In some embodiments, the visual indicator is overlaid on the first portion of the first surface (and not overlaid on parts of the first surface that are not designated as the input region). Applying a visual indicator to the designated input region, minimizes the likelihood of erroneous user inputs, such as applying inputs intended for the input region to another portion of the surface, or inadvertently applying an input to the input region when no input was intended, thereby conserving computing resources associated with correcting erroneous input.

In some embodiments, the visual indicator is an input region user interface, and the input region user interface comprises one or more selectable options for providing input to the computer system, such as control 734 displayed on input region 710 in FIG. 7F. In some embodiments, while the first portion of the first physical surface is designated as the first input region, the computer system receives, via the one or more input devices, a second input directed to a first selectable option of the one more selectable options of the input region user interface, such as if hand 702 applied an input to one of the selectable options of control window 734 displayed on input region 710 in FIG. 7F. In some embodiments, the second input shares one or more characteristics of the movement of the portion of the person directed to the input region described above. In some embodiments, the second input includes, but is not limited to, a tap, swipe, and or drag input (described above).

In some embodiments, in response to receiving the second input directed to the first selectable option, the computer system performs an operation at the computer system in accordance with the received second input, such as if computer system performed an operation on photo 732b in response to a user selecting a selectable option of control window 734 in FIG. 7F. In some embodiments, the visual indicator that is displayed on the designated input region includes one or more controls that are visually displayed on the input region as part of the visual indicator. In some embodiments, the controls are displayed on the designated input region as a user interface (e.g., an input region user interface) that includes one or more selectable options that when selected cause the electronic device to perform an operation on the computer system corresponding to the selected option. In some embodiments the one or more selectable options include sliders, knobs, buttons, toggle switches, and/or replications of mechanical input mechanisms. As an example, if the user is interacting with a photo application, then the input region user interface optionally includes one or more selectable options corresponding to operations including but not limited to, cropping an image, applying one or more visual filters to the image, adjusting a visual characteristic of the image, and/or storing the image on the computer system. In the example of a video communication application, the one or more selectable options could include, but are not limited to, a call end button for terminating a video communication session, a camera selection option, applying a filter to the video communication session, and/or adjusting one or more visual characteristics of the video communication session. In some embodiments, the input region user interface is displayed on the entire surface of the designated input region. Alternatively, the input region user interface is displayed on a portion of the designated input region, and thus the user is able to both interact with the input region user interface (e.g., selectable options) while also providing inputs to the input region according to the processes and methods described above. Including interactive controls on the designated input region, allows the user to use the input region for a larger variety of purposes (e.g., performing a larger variety of operations on the input region), and increases the total number of ways in which a user can provide inputs to the computer system, thus minimizing the likelihood of the user providing erroneous input to the computer system, thereby conserving computing resources of the computing system associated with correcting erroneous input.

In some embodiments, the first input includes detecting a second portion of the person in a first pose, such as if hand 702 switched from the gesture illustrated in FIG. 7A, to the gesture illustrated in FIG. 7T. In some embodiments, while the first portion of the first physical surface is designated as the first input region, the computer system detects, via the one or more input devices, the second portion of the person changing from having the first pose to having a second pose, different from the first pose, such as hand 702 performing the gesture illustrated in FIG. 7A to designate input region 710 (illustrated in FIG. 7E), and then ceasing designation of input region 710 in response to detecting hand 702 performing a multi-finger tap gesture 720 as illustrated in FIG. 7T.

In some embodiments, in response to detecting the second portion of the person changing from having the first pose to having the second pose, the computer system ceases designation of the first surface as the first input region, such as input region 710 no longer being designated in FIG. 7U. In some embodiments, the first input that when detected by the computer system causes the computer system to designate the first input region includes a pose that is performed by a second portion of the user (e.g., the user's hand that is not being used to apply inputs to the first input region) while the first portion of the first surface is being used an input region. In some embodiments, the second portion is the same portion of the person as the first portion, and thus the input region is designated by the same portion of the person that is also used to provide inputs to the computer system. For instance, in some embodiments, the first pose includes laying the other hand flat against the surface within a threshold distance of and/or next to the portion of the surface that is designated as the first input region. In some embodiments, when the first pose held by the second portion of the user is changed and/or removed, the computer system in response ceases designating the input region such that the first input region no longer acts an input region upon which inputs can be applied. For instance, if the user ceases to rest the second portion (e.g., the other hand) on the surface, the computer system ceases designating the first input region. In some embodiments, once the computer system ceases designating the first input region, the computer system ceases to perform operations in response to inputs directed to the first input region. In some embodiments, the second pose is a specific pose that when detected by the computer system, causes the computer system to cease designating the first input region. As an example, if the first pose is the hand of the user laying flat against the surface, then the second pose is the user retracting their fingers such that the second hand is no longer laying flat against the surface that also includes the first input region. Detecting a pose of a second portion of the user to cease designation of an input region minimizes the likelihood of the user inadvertently applying an input to the input region when the user no longer intends to use the portion of the surface and an input region, thereby conserving computing resources associated with correcting the inadvertent/erroneous input.

In some embodiments, while the first portion of the of the first surface is designated as the first input region, the computer system detects that an elapsed time since input has been detected at the first input region is greater than a time threshold. In some embodiments, in response to detecting that the elapsed time is greater than the time threshold, the computer system ceases designation of the first surface as the first input region, such as if input region 710 was no longer designated in FIG. 7E due to the computer system detecting that input region 710 had not been used for longer than a threshold amount of time. In some embodiments, the time threshold is 5, 10, 15, 30, or 60 seconds. In some embodiments, the elapsed time is measured from the last input applied to the input region. In response to detecting an input at the input region, the computers system optionally begins a timer that either ends when the time threshold is reached, or resets when another input is applied to the input region. In some embodiments, the time threshold is application specific such that different applications have different time thresholds. For instance, an application where a higher frequency of input is expected will have a shorter time threshold, while an application where inputs are expected less frequently will have a longer threshold. Using a time threshold to cease designation of an input region minimizes the likelihood of the user inadvertently applying an input to the input region when the user no longer intends to use the portion of the surface and an input region, thereby conserving computing resources associated with correcting the inadvertent/erroneous input.

In some embodiments, while the first portion of the first surface is designated as the first input region, the computer system detects, via the one or more input devices, a second gesture corresponding to a request to terminate the designation of the first portion of the first surface as the first input region, such as multi-tap finger gesture 720 in FIG. 7T. In some embodiments, in response to detecting the second gesture, the computer system ceases designation of the first surface as the first input region, such as computer system 101 ceasing designation of input region 710 in response to detecting multi-finger tap gesture 720 in FIG. 7U. In some embodiments, the first portion of the user (e.g., the hand of the user that also applied inputs to the designated input region) is also used to cease designation of the first surface as the first input region. For instance, in some embodiments, the computer system ceases designating the first input region upon detecting that the first portion of the user performs a specific gesture (the same and/or different from the gesture that was used to designate the input region). For instance, if the user used a four finger tap to designate the input region, then upon detecting that the user performs another four finger tap while the input region is active, the computer system will cease designation of the input region. In some embodiments, the gesture used to cease designating an input region includes but is not limited to a multi-finger tap, a swiping gesture, and/or laying the hand flat against the input region with fingers extended (similar to the gestures described above for designating an input region). Using a gesture to cease designation of an input region minimizes the likelihood of the user inadvertently applying an input to the input region when the user no longer intends to use the portion of the surface and an input region, thereby conserving computing resources associated with correcting the inadvertent/erroneous input. In some embodiments, the user can continue to use air gestures when input region is active.

In some embodiments, while the first portion of the first surface is designated as the first input region, the computer system detects via the one or more input devices, a first air gesture not directed to the first input region such as if the user were using hand 702 to perform an air gesture directed to photo 723b in FIG. 7J. In some embodiments, in response to detecting the first air gesture, the computer system performs an operation at the computer system in accordance with the detected first air gesture while maintaining designation of the first portion of the first physical surface as the input region, such as if user selected photo 732b using an air gesture (rather than tap gesture 720 on input region 710) and computer system 101 maintained designation of input region 710 in FIG. 7J. In some embodiments, even while an input region has been designated by the computer system, the user of the computer system is able to continue to apply inputs to the computer system using air gestures or other means that were available for applying inputs to the computer system even when the computer system has designated an input region. For instance, when an input region is designated, a user can select a selectable option on a content window that is visible in the three-dimensional environment by directing their gaze to the selectable option and either applying an input to the input region (such as a tap) and/or performing an air gesture (such as an air pinch) to select the selectable option. In the case where the input region itself includes one or more controls (e.g., an input region user interface), the user is optionally able to select a selectable option by directly tapping on the selectable option on the input region and/or by directing their gaze to the selectable option on the input region and performing an air gesture (such as an air pinch) input region. In some embodiments, in response to designating the input region, the computer system limits the number of air gestures that are still available to be used while the input region has been designating such that not all air gestures that were previously recognized (before the input region was designated) are still available to be used while the input region is active. Allowing air gestures to be used even when an input region has been designated increases the total number of ways in which a user can provide inputs to the computer system, thus minimizing the likelihood of the user providing erroneous input to the computer system by allowing the user to have the flexibility to provide inputs to the computer system according to their preferences, thereby conserving computing resources of the computing system associated with correcting erroneous input.

In some embodiments, and optionally while the first portion of the first surface is designated as the first input region or while the first portion of the first surface is not designated as the first input region, the computer system detects, via the one or more input devices, a second input corresponding to a request to designate a second portion of the first surface as a second input region, different from the first portion of the first physical surface, such as if the user performed a gesture to generate a separate input region (from input region 710) at a separate portion of table 706 in FIG. 7K. In some embodiments, the second input shares one or more of the characteristics described above with respect to the first input. In some embodiments, the second portion of the first surface is a different portion of the first surface than the first portion. In some embodiments, the second input is distinguishable from the first input insofar as the second input is directed to a portion of the physical surface that is different than the portion of the physical surface where the first input region is designated.

In some embodiments, in response to detecting the second input (the computer system optionally ceases designation of the first portion of the first surface as the first input region and) the computer system designates the second portion of the first surface as the second input region, such as if computer system 101 designated a second input region in response to detecting a gesture at a second portion of table 706 in FIG. 7K.

In some embodiments, while the second portion of the first surface is designated as the second input region, the computer system detects, via the one or more input devices, movement of a second portion (e.g., the first portion or a different portion) of the person directed to the second input region, such as if the tap gesture 720 in FIG. 7J were performed at the second input region.

In some embodiments, in response to detecting the movement of the second portion of the user directed to the second input region, the computer system performs an operation at the computer system in accordance the movement of the second portion of the person relative to the second input region, such as if computer system 101 selected photo 732b as illustrated in FIG. 7K in response to a tap gesture performed at the second input region. In some embodiments, in response to designation of the second input region, the computer system ceases designation of the first portion such that the first input region and the second input region are not active at the same time. Alternatively, the computer system ceases designation of the first input region, in response to designation of the second input region, after a threshold period of time (e.g., 0.05, 0.1., 0.2, 0.5, 1, 2, or 5 seconds) has elapsed, such that while the second input region has been designated but not for longer than the threshold period of time, both the first input region and the second input region are simultaneously active. In some embodiments, the computer system ceases designating the first input region in response to the user designating the second input region and in response to the user performing a gesture and/or pose that is used to cease designating the first input region (such as the gestures and poses described above). In some embodiments, the computer system in response to detecting that the user has performed the second input, designates the second input region without de-designating the first input region, such that multiple input regions are designated on the same surface (and/or different surfaces). In some embodiments, the second input region is designated without the first input region (described above) having been ever previously designated. Allowing the user to modify which portions of a surface are to be designated as an input region minimizes the likelihood of the user providing erroneous input to the computer system by allowing the user to have the flexibility to provide inputs to the computer system according to their preferences, thereby conserving computing resources of the computing system associated with correcting erroneous input.

In some embodiments, the movement of the first portion of the person is a tap input, such as tap input 720 illustrated in FIGS. 7J-K. In some embodiments, a tap input shares one or more characteristics with the tap input described above. In some embodiments, a tap input refers to the device detecting a tap of a user's finger or fingers on the input region such that the user places their finger and/or fingers less than a threshold period of time (e.g., 1, 10, or 100 ms) before raising their finger and/or fingers again thereby completing the tap input. In some embodiments, in response to detecting a tap input, the computer system performs an operation on the computer system, such as selecting a selectable option on a user interface and/or selecting an active content window. Using tap gestures for inputs applied to the input region increases the total number of ways in which a user can provide inputs to the computer system, thus minimizing the likelihood of the user providing erroneous input to the computer system by allowing the user to have the flexibility to provide inputs to the computer system according to their preferences, thereby conserving computing resources of the computing system associated with correcting erroneous input.

In some embodiments, the movement of the first portion of the person is an input that includes movement, such as the movement of gesture 720 illustrated in FIG. 7L. In some embodiments, a swipe input shares one or more characteristics with the swipe inputs described above. In some embodiments, a swipe input refers to an input in which the device detects that the user has placed one or more fingers on the input surface (or within a threshold distance, such as 0.1, 1, or 10 cm) and has moved their fingers in a direction on the input region (e.g., dragged their fingers) while the fingers continue to touch (or be within the threshold distance) the designated input region. In some embodiments, in response to detecting a swipe, the computer system performs an operation on the computer system, such as moving a content window in the three-dimensional environment and/or scrolling text on a content window displayed in the three-dimensional environment. Using swipe gestures for inputs applied to the input region increases the total number of ways in which a user can provide inputs to the computer system, thus minimizing the likelihood of the user providing erroneous input to the computer system by allowing the user to have the flexibility to provide inputs to the computer system according to their preferences, thereby conserving computing resources of the computing system associated with correcting erroneous input.

In some embodiments, while the first portion of the first physical surface is designated as the first input region, the computer system displays a content user interface on the first input region, wherein the content user interface includes one or more interactive controls, such as control window 734 illustrated in FIG. 7F. In some embodiments, the content user interface is projected onto the first input region such that the user can apply inputs directly to the content user interface rather than indirectly in the case where the content is displayed in a location within the three-dimensional environment that is different from the first input region. As an example, when the first input region is designated by the computer system, a content window that was previously displayed in the three-dimensional environment (for instance in front of the user) ceases to be displayed and is instead displayed on the designated input region. In some examples, the content user interface includes, but is not limited to, a content window for displaying graphical and/or textual content, such as a map displayed as part of a map application. In some embodiments, the content user interface includes one or more controls/selectable options that are associated with another content window that is displayed concurrently with the content window when the input region is not designated but is then “snapped” to the input region (e.g., displayed on the input region) once the input region has been designated. In some embodiments, the one or more interactive controls include selectable options associated with the content user interface, and/or visual objects displayed on the content user interface that can be manipulated and/or controlled through user interaction with the interactive controls on the first input region. In some embodiments, while the controls/selectable options are snapped to the input region, the content window associated with the controls is not snapped to the input region, but it is still displayed within the three-dimensional environment.

In some embodiments, the movement of the first portion of the person includes an interaction with the one or more interactive controls of the content user interface displayed on the first input region, such as if hand 702 in FIG. 7E interacted with the one or more selectable options of control window 734 in FIG. 7F. In some embodiments, the content user interface includes content that is interactive such that the user can manipulate the content and/or apply inputs to the content while it is displayed on the input region. For instance, the content user interface includes one or more selectable options (as described above) that the user can select by directing input to the input region at a location on the input region that corresponds to the selectable option. In some embodiments, the interaction with the one or more interactive controls of the content user interface displayed on the first input region controls the content window that is displayed separated from the content user interface in the three-dimensional environment. Displaying a content user interface on the designated input region such that the user can directly interact with the content user interface when applying inputs to the input region increases the total number of ways in which a user can provide inputs to the computer system, thus minimizing the likelihood of the user providing erroneous input to the computer system by allowing the user to have the flexibility to provide inputs to the computer system according to their preferences, thereby conserving computing resources of the computing system associated with correcting erroneous input.

In some embodiments, while the first portion of the first surface is designated as the first input region, the computer system displays a content user interface on the first input region, wherein the content user interface includes content, such as instead of control window 734, the content of content window 730 were displayed on the input region 710 in FIG. 7F.

In some embodiments, performing the operation at the computer system in accordance with the detected first gesture comprises performing an operation on the content of the content user interface displayed on the first input region, such as if the user used hand 702 interacting with the content of content window 730 to perform operations on the content in FIG. 7F. In some embodiments, in addition to and/or alternatively to displaying one or more interactive controls on the content user interface, the content user interface directly displays content on the content user interface. In some embodiments, in response to designation of an input region, the computer system ceases displaying a content window in the three-dimensional environment and instead displays the content associated with the content window on the content user interface that is displayed on the designated input region. For instance, if a map is displayed in a content window in the three-dimensional environment, upon designating an input region, the computer system displays the content window on the input region as part of displaying the content user interface on the input region. In some embodiments, the user performs operations on the content (for instance zooming in/out on the content, highlighting a portion of the content, and/or swiping through the content) by directly applying inputs to the content user interface displayed on the content user interface. Displaying a content user interface that includes content on the designated input region such that the user can directly interact with the content when applying inputs to the input region increases the total number of ways in which a user can provide inputs to the computer system, thus minimizing the likelihood of the user providing erroneous input to the computer system, thereby conserving computing resources of the computing system associated with correcting erroneous input.

In some embodiments, performing the operation at the computer system in accordance with the detected first gesture includes: in accordance with a determination that attention of the user is directed to a first location in the three-dimensional environment, the computer system performing a first operation associated with the first location at the computer system in accordance with the detected first gesture, such as the user's gaze 736 being directed to photo 732B while performing gesture 720 in FIG. 7J to select photo 732B as illustrated in FIG. 7K.

In some embodiments, in accordance with a determination that the attention of the user is directed to a second location, different from the first location, in the three-dimensional environment, the computer system performing a second operation, different from the first operation, associated with the second location at the computer system in accordance with the detected first gesture (or optionally performing the same first operation but at the second location rather than the first location), such as if the user's gaze 736 were directed to a different photo (e.g., such as photo 732a in FIG. 7J) and in response to gesture 720, computer system 101 selected photo 732a instead in FIG. 7K. In some embodiments, the computer systems detects where the user's gaze is directed to when an input is applied to the input region so as ascertain/determine which operation to perform in response to the input applied to the input region (e.g., the first operation is a different and/or different type of operation than the second operation) and/or which location in the three-dimensional environment at which to perform the same operation (e.g., the first operation is the same as the second operation). For instance, if a three-dimensional environment has multiple applications/content windows that are visible in the three-dimensional environment, then in order to know which application and/or content window a detected input at the input region is directed to, the computer system detects where the user's gaze was directed to (e.g., which application/content window) to determine which application/content window to perform an operation on in response to the detected input at the input region. In some embodiments, and in the case where a content user interface is displayed on the input region, the device detects that the user is directing their gaze on the content user interface when performing operations associated with the content user interface and performs the action in response that corresponds to the received input at the input region. In some embodiments, in the event that the user's gaze is not directed to a content window and/or application when the device detects that the user has applied an input to the input region, the computer system forgoes performing an operation in response to the detected input at the input region. Using the gaze of the user to determine what operation to perform in response to a detected input at the input region minimizes the likelihood of the device performing an operation that was not intended by the user when applying an input to the input region, thereby conserving computing resources of the computing system associated with correcting erroneous input.

In some embodiments, while the first portion of the first surface is designated as the first input region, the computer system detects, via the one or more input devices, a second input, such as input 720 in FIG. 7N. In some embodiments, in response to detecting the second input, in accordance with a determination that the second input corresponds to a request to relocate the first input region in a first manner, the computer system relocates the first input region from the first portion of the first surface to a respective portion of a second surface (optionally the first surface or a surface different than the first surface) in the three-dimensional environment, such as the movement of input region 710 from FIG. 7N to FIG. 7O. In some embodiments, the second input corresponding to a request to relocate the first input region shares one or more characteristics with the inputs used to relocated an input region described with respect to method 1000. In some embodiments the second input includes a gesture that when detected being performed by the computer system causes the computer system to move the input region to a location indicated by the second input. For instance, the second input can include a pinch gesture applied to the input region followed by movement of the user's hand while the pinch gesture is being held that drags the first input region to the respective portion of the second surface (e.g., the direction and/or magnitude of the movement of the input region corresponds to the direction and/or magnitude of the movement of the hand of the user that is maintaining the pinch gesture). When the user releases the pinch (after moving the hand), the input region is optionally relocated to a location that corresponds to the direction and magnitude of the motion of the user's hand when performing the second input. In some embodiments, the second surface is the same as and/or different than the first surface.

In some embodiments, in accordance with a determination that the second input corresponds to a request to relocate the first input region in a second manner, different from the first manner, the computer system relocates the first input region from the first portion of the first surface to a respective portion of a third surface (optionally the first surface, the second surface or a surface different than the first and the second surfaces) in the three-dimensional environment, such as if the motion gesture 720 in FIG. 7N were in a different direction and in response, computer system 101 moved input region 710 to a different location in FIG. 7O based on the direction of the movement. In some embodiments, the second manner is different from the first manner insofar as the direction and/or magnitude of movement of the user's hand and/or the gesture itself is different than with respect to the first manner. For instance, in the example of the pinch to move the input region, the first manner includes dragging the input region in a first direction, while the second manner includes dragging the input region in a second direction that is different from the first direction. In some embodiments the third surface is the same as the first surface and/or the second surface. Additionally or alternatively, the third surface is different than the first surface and/or the second surface. Allowing the user to move an input region once it has been designated reduces the power needed by the computer system to power and/or respond to inputs provided via different input devices (e.g., an electronic trackpad), thereby conserving computing resources of the computing system associated with correcting erroneous input.

In some embodiments, while a movement portion of the second input is ongoing, the computer system detects that the first input region reaches a first movement threshold, such as the boundary of input region 710 exceeding the boundary of table 706 in FIG. 7O.

In some embodiments, in response to detecting that the first input region has reached a first movement threshold, the computer system displays a first visual indicator at the first input region indicating that the first movement threshold has been reached, such as visual indicator 740 illustrated in FIG. 7O. In some embodiments, the first movement threshold corresponds to a boundary associated with the surface that the first input region is being placed on. For instance, if the computer system detects that the user is attempting to move the input region beyond a boundary of the surface (for instance if the user is moving the input region beyond the surface of the table such that a portion of the input region will be off of the surface if placed at the location desired by the user) then the device determines that the movement threshold has been reached and/or exceeded. In some embodiments, the movement threshold corresponds to a boundary of the one or more remote body tracking sensors (e.g., the sensing area of the body tracking sensors). In some embodiments, in response to determining that the movement threshold has been reach and/or exceed, the computer system provides a visual indicator either on the input region (while it is being moved) and/or at a location within the three-dimensional environment providing a warning to the user that their placement of the input region is beyond the physical limitations (e.g., the boundary) of the surface that the input region is on. In some embodiments, the visual indicator on the input region includes applying a color and/or shading to the input region (e.g., different from the color and/or shading of the input region when the input region is operating normally) that is configured to warn the user that they have crossed or are about to cross the movement threshold. In some embodiments, displaying the visual indicator includes or is changing a visual appearance of the input region (e.g., changing the color, opacity, brightness and/or size of the input region). In some embodiments, the visual indicator includes at textual warning and/or a graphical warning (e.g., a caution sign) that is configured to alert the user that the movement limit has been reach and/or exceeded. Providing a visual indicator when the movement limit has been reached and/or exceeded while the user is attempting to move the input region to a different location in the three-dimensional environment, minimizes the likelihood that the user places the input region in a location that is not viable for accepting inputs on the input region, thereby conserving computing resources associated with the user having to relocate the input region in response to placing the input region in a location that is not viable.

In some embodiments, while displaying the first visual indicator at the first input region indicating that the first movement threshold has been reached, the computer system detects further input corresponding to movement of the first input region beyond the first movement threshold followed by termination of the further input, such as if hand 702 performed an input that attempts to move input region 710 even further beyond the boundary of table 706 in FIG. 7O. In some embodiments, termination of the further input includes detecting an end point of a movement. For instance, if the movement is a drag input (e.g., when the user is dragging their fingers cross the input region), then the computer system determines that the drag input is terminated when the computer system detects that the user/person has lifted off their fingers from the input region. As another example, if the movement includes a pinch pose in which the hand of the user is holding the tips of their thumb and index fingers together, then the computer system determines that the further input is terminated when the computer system detects that the tips of the thumb and index fingers have moved apart from one another.

In some embodiments, in response to detecting the further input, the computer system moves the first input region beyond the first movement threshold in accordance with further input, and in response to detecting the termination of the further input, the computer system displays an animation of the first input region moving back to within the first movement threshold, such as if in response to the further movement of input region 710 beyond the boundary of table 706, computer system moved input region 710 back onto table 706 using an animation in response to detecting termination of input 720. In some embodiments, and in the case where the further input moves the input region beyond the movement threshold, the animation includes showing the input region moving to a location on the surface that is at and/or within the movement threshold and is viable as a location for placement of the input region. In some embodiments, while the user is moving the input region beyond the movement threshold (e.g., due to the further input), the device slows the rate of movement of the input region such that it no longer moves at the rate that the user's hand is moving while they are performing the further input (e.g., the rate of movement of the further input is larger than the rate of movement of the input region). In some embodiments, if the further input moves the input region beyond a threshold distance (e.g., 0.1, 1, or 10 cm) from the movement threshold, the computer system no longer applies movement to the input region. In some embodiments, the rate of movement of the input region in response to the further input is inversely proportional to the distance from the movement threshold (e.g., the further away the input region is moved beyond the movement threshold, the smaller the rate of movement of the input region). In some embodiments, the slowing of the rate of movement coupled with the animation back to the movement threshold constitutes a “rubber-band” effect that is applied to the input region by the computer system such that once the movement threshold has been exceeded, the input region “snaps back” to a location at or within the movement threshold. Applying a rubber band effect when the movement limit has been reached or exceeded while the user is attempting to move the input region to a different location in the three-dimensional environment, minimizes the likelihood that the user places the input region in a location that is not viable for accepting inputs on the input region, thereby conserving computing resources associated with the user have to relocate the input region in response to placing the input region in a location that is not viable.

In some embodiments, the one or more input devices include one or more remote body tracking devices (e.g., the remote body tracking devices described above). In some embodiments, while the first portion of the first surface is designated as the first input region, the computer system detects movement of the one or more remote body tracking devices, such as movement of user 742 causing the one or more cameras to change their field of view in FIG. 7R. In some embodiments, the movement of the one or more remote body tracking devices is due to movement and/or changes to the user's perspective relative to the three-dimensional environment. For instance, if the user moves and/or rotates their body, such that the position of the head mounted device they are wearing changes location with respect to the physical space it occupies, then optionally, the one or more body tracking devices (which are mounted to the head mounted device) also move, thus causing a change in the field of view of the remote body tracking devices. In some embodiments, the field of view of the remote body tracking devices refers to the portion of the three-dimensional space that is trackable by the remote body tracking devices. For instance, if a user performs a motion with their body that is outside of the field of view of the remote body tracking devices, then the remote body tracking devices will not detect the movement due to the movement occurring outside the field of view. However, if the movement occurs within the field of view, then the remote body tracking sensor will be able to detect the movement.

In some embodiments, in response to detecting the movement of the one or more input devices, in accordance with a determination that at least a portion of the first input region is outside of a field of sensing limit of the one or more remote body tracking devices, the computer system displays, via the display generation component, a visual indicator in the three-dimensional environment indicating that at least a portion of the first input region is outside of the field of sensing limit of the one or more remote body tracking devices, such as visual indicator 750 in FIG. 7S. In some embodiments, in accordance with a determination that the first input region is entirely within the field of sensing limit of the one or more remote body tracking devices, the computer system forgoes displaying the visual indicator. In some embodiments, if the input region is completely or partially outside the field of sensing limit (e.g., field of view) of the remote body tracking devices (e.g., input device), then the computer system will not be able to detect when an input is applied by the user's body (e.g., hands) to the input region, or will only be able to detect inputs that are applied to the portion of the input region that is within the field of view of the remote body tracking devices. In some embodiments, the field of view of the remote tracking sensors is wider than the user's field of view when viewing the three-dimensional environment, thus meaning that the input region may be able to be sensed by the remote body tracking devices even if the input region is not visible to the user while they are viewing the three-dimensional environment. In such a scenario, the computer system optionally continues to accept inputs to the input region, even though the inputs that are being applied are made while the input region is not visible to the user. In some embodiments, when the input region is outside the field of view of the remote body tracking devices, the computer system displays a visual indicator at a location in the three-dimensional environment that is visible to the user alerting the user that the input region is no longer within the field of view of the remote body tracking devices. In some embodiments, the location of the visual indicator is based on a determination as to where in the three-dimensional environment the user's gaze is directed to. Additionally or alternatively, the visual indicator is applied to and/or displayed within (e.g., displayed relative to) a content window that the user is engaged with in the three-dimensional environment. In some embodiments, the visual indicator includes but is not limited to a textual indicator, a graphical indicator (e.g., a warning sign and/or a visual cue indicating the direction towards which the input region is outside the field of sensing), an animation sequence, and/or changing a color of one or more virtual objects and/or content windows that are using the input region to receive inputs. Displaying a visual indicator when the input region is partially or completely outside of the field of view of the remote body tracking devices, minimizes the likelihood that the computer system fails to detect inputs to the input region, thereby conserving computing resources associated with the user re-entering inputs that were not detected due to the inputs occurring outside the field of view of the remote body tracking devices.

In some embodiments, the computer system displaying the visual indicator indicating that at least the portion of the first input region is outside of the field of sensing limit of the one or more input devices includes: in accordance with a determination that the first input region does not include interactive content, the computer system displaying the first visual indicator at a first content window displayed in the three-dimensional environment, the first content window including interactive content that is interactable via the first input region, such as visual indicator 750 being displayed on the content window in FIG. 7S. In some embodiments, if the first input region were being used to interact with a different content window in the three-dimensional environment rather than the first content window (e.g., both content windows being displayed in the three-dimensional environment), the first visual indicator would be displayed at the different content window rather than the first content window.

In some embodiments, displaying the visual indicator indicating that at least the portion of the first input region is outside of the field of sensing limit of the one or more input devices includes in accordance with a determination that the first input region includes interactive content, displaying the first visual indicator at the first input region, such as if visual indicator 750 were displayed on a portion of input region 710 that was still visible in three-dimensional environment 700 in FIG. 7S. In some embodiments, the location in the three-dimensional environment where the visual indicator is displayed is within and/or on a content window itself. In the case where the content window (e.g., a content window that interactable with the input region) is not displayed on the input region, the visual indicator is displayed on the content window that the user is currently interacting with and/or on a content window that is interactable with the input region. In the case of a content user interface (described above) being displayed on the input region, the visual indicator is optionally displayed on the content user interface. In some embodiments, the visual indicator includes but is not limited to a textual indicator, a graphical indicator (e.g., a warning sign), an animation sequence, and/or changing a color of one or more virtual objects and/or content windows that are using the input region to receive inputs. Displaying a visual indicator on a content window and/or content user interface when the input region is partially or completely outside of the field of view of the remote body tracking devices, minimizes the likelihood that the computer system fails to detect inputs to the input region, thereby conserving computing resources associated with the user re-entering inputs that were not detected due to the inputs occurring outside the field of view of the remote body tracking devices.

In some embodiments, designating the first portion of the first surface as the first input region includes in accordance with a determination that a first object in the three-dimensional environment is located at a first location in the three-dimensional environment, the computer system orienting the first input region at a first orientation with respect to the three-dimensional environment, such as the orientation 709 of input region 710 being based on the location of content window 730 in three-dimensional environment 700 in FIG. 7E.

In some embodiments, designating the first portion of the first surface as the first input region includes in accordance with a determination that the first object in the three-dimensional environment is located at a second location, different from the first location, in the three-dimensional environment, the computer system orienting the first input region at a second orientation, different from the first orientation, with respect to the three-dimensional environment, such as if the orientation 709 of input region 710 were in a different orientation based on content window 730 being in a different location in three-dimensional environment 700 in FIG. 7E. In some embodiments, the orientation of input region refers to the alignment of one or more edges and or surface of input region with an object in the three-dimensional environment. For instance, if the input region is configured to interact with a first content window (e.g., the first object) then the input region is oriented to the content window such that an edge and/or the surface of the input region is parallel to an edge of the content window. As a further example, if a first vector is drawn from the center of a content window displayed in the three-dimensional environment to the head mounted display, and a reference vector is drawn that extends straight out from the head mounted display, then the orientation is characterized as the angle between the first vector and the reference vector. In some embodiments, when displaying the input region, the computer system displays the input region at an orientation such that the plane of the input region is parallel to the reference vector. In some embodiments, the computer system, determines a direction of an input applied to the input region based on the orientation of the input region. In some embodiments, the orientation of the input region with respect to a content window (or other objects in the three-dimensional environment, whether virtual or physical) shares one or more characteristics with the orientations of the input region described with respect to method 1000 described below. Orienting the input region to the content window that is being interacted with, minimizes the likelihood of erroneous input to the computer system due to perception errors caused by an input region that is not aligned with and/or orientated with the content window that the input region is being used to interact with, thereby conserving computing resources associated with correcting erroneous input.

In some embodiments, the first physical surface is not an input device, such as table 706 not being a physical input device in FIG. 7A. In some embodiments, the surface that the input region is designated on is not an input device itself. For instance, the surface is not a track pad, touch sensor surface, a pressure sensor surface, or any other surface that can be communicatively coupled to the computer system. Not having input regions that are designated on input devices minimizes the likelihood that a user providing input to the input region will have their input registered twice, once by the input device itself and a second time by the computer system detecting the input being applied to the input region, and furthermore allows for physical surfaces that would not normally be used to provide input to a computer system to be utilized as an input device, thereby conserving computing resources associated with correcting erroneous input caused by duplicative inputs to the computer system and providing additional ways for a user of a computer system to provide input to the computer system.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9K illustrate examples of a computer system determining a pose of an input region on a physical surface in a three-dimensional environment based on one or more properties of the three-dimensional environment in accordance with some embodiments.

FIG. 9A illustrates a computer system 101 (e.g., an electronic device) displaying, via a display generation component (e.g., display generation component 120 of FIGS. 1 and 3), a three-dimensional environment 900 from a viewpoint of a user 942 (e.g., facing the back wall of the physical environment in which computer system 101 is located, as shown in the overhead/top-down view 940 of the three-dimensional environment 900).

In some embodiments, computer system 101 includes a display generation component 120. In FIG. 9A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 9A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 900. For example, as shown in FIG. 9A, the three-dimensional environment 900 includes a representation of a table 906 (e.g., corresponding to representation of table 906 in the overhead view 940), which is optionally a representation of a physical table in the physical environment, and a representation of a keyboard 915, which is optionally a representation of a physical keyboard in the physical environment of the computer system 101. In some embodiments, the keyboard 915 is in communication with the computer system 101 (e.g., as an input device). In some embodiments, the keyboard 915 is not in communication with the computer system 101 (e.g., and is optionally in communication with a different electronic device or computer system in the physical environment).

As discussed in more detail below, in FIG. 9A, display generation component 120 is illustrated as displaying content in the three-dimensional environment 900. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 9A-9K.

Display generation component 120 has a field of view (e.g., a field of view captured by external image sensors 114b and 114c and/or visible to the user via display generation component 120) that corresponds to the content shown in FIG. 9A. Because display generation component 120 is optionally a head-mounted device, the field of view of display generation component 120 is optionally the same as or similar to the field of view of the user. In some embodiments, as discussed in more detail with reference to method 800, the field of view of display generation component 120 is larger than the field of view of the user.

As discussed herein, the user 942 performs one or more air pinch gestures (e.g., with hand 903) to provide one or more inputs to computer system 101 to provide one or more user inputs directed to content displayed by computer system 101. Such depiction is intended to be exemplary rather than limiting; the user optionally provides user inputs using different air gestures and/or using other forms of input as described with reference to the FIG. 7 series.

In the example of FIG. 9A, because the user's hand 903 is within the field of view of display generation component 120, it is visible within the three-dimensional environment 900. That is, the user 942 can optionally see, in the three-dimensional environment 900, any portion of their own body that is within the field of view of display generation component 120.

As mentioned above, the computer system 101 is configured to display content in the three-dimensional environment 900 using the display generation component 120. In FIG. 9A, the three-dimensional environment 900 also includes a virtual object 930 (e.g., corresponding to virtual object 930 in the overhead view 940). In some embodiments, the virtual object 930 is optionally a user interface of an application containing content (e.g., a plurality of selectable options, images, text, and/or video), three-dimensional objects (e.g., virtual clocks, virtual balls, virtual cars, etc.) or any other element displayed by computer system 101 that is not included in the physical environment of display generation component 120. For example, in FIG. 9A, the virtual object 930 is a user interface of a web-browsing application containing website content, such as text, images, video, hyperlinks, and/or audio content. As an example, in FIG. 9A, the virtual object 930 includes a first image 932a and a second image 932b. In some embodiments, the user interface of virtual object 930 is configured to be scrollable (e.g., upward and/or downward) in the three-dimensional environment 900, such that additional and/or previous images are able to be displayed in the user interface of the virtual object 930. It should be understood that the content discussed above is exemplary and that, in some embodiments, additional and/or alternative content and/or user interfaces are provided in the three-dimensional environment 900, such as the content described below with reference to methods 800 and/or 1000. Additionally, in some embodiments, as shown in FIG. 9A, the virtual object 930 is displayed with an exit option and a grabber bar 935. In some embodiments, the exit option is selectable to initiate a process to cease displaying the virtual object 930 in the three-dimensional environment 900. In some embodiments, as discussed below, the grabber bar 935 is selectable to initiate a process to move the virtual object 930 within the three-dimensional environment 900.

In some embodiments, as shown in FIG. 9A, the three-dimensional environment 900 includes a first input region 910 on a surface of the table 906. For example, as described in more detail with reference to methods 800 and/or 1000, the first input region 910 is configured to function as an input region for the computer system 101, such as an input region via which input is able to be provided by the user 942. In some embodiments, the first input region 910 is associated with the virtual object 930. For example, input provided by the user 942 directed to the first input region 910 is mapped by the computer system 101 as input directed to the user interface of the virtual object 930. In some embodiments, input provided by the user 942 directed to the first input region 910 is mapped by the computer system 101 based on a location of attention of the user 942, such as a location of gaze 926, as discussed in more detail below. In some embodiments, as discussed in more detail with reference to methods 800 and/or 1000, the first input region 910 is visually delineated in the three-dimensional environment 900 (e.g., as a virtual object). For example, as shown in FIG. 9A, a size, location, and/or orientation of the first input region 910 is visually communicated via a visual appearance of the first input region 910 on the surface of the table 906 in the three-dimensional environment 900. In some embodiments, as discussed below, a pose (e.g., a location and/or orientation) of the first input region 910 in the three-dimensional environment 900 is determined (e.g., automatically) by the computer system 101 based on one or more properties of the three-dimensional environment 900 (e.g., from a viewpoint of the user 942).

In some embodiments, the one or more properties of the three-dimensional environment 900 include the viewpoint of the user 942 in the three-dimensional environment 900. In some embodiments, the one or more properties of the three-dimensional environment 900 include a location of a hand (e.g., hand 903) of the user 942 in the three-dimensional environment 900. In some embodiments, the one or more properties of the three-dimensional environment 900 include a pose of the surface on which the first input region 910 is positioned/displayed, such as a location, height, and/or orientation of the table 906 in the three-dimensional environment 900. In some embodiments, the one or more properties of the three-dimensional environment 900 include one or more locations of one or more physical objects, including other electronic devices (e.g., different from the computer system 101), in the three-dimensional environment 900. In some embodiments, the one or more properties of the three-dimensional environment 900 include one or more properties of virtual objects displayed in the three-dimensional environment 900, such as a location of a virtual object and/or a type of the virtual object with which the first input region 910 is associated (e.g., and/or otherwise configured to function as an input region for). It should be understood that, as discussed herein, the pose of the first input region 910 is determined based on any one or combination of the above exemplary spatial properties of the three-dimensional environment 900.

As shown in FIG. 9A, the first input region 910 optionally has (e.g., is optionally displayed with) a first pose based on the one or more spatial properties of the three-dimensional environment 900 discussed above. For example, as shown in FIG. 9A, the first input region 910 is displayed at a first location in the three-dimensional environment 900 from the viewpoint of the user 942. In some embodiments, the first location is selected based on a location of the table 906 in the three-dimensional environment 900. For example, as shown in FIG. 9A, the first location corresponds to a location on the surface of the table 906 in the three-dimensional environment 900. In some embodiments, the first location is selected based on a location of hand 903 of the user 942 in the three-dimensional environment 900. For example, as shown in FIG. 9A, the first location is selected to be below the hand 903 on the table 906 in the three-dimensional environment 900.

Additionally, as shown in FIG. 9A, the first input region 910 optionally has (e.g., is displayed with) a first orientation in the three-dimensional environment 900 based on the one or more properties of the three-dimensional environment 900. For example, in FIG. 9A, the first input region 910 has a first orientation (e.g., indicated by axes 909) on the surface of the table 906 in the three-dimensional environment 900 from the viewpoint of the user 942. In some embodiments, the first orientation of the first input region 910 is selected based on an orientation of arm 907 of the user 942 shown in the overhead view 940 (e.g., detected via the external image sensors 114b and 114c). For example, the first orientation of the first input region 910 aligns to (e.g., is parallel to) and/or is otherwise based on an angle of the elbow joint of the arm 907 of the user 942 (e.g., in the overhead view 940) as detected by the computer system 101, as discussed in more detail with reference to method 1000. It should be understood that the orientation of the first input region 910 in FIG. 9A is merely exemplary and that other orientations are possible, such as those discussed below.

As mentioned previously above, in some embodiments, the first input region 910 is configured to function as an input region for the computer system 101, such as to direct input to the user interface of the virtual object 930 in the three-dimensional environment 900. In FIG. 9A, the computer system 101 is detecting an input provided by the hand 903 directed to the first input region 910 in the three-dimensional environment 900. For example, as shown in side view 911 of FIG. 9A, the computer system 101 is detecting finger 902 of the hand 903 on the surface of the table 906 and directed to the first input region 910, optionally while the gaze 926 of the user 942 is directed to the user interface of the virtual object 930. In some embodiments, as shown in the side view 911, the input includes movement of the finger 902 in a respective direction on the surface of the table 906 relative to the first input region 910 (e.g., a swipe of the finger 902) in the three-dimensional environment 900.

In some embodiments, the orientation of the first input region 910 determines/controls the particular operation the computer system 101 performs in response to detecting the input provided by the hand 903 directed to the first input region 910 on the surface of the table 906 in the three-dimensional environment 900. For example, the first orientation of the first input region 910 in FIG. 9A determines the operation the computer system 101 performs in response to the swipe of the finger 902 directed to the first input region 910 on the surface of the table 906. As indicated in FIG. 9A, the direction of the swipe of the finger 902 directed to the first input region 910 is in an upward direction of the first input region 910 based on the first orientation of the first input region 910 (e.g., as indicated by the axes 909).

In some embodiments, as shown in FIG. 9B, in response to detecting the input provided by the hand 903 directed to the first input region 910 on the surface of the table 906, the computer system 101 scrolls the user interface of the virtual object 930 in the three-dimensional environment 900. For example, as shown in FIG. 9B, the computer system 101 scrolls the user interface upward in the virtual object 930, which reveals additional portions of the second image 932b and a portion of a third image 932c in the user interface (e.g., and ceases display of portions of the first image 932a), in the three-dimensional environment 900 in accordance with the swipe of the finger 902 on the surface of the table 906. In some embodiments, as alluded to above, the computer system 101 scrolls the user interface of the virtual object 930 upward (e.g., as opposed to downward or horizontally) in response to detecting the swipe of the finger 902 directed to the first input region 910 based on the first orientation of the first input region 910 (e.g., particularly the directionality defined by the axes 909).

In FIG. 9C, the first input region 910 optionally has (e.g., is optionally displayed with) a second pose (e.g., different from the first pose discussed above with reference to FIG. 9A) based on the one or more spatial properties of the three-dimensional environment 900 discussed previously above. For example, as shown in FIG. 9C, the first input region 910 is displayed at a second location (e.g., different from the first location of the first input region 910 in FIG. 9A) in the three-dimensional environment 900 from the viewpoint of the user 942. In some embodiments, the second location is selected based on a location of the table 906 in the three-dimensional environment 900. For example, as shown in FIG. 9C, the second location corresponds to a location on the surface of the table 906 in the three-dimensional environment 900. In some embodiments, the second location is selected based on a location of hand 905 (e.g., different from the hand 903 in FIG. 9A) of the user 942 in the three-dimensional environment 900. For example, as shown in FIG. 9C, the second location is selected to be below the hand 905 on the table 906 in the three-dimensional environment 900.

Additionally, as shown in FIG. 9C, the first input region 910 optionally has (e.g., is displayed with) a second orientation (e.g., different from the first orientation of the first input region 910 in FIG. 9A) in the three-dimensional environment 900 based on the one or more properties of the three-dimensional environment 900. For example, in FIG. 9C, the first input region 910 has a second orientation (e.g., indicated by axes 909) on the surface of the table 906 in the three-dimensional environment 900 from the viewpoint of the user 942. In some embodiments, the second orientation of the first input region 910 is selected based on an orientation of arm 917 (e.g., different from the arm 907 in FIG. 9A) of the user 942 shown in the overhead view 940 (e.g., detected via the external image sensors 114b and 114c). For example, the second orientation of the first input region 910 aligns to (e.g., is parallel to) and/or is otherwise based on an angle of the elbow joint of the arm 917 of the user 942 (e.g., in the overhead view 940) as detected by the computer system 101, as discussed in more detail with reference to method 1000.

In FIG. 9C, the computer system 101 is detecting an input provided by the hand 905 directed to the first input region 910 in the three-dimensional environment 900. For example, as shown in the side view 911 of FIG. 9C, the computer system 101 is detecting finger 904 of the hand 905 on the surface of the table 906 and directed to the first input region 910, optionally while the gaze 926 of the user 942 is directed to the user interface of the virtual object 930. In some embodiments, as shown in the side view 911, the input includes movement of the finger 904 in a respective direction on the surface of the table 906 relative to the first input region 910 (e.g., a swipe of the finger 904) in the three-dimensional environment 900.

In some embodiments, as shown in FIG. 9D, in response to detecting the input provided by the hand 905 directed to the first input region 910 on the surface of the table 906, the computer system 101 scrolls the user interface of the virtual object 930 in the three-dimensional environment 900. For example, as shown in FIG. 9D, the computer system 101 scrolls the user interface upward in the virtual object 930, which reveals additional portions of the third image 932c and a portion of a fourth image 932d in the user interface (e.g., and ceases display of portions of the second image 932b), in the three-dimensional environment 900 in accordance with the swipe of the finger 904 on the surface of the table 906. In some embodiments, as similarly discussed above, the computer system 101 scrolls the user interface of the virtual object 930 upward (e.g., as opposed to downward or horizontally) in response to detecting the swipe of the finger 904 directed to the first input region 910 based on the second orientation of the first input region 910 (e.g., particularly the directionality defined by the axes 909). For example, the direction of the swipe of the finger 904 directed to the first input region 910 is in an upward direction of the first input region 910 based on the second orientation of the first input region 910 (e.g., as indicated by the axes 909).

In some embodiments, as shown in FIG. 9E, the three-dimensional environment 900 concurrently includes a plurality of input regions. For example, in FIG. 9E, the three-dimensional environment 900 includes a first input region 910a and a second input region 910b on the surface of the table 906 in the three-dimensional environment 900. As similarly discussed above, in some embodiments, the first input region 910a and the second input region 910b have respective poses that are based on the one or more properties of the three-dimensional environment 900. For example, in FIG. 9E, the first input region 910a is located at a first location and has a first orientation on the surface of the table 906 and the second input region 910b is located at a second location (e.g., different from the first location) and has a second orientation (e.g., different from the first orientation) on the surface of the table 906 in the three-dimensional environment 900 based on the one or more properties of the three-dimensional environment 900. Particularly, in some embodiments, the first input region 910a is positioned below the hand 905 of the user 942 on the surface of the table 906 and has an orientation that is selected based on the arm 917 (e.g., angle of the elbow joint of the arm 917) of the user 942, as indicated by the axes 909a, and the second input region 910b is positioned below the hand 903 of the user 942 on the surface of the table 906 and has an orientation that is selected based on the arm 907 (e.g., angle of the elbow joint of the arm 907) of the user 942, as indicated by the axes 909b, in the three-dimensional environment 900, as similarly discussed above.

Additionally, in some embodiments, as similarly discussed above, the first input region 910a and the second input region 910b are configured to function as input regions for receiving input provided by the hands 905 and 903. For example, in FIG. 9E, the computer system 101 is able to (e.g., individually and/or concurrently) respond to input provided by the hand 905 directed to the first input region 910a and input provided by the hand 903 directed to the second input region 910b on the surface of the table 906 in the three-dimensional environment 900. In some embodiments, the inputs include swipe inputs as similarly discussed above, tap inputs, as discussed below, and/or other types of inputs, such as those described in methods 800 and/or 1000. Additionally, in some embodiments, as similarly discussed above, the computer system 101 performs one or more operations in response to detecting input provided by the hands 905 and 903 directed to the input regions 910a and 910b, respectively, based on the individual orientations of the input regions 910a and 910b.

In some embodiments, the computer system 101 is configured to respond to input provided by the hands 903 and 905 of the user 942 directed to a same input region in the three-dimensional environment 900. For example, as shown in FIG. 9F, the three-dimensional environment 900 includes input region 910 on the surface of the table 906. In some embodiments, the input region 910 has a pose that is based on the one or more properties of the three-dimensional environment 900, as similarly discussed above. For example, as shown in FIG. 9F, the input region 910 is positioned at a location on the surface of the table 906 based on the location of the viewpoint of the user 942 in the three-dimensional environment 900 (e.g., a center of the input region 910 is aligned to the viewpoint of the user 942). As another example, in FIG. 9F, the input region 910 has an orientation (e.g., indicated by the axes 909) that is based on an orientation of the table 906 in the three-dimensional environment 900. For example, in FIG. 9F, a front edge (e.g., closest to the viewpoint of the user 942) of the input region 910 is aligned to (e.g., is parallel to) a front edge of the table 906 in the three-dimensional environment 900.

As mentioned above, in some embodiments, the computer system 101 is configured to respond to input provided by either of the hands 903 and 905 directed to the input region 910 on the surface of the table 906 in the three-dimensional environment 900. In FIG. 9F, the computer system 101 is detecting an input provided by the hand 903 directed to the input region 910 in the three-dimensional environment 900. For example, as shown in the side view 911 of FIG. 9F, the computer system 101 is detecting finger 902 of the hand 903 on the surface of the table 906 and directed to the input region 910, optionally while the gaze 926 of the user 942 is directed to the third image 932c in the user interface of the virtual object 930.

In some embodiments, as shown in FIG. 9G, in response to detecting the input provided by the hand 903 directed to the input region 910 on the surface of the table 906, the computer system 101 selects the third image 932c in the user interface of the virtual object 930 in the three-dimensional environment 900. For example, as shown in FIG. 9G, in response to detecting a tap of the finger 902 directed to the input region 910 on the surface of the table 906, the computer system 101 enlarges the third image 932c in the user interface of the virtual object 930 (e.g., and ceases display of the second image 932b and the fourth image 932d in the user interface) in the three-dimensional environment 900.

In FIG. 9G, the computer system 101 detects an input provided by the hand 905 directed to the input region 910 in the three-dimensional environment 900. For example, as shown in the side view 911 of FIG. 9G, the computer system 101 detects finger 904 of the hand 905 on the surface of the table 906 and directed to the input region 910, optionally while the gaze 926 of the user 942 is directed to the third image 932c in the user interface of the virtual object 930. In some embodiments, as shown in the side view 911, the input includes movement of the finger 904 in a respective direction on the surface of the table 906 relative to the input region 910 (e.g., a swipe of the finger 904) in the three-dimensional environment 900. As indicated in the side view 911, the computer system 101 is no longer detecting the finger 902 of the hand 903 directed to the input region 910 on the surface of the table 906 when the input provided by the hand 905 directed to the input region 910 is detected.

In some embodiments, as shown in FIG. 9H, in response to detecting the input provided by the hand 905 directed to the input region 910 on the surface of the table 906, the computer system 101 deselects the third image 932c in the user interface of the virtual object 930 in the three-dimensional environment 900. For example, as shown in FIG. 9H, the computer system 101 restores the third image 932c to its previous size in the user interface of the virtual object 930 and redisplays the second image 932b and the fourth image 932d in the user interface of the virtual object 930.

As mentioned previously above, the one or more properties of the three-dimensional environment 900 are optionally based on one or more physical objects, such as electronic devices, in the three-dimensional environment 900. As discussed previously above, in some embodiments, the pose of the input region 910 is therefore selected based on a pose (e.g., position and/or orientation) of the one or more physical objects, such as the keyboard 915. For example, in FIG. 9I, the input region 910 is positioned at a location in the three-dimensional environment 900 that is based on a location of the keyboard 915. As shown in FIG. 9I, the input region 910 is optionally positioned adjacent to (e.g., to the right of) the keyboard 915 on the surface of the table 906 in the three-dimensional environment 900 from the viewpoint of the user 942. Additionally, as shown in FIG. 9I, the input region 910 has an orientation (e.g., indicated by the axes 909) that is based on an orientation of the keyboard 915 in the three-dimensional environment 900. For example, as shown in FIG. 9I, a side edge (e.g., a left edge relative to the viewpoint of the user 942) of the input region 910 is aligned to (e.g., is parallel to) a side edge (e.g., a right edge relative to the viewpoint of the user 942) of the input region 910. As shown in FIG. 9I, in some embodiments, the pose of the input region 910 is selected based on the keyboard 915 rather than based on the hand 903 of the user 942 (e.g., such as previously discussed herein) in the three-dimensional environment 900.

FIG. 9J illustrates an alternative example of selecting the pose of the input region 910 based on the pose of the keyboard 915 in the three-dimensional environment 900. For example, as shown in FIG. 9J, the keyboard 915 has a different pose (e.g., location and/or orientation) than in FIG. 9I. Accordingly, the computer system 101 optionally selects the pose of the input region 910 based on the alternate pose of the keyboard 915 shown in FIG. 9J (e.g., positions the input region 910 adjacent to the keyboard 915 and/or aligns the input region 910 to the orientation of the keyboard 915 on the surface of the table 906).

As mentioned previously above, the one or more properties of the three-dimensional environment 900 are optionally based on one or more virtual objects, such as virtual object 930, in the three-dimensional environment 900. Accordingly, in some embodiments, the pose of the input region 910 is selected based on a location and/or type of the one or more virtual objects in the three-dimensional environment 900. For example, in FIG. 9I, in addition to and/or alternatively to being positioned on the surface of the table 906 based on the location of the keyboard 915, the input region 910 is positioned by the computer system 101 based on a location of the virtual object 930 in the three-dimensional environment 900. As an example, in FIG. 9I, the computer system 101 positions the input region 910 at a location on the surface of the table 906 that is in front of the virtual object 930 in the three-dimensional environment 900 from the viewpoint of the user 942.

Additionally or alternatively, in some embodiments, the computer system 101 determines the pose of the input region 910 based on the type of virtual object with which the input region 910 is associated. For example, in FIG. 9I, the input region 910 is associated with the virtual object 930, such that the user interface of the virtual object 930 is configured to be interacted with via indirect user input (e.g., user input provided to the input region 910 rather than directly to the virtual object 930) in the three-dimensional environment 900. Alternatively, as shown in FIG. 9K, the three-dimensional environment 900 includes a virtual object that is configured to be interacted with via direct user input. Accordingly, in some embodiments, as shown in FIG. 9K, the pose of the input region 910 corresponds to (e.g., is the same as) the user interface with which the input region 910 is associated. For example, the location on the surface of the table 906 at which the input region 910 is positioned is the same as (e.g., overlaps with) the location of the user interface configured to be interacted with via direct user input (e.g., the selectable options and sliders shown in FIG. 9K). As shown in FIG. 9K, in some embodiments, the pose of the input region 910 is selected based on the type of virtual object being interacted with rather than based on the keyboard 915 or the hand 903 of the user 942 (e.g., such as previously discussed herein) in the three-dimensional environment 900.

FIG. 10 is a flowchart illustrating a method of determining a pose of an input region on a physical surface in a three-dimensional environment based on one or more properties of the three-dimensional environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system (e.g., computer system 101 in FIG. 9A) in communication with a display generation component (e.g., display generation component 120 in FIG. 9A) and one or more input devices (e.g., image sensors 114a-114c in FIG. 9A). In some embodiments, the computer system has one or more of the characteristics of the computer system of method 800. For example, a mobile device (e.g., a tablet, a smartphone, a media player, or a wearable device), or a computer or other electronic device. In some embodiments, the display generation component has one or more characteristics of the display generation component in method 800. In some embodiments, the one or more input devices have one or more characteristics of the one or more input devices in method 800. In some embodiments, the computer system is in communication with one or more cameras (e.g., such as the one or more cameras in method 800).

In some embodiments, while a three-dimensional environment (e.g., three-dimensional environment 900 in FIG. 9A) is visible via the display generation component, the computer system detects (1002), via the one or more input devices (e.g., one or more remote body tracking devices such as cameras, motion sensors, proximity sensors and/or depth sensors, one or more gestures performed by one or more portions (e.g., one or more hands) of a person (e.g., a user of the computer system), such as by hand 903 of user 942 in FIG. 9A, directed to (or on) at least a first input region (e.g., first input region 910 in FIG. 9A) of a physical surface (e.g., surface of table 906 in FIG. 9A) in a physical environment of the user of the computer system, wherein the physical surface does not include sensors for detecting touch inputs (e.g., the physical surface is not a surface of an electronic device (e.g., a touch-sensitive surface, such as a touchscreen or touchpad) that is in communication with the computer system), and the first input region has a pose (e.g., position and/or orientation) on the physical surface that was determined based on one or more properties of the three-dimensional environment, such as a pose of the first input region 910 shown in FIG. 9A.

In some embodiments, in accordance with a determination that the three-dimensional environment has a first set of one or more properties, the first input region has a first orientation on the physical surface in the three-dimensional environment (1004), such as orientation (e.g., indicated by axes 909) of the first input region 910 shown in FIG. 9A. In some embodiments, in accordance with a determination that the three-dimensional environment has a second set of one or more properties different from the first set of one or more properties, the first input region has a second orientation on the physical surface in the three-dimensional environment that is different from the first orientation (1006), such as orientation (e.g., indicated by the axes 909) of the first input region 910 shown in FIG. 9C. In some embodiments, the three-dimensional environment has one or more characteristics of the three-dimensional environment in method 800. In some embodiments, the surface in the physical environment has one or more characteristics of surfaces in the physical environment as described in method 800. For example, the surface includes a real word physical surface (such as a table top, floor, desk, and/or any physical object) that is part of the physical environment of the user or a virtual surface of a virtual object that is displayed within the three-dimensional environment. In some embodiments, the first region corresponds to an input region that is associated with the surface in the physical environment. In some embodiments, the first region is a predefined region that is selected automatically by the computer system (e.g., according to one or more factors, as described in more detail below). In some embodiments, the first region is visually delineated on the surface in the physical environment. For example, the computer system displays a virtual object (e.g., having a particular shape, size, and/or orientation) at a respective location in the three-dimensional environment that corresponds to the location of the first region on the surface in the physical environment. In some embodiments, the first region is associated with another virtual object that is displayed in the three-dimensional environment. For example, the three-dimensional environment includes a virtual window, virtual object and/or volume associated with an application (e.g., a web-browsing application, a media player application, a text editing application, a photos application, and/or a video game application) and that is displaying content (e.g., a user interface including one or more of selectable options, images, text, video, and/or slides/toggles). Accordingly, the first region optionally functions as an input region for the virtual object in the three-dimensional environment (e.g., input directed to the first region causes the computer system to perform one or more corresponding operations). In some embodiments, the first region includes one or more user interface elements. For example, the first region is itself a user interface of an application running on the computer system and input directed to one or more user interface elements of the user interface causes the computer system to perform one or more corresponding operations. As mentioned above and as discussed in more detail below, the first region has and/or is displayed with a respective orientation relative to the surface and/or the viewpoint of the user in the physical environment. In some embodiments, the first region has one or more characteristics of input regions and/or input surfaces in method 800.

In some embodiments, the orientation of the first region is determined based on the one or more properties of the three-dimensional environment, as similarly described with reference to the properties of three-dimensional environment 900 in FIG. 9A. In some embodiments, the one or more properties of the three-dimensional environment include a location of the surface in the portion of the physical environment that is included in the three-dimensional environment. In some embodiments, the one or more properties of the three-dimensional environment include one or more locations of the one or more portions of the user relative to the surface that is visible in the three-dimensional environment. In some embodiments, the one or more properties of the three-dimensional environment include one or more locations of one or more physical objects in the physical environment, such as objects (e.g., including other electronic devices and/or computer systems) positioned on the surface and that are visible in the three-dimensional environment from a viewpoint of the user. In some embodiments, the one or more properties of the three-dimensional environment include a field of view of the three-dimensional environment that is based on the current viewpoint of the user (e.g., and particularly the portions of the three-dimensional environment and/or physical environment that are currently visible from the current viewpoint of the user).

In some embodiments, the one or more gestures correspond to one or more contacts of one or more hands (e.g., via fingers of the one or more hands) on the surface at a location corresponding to the first region, such as hand 903 in FIG. 9A and/or hand 905 in FIG. 9C. For example, the computer system detects a hand contact the first region of the surface in the physical environment. In some embodiments, the one or more gestures include a tap on the surface directed to the first region, a swipe on the surface directed to the first region (e.g., with a respective magnitude (e.g., of speed and/or distance) and/or in a respective direction), and/or a sequence of taps on the surface directed to the first region (e.g., a multi-finger tap or a double or triple tap). In some embodiments, the computer system concurrently detects two hands of the user contact the first region of the surface in the physical environment. In some embodiments, the surface includes a second region, different from the first region, and the computer system concurrently detects the two hands of the user contact the first region and the second region of the surface (e.g., a first hand contacts the first region and a second hand contacts the second region). In some embodiments, the one or more gestures correspond to air gestures (e.g., air pinch gestures, air tap gestures, and/or air swipe gestures) performed by one or more hands of the user. For example, the one or more gestures are performed proximate to (e.g., above, such as within a threshold distance (e.g., 0.05, 0.1, 0.5, 0.75, 1, 2, 3, 4, 5, or 10 cm) of) the first region of the surface, without necessarily being in contact with the first region. In some embodiments, the one or more gestures have one or more characteristics of inputs and/or gestures described with reference to method 800. In some embodiments, the computer system detects attention (e.g., including gaze) of the user directed to a virtual object and/or a particular user interface element (e.g., included in the virtual object and/or the first region) when detecting the one or more gestures.

In some embodiments, in response to detecting the one or more gestures, the computer system performs (1008) an operation in the three-dimensional environment that is based on a location and/or movement of the one or more gestures relative to the pose (e.g., position and/or orientation) of the first input region, such as scrolling user interface of virtual object 930 that includes first image 932a and second image 932b in accordance with movement of finger 902 of the hand 903 on the first input region 910 as shown in FIG. 9B. For example, the computer system performs an operation in response to detecting the one or more gestures based on the orientation of the first region relative to the surface. In some embodiments, in accordance with a determination that the first input region has the first orientation on the physical surface in the three-dimensional environment, the computer system performs a first operation in accordance with the first orientation and the one or more gestures. In some embodiments, in accordance with a determination that the first input region has the second orientation on the physical surface in the three-dimensional environment, the computer system performs a second operation in accordance with the second orientation and the one or more gestures. In some embodiments, performing the first operation in accordance with the first orientation and the one or more gestures includes interacting with one or more user interfaces displayed in the three-dimensional environment in a first manner. For example, the computer system selects/activates a user interface element (e.g., a selectable option), scrolls (e.g., in a first direction) a user interface that includes content (e.g., which optionally reveals additional (e.g. previously non-displayed or nonvisible) content in the user interface, and/or adjusts a setting or control (e.g., a control slider/toggle, such as for controlling volume, brightness, playback position, playback speed, and/or other settings) in a first manner. In some embodiments, performing the first operation has one or more characteristics of performing operations as discussed in method 800. In some embodiments, performing the second operation in accordance with the second orientation and the one or more gestures includes interacting with one or more user interfaces displayed in the three-dimensional environment in a second manner, different from the first manner. For example, the computer system selects/activates a different user interface element than is selected/activated when performing the first operation, scrolls the user interface in a different direction (e.g., a second direction, different from the first direction above), and/or adjusts a different setting or control or adjusts the setting or control in a different manner (e.g., decreases the brightness or volume control rather than increasing the brightness or volume control). Performing a particular operation in response to detecting input directed to a region of a surface visible in a three-dimensional environment based on an orientation of the region, which is based on one or more properties of the three-dimensional environment, increases the ease and efficiency at which inputs are provided to the computer system by accounting for the one or more properties of the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, the determination that the three-dimensional environment has the first set of one or more properties is in accordance with a determination that a viewpoint of a user of the computer system is a first viewpoint in the three-dimensional environment, such as a viewpoint of the user 942 in FIG. 9A. In some embodiments, the determination that the three-dimensional environment has the second set of one or more properties is in accordance with a determination that the viewpoint of the user of the computer system is a second viewpoint, different from the first viewpoint, in the three-dimensional environment, such as the viewpoint of the user 942 in FIG. 9F. For example, the orientation of the first input region is determined based on a location of the viewpoint of the user of the computer system in the three-dimensional environment. In some embodiments, the location at which the first input region is positioned/defined on the physical surface is a predetermined distance and/or orientation from the viewpoint of the user of the computer system and/or corresponds to a center point in a field of view of the user from the viewpoint. In some embodiments, if the location of the viewpoint is moved, shifted, or rotated in the three-dimensional environment when defining, calibrating, and/or otherwise selecting the first input region (e.g., as discussed in method 800), the computer system updates the pose (e.g., the location and/or orientation) of the first input region based on the updated viewpoint of the user. For example, the computer system automatically moves and/or rotates the first input region on the physical surface in the three-dimensional environment to remain the predetermined distance from the updated viewpoint and/or in the center of the field of view of the user from the updated viewpoint. In some embodiments, the pose (e.g., the location and/or orientation) of the first input region is fixed based on the viewpoint of the user when the first input region was designated/defined (e.g., as discussed with reference to method 800). For example, if the location of the viewpoint is moved, shifted, or rotated in the three-dimensional environment after the first input region has been defined, calibrated, and/or otherwise selected, the computer system does not update the pose of the first input region based on the updated viewpoint of the user. It should be understood that, in some embodiments, the one or more properties of the three-dimensional environment include one or more of the properties discussed below, in addition to the viewpoint of the user of the computer system. Performing a particular operation in response to detecting input directed to a region of a surface visible in a three-dimensional environment based on an orientation of the region, which is based on a viewpoint of the user, increases the ease and efficiency at which inputs are provided to the computer system by accounting for the viewpoint of the user, without requiring the user to select/define the orientation of the region, and/or minimizes the likelihood of the user providing erroneous input to the computer system, thereby conserving computing resources of the computing system associated with correcting erroneous input.

In some embodiments, the determination that the three-dimensional environment has the first set of one or more properties is in accordance with a determination that a location (and/or orientation) of a hand of a user of the computer system is a first location (and/or orientation) relative to the physical surface, such as a location of the hand 903 on the table 906 shown in FIG. 9A. In some embodiments, the determination that the three-dimensional environment has the second set of one or more properties is in accordance with a determination that the location (and/or orientation) of the hand of the user of the computer system is a second location (and/or orientation), different from the first location (and/or orientation), relative to the physical surface, such as a location of hand 905 on the table 906 shown in FIG. 9C. For example, the orientation of the first input region is determined based on a pose (e.g., position and/or orientation) of the hand of the user of the computer system in the three-dimensional environment. In some embodiments, the location at which the first input region is positioned/defined on the physical surface is below the hand of the user in the three-dimensional environment. Additionally, in some embodiments, the orientation of the first input region on the physical surface is defined according to and/or based on an orientation of the hand, including the wrist and arm/elbow, of the user in the three-dimensional environment. For example, the computer system determines the orientation of the first input region based on an orientation of the elbow joint and/or wrist joint of the user (e.g., which controls the angle at which the hand is positioned and thus detected on the physical surface). In some embodiments, if the hand is moved, shifted, or rotated in the three-dimensional environment when defining, calibrating, and/or otherwise selecting the first input region (e.g., as discussed in method 800), the computer system updates the pose (e.g., the location and/or orientation) of the first input region based on the updated location and/or orientation of the hand in the three-dimensional environment. For example, the computer system automatically moves and/or rotates the first input region on the physical surface in the three-dimensional environment to correspond to the updated location and/or orientation of the hand (and/or wrist and/or elbow) of the user in the three-dimensional environment. In some embodiments, the pose (e.g., the location and/or orientation) of the first input region is fixed based on the location and/or orientation of the hand of the user when the first input region was designated/defined (e.g., as discussed with reference to method 800). For example, if the hand of the user is moved, shifted, or rotated in the three-dimensional environment after the first input region has been defined, calibrated, and/or otherwise selected, the computer system does not update the pose of the first input region based on the updated location and/or orientation of the hand of the user in the three-dimensional environment. It should be understood that, in some embodiments, the one or more properties of the three-dimensional environment include one or more of the properties discussed above and/or below, in addition to the location of the hand of the user in the three-dimensional environment. Performing a particular operation in response to detecting input directed to a region of a surface visible in a three-dimensional environment based on an orientation of the region, which is based on a location of a hand of the user in the three-dimensional environment, increases the ease and efficiency at which inputs are provided to the computer system by accounting for the location of the hand in the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, the determination that the three-dimensional environment has the first set of one or more properties is in accordance with a determination that a location (and/or orientation) of physical surface in the three-dimensional environment is a first location (and/or orientation), such as the location of the table 906 shown in FIG. 9A. In some embodiments, the determination that the three-dimensional environment has the second set of one or more properties is in accordance with a determination that the location (and/or orientation) of the physical surface in the three-dimensional environment is a second location (and/or orientation), different from the first location (and/or orientation), such as the location of the table 906 in FIG. 9J. For example, the orientation of the first input region is determined based on a pose (e.g., position and/or orientation and/or elevation) of the physical surface on which the first input region is positioned/displayed in the three-dimensional environment. In some embodiments, the location at which the first input region is positioned/defined on the physical surface in the three-dimensional environment is determined based on the location of the physical surface itself in the three-dimensional environment. Additionally, in some embodiments, the orientation of the first input region on the physical surface is defined according to and/or based on an orientation/elevation/slope of the physical surface in the three-dimensional environment. For example, the computer system aligns the orientation/elevation/slope of the first input region to that of the physical surface, such that if the physical surface includes a curved/angled surface, the first input region is also and/or similarly curved/angled. As another example, if the physical surface has multiple surfaces of different elevations/heights (e.g., a desk that has a first surface/level for a keyboard and mouse and a second surface/level for a desktop computer or laptop and/or monitor), the computer system positions the first input region on one of the surfaces of the physical surface (e.g., the surface closest to the viewpoint of the user). In some embodiments, if the physical surface is moved, shifted, or rotated in the three-dimensional environment when defining, calibrating, and/or otherwise selecting the first input region (e.g., as discussed in method 800), the computer system updates the pose (e.g., the location and/or orientation) of the first input region based on the updated location and/or orientation of the physical surface in the three-dimensional environment. For example, the computer system automatically moves and/or rotates the first input region on the physical surface in the three-dimensional environment to correspond to the updated location and/or orientation of the hand (and/or wrist and/or elbow) of the user in the three-dimensional environment. In some embodiments, the pose (e.g., the location and/or orientation) of the first input region is fixed based on the location and/or orientation of the physical surface when the first input region was designated/defined (e.g., as discussed with reference to method 800). For example, if the physical surface is moved, shifted, or rotated in the three-dimensional environment after the first input region has been defined, calibrated, and/or otherwise selected, the computer system does not update the pose of the first input region based on the updated location and/or orientation of the physical surface in the three-dimensional environment. It should be understood that, in some embodiments, the one or more properties of the three-dimensional environment include one or more of the properties discussed above and/or below, in addition to the location of the physical surface in the three-dimensional environment. Performing a particular operation in response to detecting input directed to a region of a surface visible in a three-dimensional environment based on an orientation of the region, which is based on a location of the surface in the three-dimensional environment, increases the ease and efficiency at which inputs are provided to the computer system by accounting for the location of the surface in the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, the determination that the three-dimensional environment has the first set of one or more properties is in accordance with a determination that the three-dimensional environment includes one or more electronic devices, other than the computer system, such as keyboard 915 in FIG. 9I, at one or more first locations in the three-dimensional environment, such as the location of the keyboard 915 shown in FIG. 9I. In some embodiments, the one or more electronic devices are different from (e.g., separate from) the computer system. In some embodiments, the one or more electronic devices are in communication with the computer system. For example, the one or more electronic devices include and/or correspond to the one or more input devices described above, such as a keyboard, a mouse, a trackpad, a smartphone, a laptop, a desktop computer, a tablet computer, a monitor, and/or other supporting components, such as electrical cables, wires, docking stations, and/or headphones, that are located on the physical surface and/or in the three-dimensional environment. In some embodiments, the one or more electronic devices are not in communication with the computer system. For example, the one or more electronic devices include lamps, fans, televisions, and/or one or more of the above devices that are located on the physical surface and/or in the three-dimensional environment.

In some embodiments, the determination that the three-dimensional environment has the second set of one or more properties is in accordance with a determination that the three-dimensional environment includes the one or more electronic devices at one or more second locations, different from the one or more first locations, in the three-dimensional environment, such as the location of the keyboard 915 shown in FIG. 9J. For example, the orientation of the first input region is determined based on a pose (e.g., position and/or orientation) of the one or more electronic devices in the three-dimensional environment. In some embodiments, the location at which the first input region is positioned/defined on the physical surface is adjacent to, but does not correspond to, the one or more locations of the one or more electronic devices in the three-dimensional environment. For example, if the physical surface includes a keyboard, the computer system positions the first input region to the side of, above, or below the keyboard (e.g., but not overlaid on or overlapping the keyboard) on the physical surface in the three-dimensional environment. Additionally, in some embodiments, the orientation of the first input region on the physical surface is defined according to and/or based on orientations of the one or more electronic devices in the three-dimensional environment. For example, if the physical surface includes a keyboard, the computer system aligns the first input region to the orientation of the keyboard on the physical surface (e.g., a side of the first input region is aligned to an angle of the side of the keyboard on the physical surface) in the three-dimensional environment. In some embodiments, if the one or more electronic devices are moved, shifted, or rotated in the three-dimensional environment when defining, calibrating, and/or otherwise selecting the first input region (e.g., as discussed in method 800), the computer system updates the pose (e.g., the location and/or orientation) of the first input region based on the updated locations and/or orientations of the one or more electronic devices in the three-dimensional environment. For example, the computer system automatically moves and/or rotates the first input region on the physical surface in the three-dimensional environment to be positioned adjacent to and/or to be aligned to the one or more electronic devices in the three-dimensional environment. It should be understood that, in some embodiments, the one or more properties of the three-dimensional environment include one or more of the properties discussed above and/or below, in addition to the locations of the other electronic devices in the three-dimensional environment. Performing a particular operation in response to detecting input directed to a region of a surface visible in a three-dimensional environment based on an orientation of the region, which is based on locations of other electronic devices in the three-dimensional environment, increases the ease and efficiency at which inputs are provided to the computer system by accounting for the locations of the other electronic devices in the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, the three-dimensional environment further includes a first object (e.g., a virtual object that is or includes content, such as a user interface) that is displayed via the display generation component, such as virtual object 930 in FIG. 9A. In some embodiments, the first object has one or more characteristics of virtual content and/or user interfaces described with reference to method 800.

In some embodiments, the determination that the three-dimensional environment has the first set of one or more properties is in accordance with a determination that the first object is displayed at a first location (and/or with a first orientation) in the three-dimensional environment, such as the location of the virtual object 930 in three-dimensional environment 900 shown in FIG. 9I. In some embodiments, the determination that the three-dimensional environment has the second set of one or more properties is in accordance with a determination that the first object is displayed at a second location (and/or with a second orientation), different from the first location (and/or orientation), in the three-dimensional environment, such as the location of input region 910 in three-dimensional environment 900 shown in FIG. 9K. For example, the orientation of the first input region is determined based on a pose (e.g., position and/or orientation) of the first object in the three-dimensional environment. In some embodiments, the location at which the first input region is positioned/defined on the physical surface is adjacent to, but does not correspond to, the location of the first object in the three-dimensional environment. For example, the computer system positions the first input region to the side of, above, below, or in front of the first object (e.g., but not overlaid on or overlapping the first object) on the physical surface in the three-dimensional environment. Additionally, in some embodiments, the orientation of the first input region on the physical surface is defined according to and/or based on the orientation of the first object in the three-dimensional environment. For example, the computer system aligns the first input region to the orientation of the first object on the physical surface (e.g., a front side/edge of the first input region is aligned to an angle of the front-facing surface of the first object on the physical surface) in the three-dimensional environment. In some embodiments, if the first object is moved, shifted, or rotated in the three-dimensional environment when defining, calibrating, and/or otherwise selecting the first input region (e.g., as discussed in method 800), the computer system updates the pose (e.g., the location and/or orientation) of the first input region based on the updated location and/or orientation of the first object in the three-dimensional environment. For example, the computer system automatically moves and/or rotates the first input region on the physical surface in the three-dimensional environment to be positioned adjacent to or in front of and/or to be aligned to the first object in the three-dimensional environment. In some embodiments, the pose (e.g., the location and/or orientation) of the first input region is fixed based on the location and/or orientation of the first object when the first input region was designated/defined (e.g., as discussed with reference to method 800). For example, if the first object is moved, shifted, or rotated in the three-dimensional environment after the first input region has been defined, calibrated, and/or otherwise selected, the computer system does not update the pose of the first input region based on the updated location and/or orientation of the first object in the three-dimensional environment. It should be understood that, in some embodiments, the one or more properties of the three-dimensional environment include one or more of the properties discussed above and/or below, in addition to the location and/or orientation of the virtual content in the three-dimensional environment. Performing a particular operation in response to detecting input directed to a region of a surface visible in a three-dimensional environment based on an orientation of the region, which is based on a location of virtual content in the three-dimensional environment, increases the ease and efficiency at which inputs are provided to the computer system by accounting for the location of the virtual content in the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, the three-dimensional environment further includes a user interface that is displayed via the display generation component (e.g., a virtual object that includes content, as similarly discussed above), such as virtual object 930 including the first image 932a and the second image 932b as shown in FIG. 9A. In some embodiments, performing the operation in the three-dimensional environment that is based on the location and/or movement of the one or more gestures relative to the pose of the first input region includes performing a directional operation in the user interface in a respective direction, such as a scroll operation in virtual object 930. In some embodiments, performing the directional operation in the user interface in the respective direction includes moving a respective user interface element corresponds to content that is displayed in the user interface, such as an image, a selectable option/button, text, or other object. For example, the computer system scrolls the user interface in the respective direction, which causes the respective user interface element to be moved in the respective direction in the user interface, in response to detecting the one or more gestures. In some embodiments, the respective user interface element corresponds to a focus element or indicator that is displayed in the user interface, such as a focus ring, focus dot, or highlight. For example, the computer system moves the focus indicator in the respective direction in the user interface in response to detecting the one or more gestures. In some embodiments, the respective user interface element corresponds to a cursor or other selection tool that is displayed in the user interface and that is controllable via the first input region. For example, the computer system moves the cursor in the respective direction in the user interface in response to detecting the one or more gestures.

In some embodiments, in accordance with the determination that the first input region has the first orientation on the physical surface in the three-dimensional environment (e.g., the orientation of the first input region 910 in FIG. 9A) and that the movement of the one or more gestures relative to the pose of the first input region has a first direction relative to the three-dimensional environment (e.g., the movement of the one or more gestures include movement of one or more fingers of a hand of the user in the first direction on the first input region on the physical surface, as similarly discussed above), such as the direction of the movement of the finger 902 of the hand 903 on the first input region 910 as shown in FIG. 9A, the respective direction is a second direction, as illustrated by the upward scroll of the user interface of the virtual object 930 in FIG. 9B. For example, the second direction is the same as or different from the first direction and/or is based on or corresponds to the first direction relative to the pose of the first input region.

In some embodiments, in accordance with the determination that the first input region has the second orientation on the physical surface in the three-dimensional environment (e.g., the orientation of the first input region 910 in FIG. 9C) and that the movement of the one or more gestures relative to the pose of the first input region has the first direction relative to the three-dimensional environment, such as the direction of the movement of finger 904 of hand 905 on the first input region 910 as shown in FIG. 9C, the respective direction is a third direction, different from the second direction, as illustrated by the upward scroll of the user interface of the virtual object 930 in FIG. 9D. For example, the third direction is the same as or different from the first direction and/or is based on or corresponds to the first direction relative to the pose of the first input region. For example, the direction in which the computer system performs the directional operation in the user interface (e.g., moves the respective user interface element of the user interface) in response to detecting the movement of the one or more gestures relative to the pose of the first input region is determined based on the orientation of the first input region in the three-dimensional environment. In some embodiments, if the orientation of the first input region is the first orientation, the computer system performs the directional operation (e.g., moves the respective user interface element) in a direction relative to the three-dimensional environment that corresponds to the movement of the one or more gestures (e.g., the computer system moves the respective user interface element in the same direction as the movement of the finger(s) of the hand of the user). In some embodiments, if the orientation of the first input region is the second orientation, the computer system performs the directional operation (e.g., moves the respective user interface element) in a direction relative to the three-dimensional environment that does not necessarily correspond to (e.g., is not necessarily the same as) the direction of the movement of the one or more gestures. For example, the movement of the one or more gestures relative to the pose of the first input region that has the first direction relative to the three-dimensional environment causes the respective user interface element to be moved upward while the first input region has the first orientation on the physical surface, while the movement of the one or more gestures relative to the pose of the first input region that has the first direction relative to the three-dimensional environment causes the respective user interface element to be moved downward (e.g., or leftward or rightward, or otherwise diagonally) in the user interface while the first input region has the second orientation on the physical surface (e.g., and vice versa). In some embodiments, a difference between the first orientation and the second orientation is more than a threshold amount (e.g., a threshold number of degrees). For example, the computer system moves the respective user interface element in different directions in the user interface when the first input region has the first orientation compared to when the first input region has the second orientation in response to detecting the movement of the one or more gestures in accordance with a determination that the first orientation is different from the second orientation by more than 10, 15, 20, 25, 30, 45, 60, or 90 degrees. Otherwise, in some embodiments, if the first orientation is not different from the second orientation by more than the threshold amount, the computer system forgoes moving the respective user interface element in different directions in the user interface when the first input region has the first orientation compared to when the first input region has the second orientation in response to detecting the movement of the one or more gestures. Performing a particular directional operation in response to detecting movement input directed to a region of a surface visible in a three-dimensional environment based on an orientation of the region, which is based on one or more properties of the three-dimensional environment, increases the ease and efficiency at which inputs are provided to the computer system by accounting for the one or more properties of the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, while the first input region is active in the three-dimensional environment, in accordance with the determination that the first input region has the first orientation on the physical surface in the three-dimensional environment (e.g., because the three-dimensional environment has the first set of one or more properties), such as the orientation (e.g., indicated by axes 909) of the first input region 910 shown in FIG. 9A, the computer system displays, via the display generation component, a visual indicator corresponding to the first input region that has a first visual appearance (e.g., has the first orientation on the physical surface in the three-dimensional environment and/or is displayed with a visual indication of the first orientation, such as virtual axes or a virtual grid), such as the visual appearance of the first input region 910 shown in FIG. 9A.

In some embodiments, in accordance with the determination that the first input region has the second orientation on the physical surface in the three-dimensional environment (e.g., because the three-dimensional environment has the second set of one or more properties), such as the orientation (e.g., indicated by axes 909) of the first input region 910 shown in FIG. 9C, the computer system displays the visual indicator corresponding to the first input region that has a second visual appearance, different from the first visual appearance (e.g., has the second orientation on the physical surface in the three-dimensional environment and/or is displayed with a visual indication of the second orientation), such as the visual appearance of the first input region 910 shown in FIG. 9C. In some embodiments, the visual indicator includes but is not limited to, a visual border (e.g., solid line and/or dashed line) that illustrates a location and/or boundary of the first input region, including the particular orientation of the first input region. In some embodiments, displaying the visual indicator in the three-dimensional environment has one or more characteristics of displaying visual indicators as described in method 800. Applying a visual indicator to the designated input surface, minimizes the likelihood of erroneous user inputs such as applying inputs intended for the input surface to another portion of the surface, or inadvertently applying an input to the input surface when no input was intended, thereby conserving computing resources associated with correcting erroneous input.

In some embodiments, detecting the one or more gestures performed by the one or more portions of the person directed to the at least the first input region includes (e.g., concurrently) detecting one or more gestures performed by a first hand and one or more gestures performed by a second hand of the person (e.g., the user of the computer system) directed to the first input region on the physical surface, such as detecting input provided by hand 905 and hand 903 directed to the first input region 910 shown in FIGS. 9F-9H. For example, the computer system designates/defines a single input region via which the first hand and the second hand are able to provide input that is detectable by the computer system. In some embodiments, the computer system is configured to independently respond to the one or more gestures performed by the first hand and the second hand. For example, the computer system performs one or more operations in response to concurrently detecting input provided by the first hand and the second hand on the first input region and/or performs one or more operations in response to successively detecting input provided by the first hand and the second hand on the first input region in the three-dimensional environment. Performing a particular operation in response to detecting input provided by multiple hands of a user directed to a single region of a surface visible in a three-dimensional environment based on an orientation of the region, which is based on one or more properties of the three-dimensional environment, increases the ease and efficiency at which inputs are provided to the computer system by accounting for the one or more properties of the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, detecting the one or more gestures performed by the one or more portions of the person (e.g., the user of the computer system) directed to the at least the first input region includes detecting one or more gestures performed by a first hand directed to the first input region on the physical surface, such as by the hand 905 on first input region 910a shown in FIG. 9E. In some embodiments, the computer system detects, via the one or more input devices (e.g., one or more remote body tracking devices such as cameras, motion sensors, proximity sensors and/or depth sensors), one or more second gestures performed by a second hand (e.g., separate from the first hand) of the person (e.g., the user of the computer system) directed to (or on) a second input region, different from the first input region, on the physical surface, such as by the hand 903 on second input region 910b shown in FIG. 9E, wherein the second input region has a pose (e.g., position and/or orientation) on the physical surface that was determined based on the one or more properties of the three-dimensional environment, such as orientation (e.g., indicated by axes 909b) of the second input region 910b shown in FIG. 9E. For example, the computer system designates/defines multiple (e.g., separate) input regions via which the first hand and the second hand are able to provide input that is detectable by the computer system. In some embodiments, detecting the one or more second gestures performed by the second hand has one or more characteristics of detecting the one or more gestures performed by the first hand. In some embodiments, the second input region is defined/designated on the physical surface in a similar manner as the first input region described above. For example, the second input region is location at a particular location in the three-dimensional environment and has a particular orientation in the three-dimensional environment based on the one or more properties of the three-dimensional environment, as similarly discussed above with reference to the pose of the first input region. In some embodiments, the first input region and the second input region are located at different locations on the physical surface and/or have different orientations on the physical surface in the three-dimensional environment. Additionally, in some embodiments, the first input region and the second input region are located on different physical surfaces in the three-dimensional environment based on the one or more properties of the three-dimensional environment.

In some embodiments, in response to detecting the one or more gestures performed by the second hand, performing a second operation in the three-dimensional environment that is based on a location and/or movement of the one or more second gestures relative to the pose (e.g., position and/or orientation) of the second input region (e.g., similar to scrolling the user interface of the virtual object 930 in accordance with the movement of the finger 904 of the hand 905 shown in FIG. 9D). In some embodiments, the computer system is configured to independently respond to the one or more gestures performed by the first hand and the second hand. For example, the computer system performs one or more operations in response to concurrently detecting input provided by the first hand and the second hand on the first input region and the second input region and/or performs one or more operations in response to successively detecting input provided by the first hand and the second hand on the first input region and the second input region in the three-dimensional environment. Additionally or alternatively, in some embodiments, the computer system detects the one or more gestures performed by the first hand directed to the second input region on the physical surface and the one or more second gestures performed by the second hand directed to the first input region on the physical surface in the three-dimensional environment. In some embodiments, performing the second operation in the three-dimensional environment has one or more characteristics of performing the operation in the three-dimensional environment as discussed above. Performing a particular operation in response to detecting input provided by multiple hands of a user directed to separate input regions of a surface visible in a three-dimensional environment based on an orientation of the region, which is based on one or more properties of the three-dimensional environment, increases the ease and efficiency at which inputs are provided to the computer system by accounting for the one or more properties of the three-dimensional environment, without requiring the user to select/define the orientation of the region, and/or minimizes the likelihood of the user providing erroneous input to the computer system, thereby conserving computing resources of the computing system associated with correcting erroneous input.

In some embodiments, in accordance with the determination that the three-dimensional environment has the first set of one or more properties, the first input region has a third orientation (and/or position) relative to the second input region on the physical surface in the three-dimensional environment, such as the orientation (e.g., indicated by axes 909a) of the first input region 910a shown in FIG. 9E. In some embodiments, in accordance with the determination that the three-dimensional environment has the second set of one or more properties, the first input region has a fourth orientation (and/or position), different from the third orientation (and/or position), relative to the second input region on the physical surface in the three-dimensional environment, such as the orientation (e.g., indicated by axes 909b) of the second input region 910b shown in FIG. 9E. For example, as similarly mentioned above, the computer system defines the first input region and the second input region as having different orientations and/or being located at different locations on the physical surface in the three-dimensional environment based on the one or more properties of the three-dimensional environment (e.g., the one or more properties discussed above, such as the viewpoint of the user, the hand(s) of the user, the physical surface, and/or the content that is displayed in the three-dimensional environment). In some embodiments, the computer system individually designates the poses of the first input region and the second input region based on the one or more properties of the three-dimensional environment. For example, the computer system determines the location and/or orientation of the first input region based on a location and/or orientation of the first hand in the three-dimensional environment and/or determines the location and/or orientation of the second input region based on a location and/or orientation of the second hand in the three-dimensional environment. As another example, the computer system determines the location and/or orientation of the first input region based on the location and/or orientation of one or more physical objects (e.g., electronic devices) in the three-dimensional environment and/or determines the location and/or orientation of the second input region based on the location and/or orientation of the one or more physical objects (e.g., or other physical objects) in the three-dimensional environment. For example, if the physical surface includes a physical keyboard, the computer system positions and/or orients the first input region and the second input region at opposite ends/sides of the keyboard in the three-dimensional environment. In some embodiments, the determination that the three-dimensional environment has the first set of one or more properties or the second set of one or more properties is based on one or more physical characteristics of a particular physical object in the three-dimensional environment. For example, if the physical surface includes a physical keyboard, the three-dimensional environment has the first set of one or more properties if the physical keyboard has a width that is less than a threshold width (e.g., 8, 10, 12, 15, 20, or 30 cm) and the three-dimensional environment has the second set of one or more properties if the physical keyboard has a width that is at least the threshold width. In such an instance, the computer system optionally positions and/or orients the first input region and the second input region at opposite ends of the keyboard in the three-dimensional environment if the physical keyboard has a width that is less than the threshold width, and optionally positions and/or orients the first input region and the second input region below and/or in front of a bottom edge of the keyboard in the three-dimensional environment if the physical keyboard has a width that is at least the threshold width. As another example, if the physical surface includes a first physical object (e.g., a physical keyboard) that is at a first location and/or has a first orientation on the physical surface and a second physical object (e.g., a physical touchpad or mouse) that is at a second location and/or has a second orientation (e.g., different from the first location and/or the second orientation, respectively) on the physical surface, the computer system positions and/or orients the first input region and the second input region according to the first physical object and the second physical object, respectively. For example, the location and/or orientation of the first input region is determined based on the first location and/or the first orientation of the physical keyboard and the location and/or orientation of the second input region is determined based on the second location and/or the second orientation of the physical touchpad, which causes the poses of the first input region and the second input region to be different relative to each other, as discussed above. In some embodiments, the first input region and the second input region alternatively have the same orientation (e.g., while being located at different positions) in the three-dimensional environment based on the one or more properties of the three-dimensional environment. Performing a particular operation in response to detecting input provided by multiple hands of a user directed to separate input regions of a surface visible in a three-dimensional environment based on an orientation of the region, which is based on one or more properties of the three-dimensional environment, increases the ease and efficiency at which inputs are provided to the computer system by accounting for the one or more properties of the three-dimensional environment, without requiring the user to select/define the orientation of the region, and/or minimizes the likelihood of the user providing erroneous input to the computer system, thereby conserving computing resources of the computing system associated with correcting erroneous input.

It should be understood that the particular order in which the operations in method 1000 have been described is merely exemplary and is not intended to indicate that the described order is the only order in which the operations could be performed. One of ordinary skill in the art would recognize various ways to reorder the operations described herein. In some embodiments, aspects/operations of methods 800 and/or 1000 may be interchanged, substituted, and/or added between these methods. For example, input region configuration techniques, input regions, input region interactions, object movement techniques, and/or other object interactions of methods 800 and/or 1000 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with a display generation component, one or more input devices:
while a three-dimensional environment is visible via the display generation component, wherein the three-dimensional environment includes a first physical surface that does not include sensors for detecting touch inputs, detecting, via the one or more input devices, a first input corresponding to a request to designate a first portion of the first physical surface as a first input region;
while the first portion of the first physical surface is designated as the first input region, detecting, via the input devices, movement of a first portion of a person directed to the first input region; and
in response to detecting the movement of the first portion of the person:
in accordance with a determination that the movement of the first portion of the person was directed to the first input region, performing an operation at the computer system in accordance with the movement of the first portion of the person relative to the first input region; and
in accordance with a determination that the movement of the first portion of the person was not directed to the first input region, forgoing performing the operation at the computer system in accordance with the movement of the first portion of the person relative to the first input region.

2. The method of claim 1, wherein detecting, via the one or more input devices, the first input corresponding to the request to designate the first portion of the first physical surface as the first input region comprises detecting a second portion of the person performing a first gesture directed to the first portion of the first physical surface that satisfies one or more criteria.

3. The method of claim 2, wherein the one or more criteria include a criterion that is satisfied when the first gesture is a first pose performed within a threshold distance of the first portion of the first physical surface.

4. The method of claim 3, wherein the second portion of the person comprises a palm of the person's hand, and wherein the one or more criteria include a criterion that is satisfied when the computer system detects that the palm of the person is located within the threshold distance from the first portion of the surface.

5. The method of claim 3, wherein the second portion of the person comprises one or more fingers of a hand of the person, and wherein the one or more criteria include a criterion that is satisfied when the computer system detects that the one or more fingers of the person's hand are extended and are located within the threshold distance from the first portion of the first physical surface.

6. The method of claim 2, wherein the one or more criteria include a criterion that is satisfied when the computer system detects the second portion of the person performing a framing gesture directed to the first portion of the first physical surface.

7. The method of claim 2, wherein the second portion of the person comprises a plurality of fingers of the person's hand, and wherein the one or more criteria include a criterion that is satisfied when the computer system detects that the plurality of fingers is concurrently performing a gesture directed to the first portion of the first physical surface.

8. The method of claim 1, wherein the method further comprises:
before detecting, via the one or more input devices, the first input corresponding to the request to designate a first portion of the first physical surface as the first input region, displaying a designation user interface that prompts the person to provide the first input corresponding to the request to designate the first portion of the first physical surface as the first input region.

9. The method of claim 1, wherein the method further comprises:
in response to detecting the first input corresponding to the request to designate the first portion of the first physical surface as the first input region, displaying a calibration user interface that prompts the person to provide one or more second inputs for calibrating the first input region.

10. The method of claim 9, wherein the one or more second inputs for calibrating the first input region comprise a plurality of taps at a plurality of locations on the first input region.

11. The method of claim 1, wherein the method further comprises:
while the first portion of the first physical surface is designated as the first input region:
detecting one or more second inputs at the first input region; and
in response to detecting the one or more second inputs at the first input region, calibrating the first input region according to a first set of calibration parameters corresponding to the one or more second inputs; and
detecting one or more third inputs, different from the one or more second inputs, at the first input region; and
in response to detecting the one or more third inputs, different from the one or more second inputs, at the first input region, calibrating the first input region according to a second set of calibration parameters corresponding to the one or more third inputs.

12. The method of claim 1, wherein the method further comprises:
while the first portion of the first physical surface is designated as the first input region, displaying, on the first physical surface, a visual indicator that indicates an extent of the first input region.

13. The method of claim 12, wherein the visual indicator is an input region user interface, and wherein the input region user interface comprises one or more selectable options for providing input to the computer system, and wherein the method further comprises:
while the first portion of the first physical surface is designated as the first input region, receiving, via the one or more input devices, a second input directed to a first selectable option of the one or more selectable options of the input region user interface; and
in response to receiving the second input directed to the first selectable option, performing an operation at the computer system in accordance with the received second input.

14. The method of claim 1, wherein the first input includes detecting a second portion of the person in a first pose, and wherein the method further comprises:
while the first portion of the first physical surface is designated as the first input region, detecting, via the one or more input devices, the second portion of the person changing from having the first pose to having a second pose, different from the first pose; and
in response to detecting the second portion of the person changing from having the first pose to having the second pose, ceasing designation of the first physical surface as the first input region.

15. The method of claim 1, wherein the method further comprises:
while the first portion of the of the first physical surface is designated as the first input region, detecting that an elapsed time since input has been detected at the first input region is greater than a time threshold; and
in response to detecting that the elapsed time is greater than the time threshold, ceasing designation of the first physical surface as the first input region.

16. The method of claim 1, wherein the method further comprises:
while the first portion of the first physical surface is designated as the first input region, detecting, via the one or more input devices, a second gesture corresponding to a request to terminate the designation of the first portion of the first physical surface as the first input region; and
in response to detecting the second gesture, ceasing designation of the first physical surface as the first input region.

17. The method of claim 1, wherein the method further comprises:
while the first portion of the first physical surface is designated as the first input region, detecting via the one or more input devices, a first air gesture not directed to the first input region; and
in response to detecting the first air gesture, performing an operation at the computer system in accordance with the detected first air gesture while maintaining designation of the first portion of the first physical surface as the input region.

18. The method of claim 1, wherein the method further comprises:
detecting, via the one or more input devices, a second input corresponding to a request to designate a second portion of the first physical surface as a second input region, different from the first portion of the first physical surface;
in response to detecting the second input:
designating the second portion of the first physical surface as the second input region;
while the second portion of the first physical surface is designated as the second input region, detecting, via the one or more input devices, movement of a second portion of the person directed to the second input region; and
in response to detecting the movement of the second portion of the person directed to the second input region, performing an operation at the computer system in accordance the movement of the second portion of the person relative to the second input region.

19. The method of claim 1, wherein the movement of the first portion of the person is a tap input.

20. The method of claim 1, wherein the movement of the first portion of the person is an input that includes movement.

21. The method of claim 1, wherein the method further comprises:
while the first portion of the first physical surface is designated as the first input region, displaying a content user interface on the first input region, wherein the content user interface includes one or more interactive controls; and
wherein the movement of the first portion of the person includes an interaction with the one or more interactive controls of the content user interface displayed on the first input region.

22. The method of claim 1, wherein the method further comprises:
while the first portion of the first physical surface is designated as the first input region, displaying a content user interface on the first input region, wherein the content user interface includes content; and
wherein performing the operation at the computer system in accordance with the detected first gesture comprises performing an operation on the content of the content user interface displayed on the first input region.

23. The method of claim 1, wherein performing the operation at the computer system in accordance with the detected first gesture includes:
in accordance with a determination that attention of the person is directed to a first location in the three-dimensional environment, performing a first operation associated with the first location at the computer system in accordance with the detected first gesture; and
in accordance with a determination that the attention of the person is directed to a second location, different from the first location, in the three-dimensional environment, performing a second operation, different from the first operation, associated with the second location at the computer system in accordance with the detected first gesture.

24. The method of claim 1, the method further comprising:
while the first portion of the first physical surface is designated as the first input region, detecting, via the one or more input devices, a second input; and
in response to detecting the second input:
in accordance with a determination that the second input corresponds to a request to relocate the first input region in a first manner, relocating the first input region from the first portion of the first physical surface to a respective portion of a second surface in the three-dimensional environment; and
in accordance with a determination that the second input corresponds to a request to relocate the first input region in a second manner, different from the first manner, relocating the first input region from the first portion of the first physical surface to a respective portion of a third surface in the three-dimensional environment.

25. The method of claim 24, wherein the method further comprises:
while a movement portion of the second input is ongoing:
detecting that the first input region reaches a first movement threshold; and
in response to detecting that the first input region has reached a first movement threshold, displaying a first visual indicator at the first input region indicating that the first movement threshold has been reached.

26. The method of claim 25, wherein the method further comprises:
while displaying the first visual indicator at the first input region indicating that the first movement threshold has been reached, detecting further input corresponding to movement of the first input region beyond the first movement threshold followed by termination of the further input;
in response to detecting the further input, moving the first input region beyond the first movement threshold in accordance with further input; and
in response to detecting the termination of the further input, displaying an animation of the first input region moving back to within the first movement threshold.

27. The method of claim 1, wherein the one or more input devices include one or more remote body tracking devices, and wherein the method further comprises:
while the first portion of the first physical surface is designated as the first input region, detecting movement of the one or more remote body tracking devices; and
in response to detecting the movement of the one or more input devices:
in accordance with a determination that at least a portion of the first input region is outside of a field of sensing limit of the one or more remote body tracking devices, displaying, via the display generation component, a visual indicator in the three-dimensional environment indicating that at least a portion of the first input region is outside of the field of sensing limit of the one or more remote body tracking devices.

28. The method of claim 27, wherein displaying the visual indicator indicating that at least the portion of the first input region is outside of the field of sensing limit of the one or more input devices includes:
in accordance with a determination that the first input region does not include interactive content, displaying the visual indicator at a first content window displayed in the three-dimensional environment, the first content window including interactive content that is interactable via the first input region; and
in accordance with a determination that the first input region includes interactive content, displaying the visual indicator at the first input region.

29. The method of claim 1, wherein designating the first portion of the first physical surface as the first input region includes:
in accordance with a determination that a first object in the three-dimensional environment is located at a first location in the three-dimensional environment, orienting the first input region at a first orientation with respect to the three-dimensional environment; and
in accordance with a determination that the first object in the three-dimensional environment is located at a second location, different from the first location, in the three-dimensional environment, orienting the first input region at a second orientation, different from the first orientation, with respect to the three-dimensional environment.

30. The method of claim 1, wherein the first physical surface is not an input device.

31. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while a three-dimensional environment is visible via the display generation component, wherein the three-dimensional environment includes a first physical surface that does not include sensors for detecting touch inputs, detecting, via the one or more input devices, a first input corresponding to a request to designate a first portion of the first physical surface as a first input region;
while the first portion of the first physical surface is designated as the first input region, detecting, via the input devices, movement of a first portion of a person directed to the first input region; and
in response to detecting the movement of the first portion of the person:
in accordance with a determination that the movement of the first portion of the person was directed to the first input region, performing an operation at the computer system in accordance with the movement of the first portion of the person relative to the first input region; and
in accordance with a determination that the movement of the first portion of the person was not directed to the first input region, forgoing performing the operation at the computer system in accordance with the movement of the first portion of the person relative to the first input region.

32. A non-transitory computer readable storage medium storing one or more programs, the one or more programs comprising instructions, which when executed by one or more processors of a computer system that is in communication with a display generation component and one or more input devices, cause the computer system to perform a method comprising:
while a three-dimensional environment is visible via the display generation component, wherein the three-dimensional environment includes a first physical surface that does not include sensors for detecting touch inputs, detecting, via the one or more input devices, a first input corresponding to a request to designate a first portion of the first physical surface as a first input region;
while the first portion of the first physical surface is designated as the first input region, detecting, via the input devices, movement of a first portion of a person directed to the first input region; and
in response to detecting the movement of the first portion of the person:
in accordance with a determination that the movement of the first portion of the person was directed to the first input region, performing an operation at the computer system in accordance with the movement of the first portion of the person relative to the first input region; and
in accordance with a determination that the movement of the first portion of the person was not directed to the first input region, forgoing performing the operation at the computer system in accordance with the movement of the first portion of the person relative to the first input region.
